(19) United States
(12) Patent Application Publication
(10) Pub. No.: US 2025/0385250 A1
(43) Pub. Date: Dec. 18, 2025

(54) HIGH-ENERGY ALL-SOLID-STATE LITHIUM BATTERIES

(71) Applicants: YEDA RESEARCH AND DEVELOPMENT CO. LTD., Rehovot (IL); BAR-ILAN UNIVERSITY, Ramat Gan (IL)

(72) Inventors: Malakhi NOKED, Tarum (IL); Ayan MUKHERJEE, Ramat Gan (IL); Longlong WANG, Ramat Gan (IL)

(73) Assignees: YEDA RESEARCH AND DEVELOPMENT CO. LTD., Rehovot (IL); BAR-ILAN UNIVERSITY, Ramat Gan (IL)

(21) Appl. No.: 18/878,176

(22) PCT Filed: Jul. 5, 2023
(86) PCT No.: PCT/IL2023/050696

§ 371 Date: Dec. 23, 2024

Related U.S. Application Data
(60) Provisional application No. 63/358,360, filed on Jul. 5, 2022.

(51) Int. Cl. H01M 4/36; C01G 53/42; H01M 4/02; H01M 4/131; H01M 4/525; H01M 10/052; H01M 10/0585; H01M 10/42

(52) U.S. Cl. CPC H01M 4/366; C01G 53/42; H01M 4/131; H01M 4/525; H01M 10/052; H01M 10/0585; H01M 10/4235; C01P 2002/72; C01P 2002/82; C01P 2002/85; C01P 2004/03; C01P 2004/61; C01P 2004/86; C01P 2006/40; H01M 2004/028

(57) ABSTRACT

Provided is an all-solid-state lithium batteries (ASSLBs), Li-based cathode materials and structures incorporated therein and to methods of producing said materials, structures and batteries.

### FIELD OF THE INVENTION

The presently disclosed subject matter is directed towards all-solid-state lithium batteries (ASSLBs), to Li-based cathode materials and structures incorporated therein and to methods of producing said materials and structures.

### BACKGROUND

A critical challenge in the development of all-solid-state lithium batteries (ASSLBs) is to achieve low cost without compromising on good performance. The presently disclosed matter discloses a sulfide ASSLB based on strategically tailored and cost-effective high-energy Co-free LiNiO₂ cathodes with robust outside-in structures, enabled by the high-pressure O₂ synthesis and subsequent atomic layer deposition of a unique ultrathin LiₓAl_{y}Zn_{z}O_{δ} (LAZO) protective layer consisting of a LAZO surface coating region and an Al+Zn near-surface doping region. This high-quality artificial interphase significantly enhances the cathode structural stability and interfacial dynamics, and mitigates the contact loss and continuous side reactions at the cathode/solid electrolyte interface. Therefore, the present ASSLBs exhibit a high areal capacity, high specific cathode capacity, superior cycling stability, and good rate capability. The present disclose thus shows how to break through the limitation of expensive cathodes (e.g., Co-based) and coatings (e.g., Nb-, Ta-, La-, Zr-based) and achieve truly cost-effective high-energy ASSLBs for large-scale propulsion applications.

The mass deployment of low-carbon and clean electric vehicles (EVs) is widely deemed an imperative to reduce the emission of greenhouse gases (e.g., CO₂) and alleviate the ever-increasing energy crisis. However, the large-scale adoption of EVs hinges heavily on the development of rechargeable batteries with higher safety, lower cost, higher energy density, and longer calendar life. In recent years, the rapidly increasing price of cobalt (Co) has led to a sharp rise in the cost of conventional lithium-ion batteries (LIBs): so far, Co has been an essential element for lithium battery cathode chemistries, and the cathodes still largely determine the cost and performance of LIBs. More importantly, Co is a scarce element on Earth and global Co mining and refining are very unevenly distributed, which raises enormous concerns about the reliability of the supply chain, especially considering the influence of ethical and political factors. Therefore, exploring alternative solutions and shifting to new Co-free cathode chemistries with higher energy density is critically important.

A Co-free lithium nickel oxide (LiNiO₂) cathode is an attractive candidate, owing to its high theoretical specific capacity (275 mAh·g⁻¹), the low cost and its high natural abundance of Ni with respect to Co. Unlike conventional LIBs containing liquid electrolyte solutions, all-solid-state lithium batteries (ASSLBs) based on solid electrolytes (SEs) don't contain volatile, flammable solvents and thus can demonstrate superior safety features. Hence, ASSLBs may allow the incorporation of high-energy LNO cathodes into commercial applications. Among the different types of SEs, sulfide-based (thiophosphate) SEs are the most suitable for use in all-solid-state batteries for electromobility (for which both high energy and high power densities are required) because of their high ionic conductivity (1-25 mS·cm⁻¹) at room temperature, relatively lower cost (compared to other high-performance SEs like halides), and high ductility. Chloride-based ASSLBs with 4 V cathode materials (namely, LiCoO₂ and LiNi_{1-x-y}CoₓMn_{y}O₂) have displayed excellent electrochemical performance as a result of the superior interfacial stability of chloride-based SEs in contact with uncoated high-voltage cathodes. However, chloride-based SEs suffer from very poor stability with the anodes (e.g., Li, Na, In). In most cases, sulfide-based SEs must be included on the anode side of such ASSLBs to suppress the reduction of chloride-based SEs. Worse, very expensive elements (e.g., Y, Sc, In) appear to be indispensable in order to elaborate high-performance chloride-based SEs, which significantly increases the cost of batteries containing SEs based on such elements, and thus limits their potential for commercialization.

Unfortunately, the more promising sulfide-based SEs suffer from a narrow electrochemical stability window, which greatly restricts their use in batteries containing high-voltage cathodes. Coating high-voltage cathodes with chemically compatible and stable buffering layers with high ionic conductivity but low electronic conductivity is one approach to overcome this problem. However, the most widely used coating layers in high-performance ASSLBs rely on the use of very expensive elements (e.g., Nb, Ta, La, Zr) to fulfill the requirement of high ionic conductivity. As a result, cost-effective coating layers with competitive ionic conductivity are critically important for developing high-performance, high-voltage ASSLBs.

The electronic and ionic conductivity of coating layers on electrodes can be affected by their thickness, composition and crystallinity. Besides, the electronic and ionic transport dynamics of the interphase coating between the cathodes and SEs play a critical role in the electrochemical performance of ASSLBs, as they influence the rate-determining step. The coating layers prepared via common wet-chemical coating methods rely primarily on their chemical composition to achieve high ionic conductivity because their thickness and uniformity cannot be precisely controlled by these rough coating methods. In contrast, the atomic layer deposition (ALD) technique can produce atomic-scale, uniform, homogeneous, and stoichiometric coatings at low temperatures, which can result in high-quality interphases with excellent interface stability and fast interfacial transport dynamics. Moreover, metal heteroatoms present in ALD precursors can favorably dope oxide substrates by insertion into interstitial sites in their near-surface active zones, which can further improve the interface and even bulk/mechanical stability of the cathodes in ASSLBs.

In the presently disclosed subject matter a cost-effective and high-energy ASSLB based on Co-free LNO cathodes with robust outside-in structures, enabled by the high-pressure O₂ synthesis and ultrathin LiₓAl_{y}Zn_{z}O_{δ} (LAZO) protective layer comprising a LAZO surface coating and an Al+Zn near-surface doping region, achieved by ALD techniques on the LNO particles. This achievement greatly reduces the cathode/coating dependency on expensive elements (e.g., Co, Nb, Ta, La, Zr), and therefore the battery cost without sacrificing performance. The ultrathin (e.g., nanoscale) and uniform LAZO interphase achieves a good balance among the ionic conductivity, electronic conductivity, interfacial stability, and mechanical stability. As a result, the sulfide ASSLBs based on LAZO-modified LNO (LAZO@LNO) with a cathode loading of ˜9 mg·cm⁻² displays a high capacity of ˜2 mAh·cm⁻² (>200 mAh·g⁻¹, 0.322 mA·cm⁻²), excellent long-term cycling stability, and superior rate capability at a near-room temperature of 35° C. With an increased cathode loading of ˜25 mg·cm⁻², the LAZO@LNO-based ASSLBs still exhibit very stable long-term cycling stability and high specific discharge capacity at a near-room temperature of 35° C. (0.454/0.934 mA·cm⁻²) or at a low stack pressure of 2 MPa (0.882/4.540 mA·cm⁻²). As shown herein, various characterization analyses are demonstrated such as electrochemical kinetic behaviors, structural and mechanical stability, and the interfacial charge-compensation mechanism. Thus, provided herein is a preparation of cost-effective and high-energy ASSLBs for large-scale applications.

### SUMMARY

In various embodiments the invention is directed towards high energy all-solid-state lithium-based batteries. The term “high energy” generally refers to the energy density or the amount of energy that a battery can store per unit of its volume or mass.

In one embodiment the invention provides a material with a general formula LiₓAl_{y}Zn_{z}O_{δ} (LAZO), wherein:
x, y, z and δ, or any combination thereof, is a whole number greater than or equal to 1.

In one embodiment of the material x, y, z and δ, or any combination thereof, is a whole number ranging between 1 and 10. In one embodiment the material is in the form of a layer wherein the thickness of the layer ranges between 1 and 500 nm.

In one embodiment the invention provides a cathode comprising:
a first layer comprising lithium; and
a second layer comprising the LAZO material disclosed herein.

In one embodiment of the cathode the first layer comprises LiNiO₂ (LNO). In one embodiment of the cathode the first layer comprises any of the following selected from: Li₃MCl₆ and Li₂M_{2/3}Cl₄ wherein M is selected from: Y, Tb—Lu, Sc, and In; and LiMn₂O₄. In one embodiment of the cathode the second layer further comprises an Al+Zn near-surface doping region disposed on the surface of the first layer. In one embodiment of the cathode the first layer comprises a modulating structure. In one embodiment of the cathode the modulating structure is selected from: spherical particles, cuboidal particles, wave-like structure and platonic solids or any combination thereof. In one embodiment of the cathode the modulating structure is polycrystalline. In one embodiment of the cathode the average size of the modulating structure ranges between 1 and 50 μm. In one embodiment cathode the further comprises secondary particles disposed on the first layer. In one embodiment of the cathode the size of the secondary particles ranges between 10 to 500 nm. In one embodiment of the cathode the thickness of the second layer ranges between 1 and 50 nm. In one embodiment of the cathode the cathode loading ranges between 5 to 25 mg/cm². In one embodiment of the cathode the areal capacity ranges between 1 and 10 mAh/cm². In one embodiment of the cathode the cyclability ranges between 70 to 100% after 500 cycles. In one embodiment cathode further comprises a current collector wherein the first layer is disposed thereon. In one embodiment of the cathode the current collector comprises any of the following selected from: aluminum (Al), copper (Cu), stainless steel, nickel (Ni), an alloy comprising Al, Cu or Ni, or any combination thereof.

In one embodiment the invention provides a method of producing LiNiO₂ (LNO), the method comprising:
mixing a plurality of precursors, producing a mixture; and
calcinating the mixture by placing the mixture in an O₂ atmosphere at high temperature.

In one embodiment of the method the plurality of precursors comprises: nickel salts, lithium compounds, metal oxides and organic precursors or any combinations thereof. In one embodiment of the method the plurality of precursors comprises Ni(OH)₂ and LiOH·H₂O. In one embodiment of the method the mixing is carried out at a mole ratio of Li:Ni of about 1.10:1. In one embodiment of the method the O₂ atmosphere is a flowing O₂ atmosphere. In one embodiment of the method the high temperature ranges between 300 to 800° C. In one embodiment of the method the calcinating is carried out for a holding time ranging between 2 and 15 hours. In one embodiment the method further comprises cooling the mixture to about room temperature after the calcinating step. In one embodiment of the method the rate of change in temperature to reach the high temperature or the room temperature, or a combination thereof, ranges between 1-20° C. per minute. In one embodiment the method further comprises increasing the 02 pressure to between 20-150 bar during the cooling.

In one embodiment the invention provides a method of depositing the LAZO material on a substrate, the method comprising:
providing a substrate;
providing a plurality of precursors; and
carrying out atomic layer deposition (ALD) on the substrate by cycling alternately between the plurality of precursors, producing a LAZO layer disposed on the substrate.

In one embodiment of the method the substrate comprises lithium. In one embodiment of the method the substrate comprises LiNiO₂ (LNO). In one embodiment of the method the substrate comprises any of the following selected from: Li₃MCl₆ and Li₂M_{2/3}Cl₄ wherein M is selected from: Y, Tb—Lu, Sc, and In; and LiMn₂O₄. In one embodiment of the method the plurality of precursors comprise Li, Al, Zn and O or a combination thereof. In one embodiment of the method the plurality of precursors comprise the following selected from: lithium tert-butoxide (LiO^{t}Bu), lithium cyclopentadienyl (LiCp), n-BuLi (n-butyllithium), lithium diisopropylamide (LiDIPA), lithium dicyclohexylamide, Li-THD, lithium alkyls, lithium alkyl n-butyllithium, LiHMDS, trimethylaluminum (TMA), tris(dimethylamino)aluminum (TDMAAI), aluminum isopropoxide (Al(O-i-Pr)₃), diethylzinc (DEZ), dimethylzinc (DMZ) and diisopropylzinc (DIZ) and deionized water or any combinations thereof. In one embodiment of the method the ALD is carried out at between 150 to 400° C. In one embodiment of the method the ALD uses a carrier gas selected from argon or nitrogen. In one embodiment of the method the carrier gas has a flow rate ranging between 10 to 200 sccm. In one embodiment of the method the cycling comprises introducing the precursors in the following step sequence:
TMA, H₂O, LiO^{t}Bu, H₂O, DEZ and H₂O;
wherein each precursor step sequence has a pulse time of about 0.02 s, a reaction time of about 10 s and an evacuation time of about 30 s.

In one embodiment of the method the cycling comprises between 10 and 1000 cycles.

In one embodiment the invention provides a solid-state lithium battery comprising:
providing a cathode as disclosed herein;
a solid electrolyte; and
an anode;
wherein the solid electrolyte is disposed between the cathode and the anode.

In one embodiment of the battery the LAZO layer has a thickness ranging between 1 to 50 nm. In one embodiment of the battery the solid electrolyte is selected from an inorganic solid electrolyte (ISE), a solid polymer electrolyte (SPE) and a composite polymer electrolyte (CPE) or any combination thereof. In one embodiment of the battery the solid electrolyte comprises: argyrodite-like material, garnets, NASICON, lithium nitrides, lithium hydrides, lithium phosphidotrielates, phoshidotetrelates, perovskites, lithium halides, RbAg₄I₅, lithium phosphorus oxynitride, lithium thiophosphates, LPSC, LSPSSC, LSPS, LGPS, LSSSI, LISC, LHC, LSC, polyethylene oxide (PEO) based, polyvinylidene fluoride (PVDF) based, polyacrylonitrile (PAN) based, polyethylene oxide/polypropylene oxide (PEO/PPO) blends and polyphosphazene-based electrolytes or any combination thereof.

In one embodiment of the battery the argyrodite-like material is in the form Li_{7-θ}BCh_{6-θ}X_{θ} wherein:
θ is between 0 and 1;
B is selected from: phosphor or arsenic;
Ch is selected from: sulfur or selenium; and
X is selected from: chlorine, bromine or iodine.

In one embodiment of the battery the anode comprises: Li, Al, Si, In and Sn, or any combination thereof. In one embodiment of the battery the anode comprises any of the following selected from: LiIn, Li-alloys, LTO, Ag—C, Li-G, LiNbO₃, carbon, metal oxides, metal sulfides, GeₓSi₁₋ₓ, SnO—B₂O₃, SnS—P₂S₅, Li₂FeS₂, FeS, NiP₂, and Li₂SiS₃ or any combinations thereof. In one embodiment the battery further comprises a first current collector connected to the cathode and a second current collector connected to the anode. In one embodiment of the battery the first current collector and the second current collector comprise any of the following selected from: aluminum (Al), copper (Cu), stainless steel, nickel (Ni), an alloy comprising Al, Cu or Ni, or any combination thereof. In one embodiment the battery the further comprises a battery housing configured to house the cathode, the anode and the solid electrolyte.

In one embodiment the invention provides a method of manufacturing a solid-state battery, the method comprising:
providing a solid electrolyte comprising a first side and a second side;
depositing the cathode disclosed herein on the first side;
depositing at least one anode material on the second side.

In one embodiment of the method the cathode is deposited by dry slot printing. In one embodiment the method further comprises pressing the cathode onto the first side with a pressure ranging between 100 to 300 MPa. In one embodiment of the method the pressing of the cathode is carried out for between 1 to 10 mins. In one embodiment of the method the at least one anode material is in the form of a metallic foil. In one embodiment of the method the at least one anode material is selected from Li, In, Al and Cu or any combination thereof. In one embodiment the method further comprises pressing the at least one anode material onto the second side with a pressure ranging between 100 to 300 MPa. In one embodiment the method further comprises depositing a first current collector on the cathode and depositing a second current collector on the anode.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows morphological and structural analyses showing robust outside-in structures of LAZO@LNO.

FIG. 2 shows the superior electrochemical performance of LAZO@LNO- over LNO-based ASSLBs.

FIG. 3 shows the electrochemical behavior showing the significantly enhanced Li-ion transport dynamics for LAZO@LNO-based ASSLBs.

FIG. 4 shows XRD and PFIB-SEM analysis showing the electro-chemo-mechanical evolution of composite cathodes at different stages.

FIG. 5 shows XAS analysis showing the evolution of the LNO, LAZO@LNO, and LPSC structure in the composite cathodes at different stages.

FIG. 6 shows XPS and Raman analysis showing the evolution of the LPSC surface composition in the composite cathodes at different stages.

FIG. 7 shows Rietveld-refined XRD patterns of pristine LNO and LAZO@LNO powders.

FIG. 8 shows Typical SEM image (FIG. 8A) of LAZO@LNO secondary particles, and corresponding SEM-EDX mapping (FIG. 8B-8E) and analysis (FIG. 8F) of O, Ni, Al, and Zn elements. Note: The electron beam comes from the upper right direction.

FIG. 9 shows enlarged Ni—K XANES spectra of LNO, LAZO@LNO samples and NiO, LaNiO3 and KNiIO6 references.

FIG. 10 shows O—K SXAS data of LNO and LAZO@LNO powders.

FIG. 11 shows TEY Ni-L₃ SXAS data of pristine pure LiNiO₂.

FIG. 12 shows TEY Ni-L3 SXAS data of pristine pure LNO and LAZO@LNO cathodes (PPC), pristine, 4.3 V charged, 1^{st} cycle discharged, and 200^{th} cycle discharged LNO and LAZO@LNO composite cathodes (PCC, 4.3 V, 1^{st}, 200^{th}).

FIG. 13 shows XPS data of Ni 2p, O 1s, Li 1s, C 1s, Al 2p and Zn 2p of LNO and LAZO@LNO powders.

FIG. 14 shows Ionic and electronic conductivity of the LAZO coating layer. FIG. 14A shows a Nyquist plot of the Au/LAZO/Au cell. FIG. 14B shows a current-time curve of the Au/LAZO/Au cell.

FIG. 15 shows galvanostatic charge-discharge voltage profiles of high-loading LAZO@LNO-based ASSLBs at the 1st, 2nd, 5th, 10th, 20th, 50th, 100th and 200th cycles at different testing conditions.

FIG. 16 shows galvanostatic charge-discharge voltage profiles and the corresponding cycling stability and Coulombic efficiency of another two LAZO@LNO-based ASSLBs (65% CAM ratio) with a cathode loading of ˜9.06 and ˜8.28 mg·cm⁻². All experiments were performed at 0.2 C, 35° C. and 150 MPa between 2.0 and 3.7 V vs. LiIn/In, corresponding to approximately 2.6-4.3 V vs. Li+/Li.

FIG. 17 shows galvanostatic charge-discharge voltage profiles and the corresponding cycling stability and Coulombic efficiency of another two LAZO@LNO-based ASSLBs (65% CAM ratio) with a cathode loading of ˜24.46 and ˜25.29 mg·cm⁻². All experiments were performed at 0.1 C, 35° C. and 150 MPa between 2.0 and 3.7 V vs. LiIn/In, corresponding to approximately 2.6-4.3 V vs. Li+/Li.

FIG. 18 shows galvanostatic charge-discharge voltage profiles and the corresponding cycling stability and Coulombic efficiency of another two LAZO@LNO-based ASSLBs (65% CAM ratio) with a cathode loading of ˜23.89 and ˜25.84 mg·cm⁻². All experiments were performed at 0.2 C, 35° C. and 150 MPa between 2.0 and 3.7 V vs. LiIn/In, corresponding to approximately 2.6-4.3 V vs. Li+/Li.

FIG. 19 shows galvanostatic charge-discharge voltage profiles and the corresponding cycling stability and Coulombic efficiency of another two LAZO@LNO-based ASSLBs (75% CAM ratio) with a cathode loading of ˜24.46 and ˜25.22 mg·cm⁻². All experiments were performed at 0.2 C, 60° C. and 2 MPa between 2.0 and 3.7 V vs. LiIn/In, corresponding to approximately 2.6-4.3 V vs. Li+/Li.

FIG. 20 shows galvanostatic charge-discharge voltage profiles and the corresponding cycling stability and Coulombic efficiency of another two LAZO@LNO-based ASSLBs (75% CAM ratio) with a cathode loading of ˜24.84 and ˜24.84 mg·cm-2. All experiments were performed at 1 C, 60° C. and 2 MPa between 2.0 and 3.7 V vs. LiIn/In, corresponding to approximately 2.6-4.3 V vs. Li+/Li.

FIG. 21 shows TEY Ni-L_{2,3} SXAS data of 4.3 V charged LAZO@LNO composite cathodes (LAZO@LNO-4.3 V). Bottom: The calculated Ni-L_{2,3} SXAS spectra (purple line) of LAZO@LNO-4.3 V, which is simulated with Ni^{(2+δ)+} (green line) and Ni^{(4-δ)+} (yellow line).

FIG. 22 shows the cycling performance comparison of LNO, 50 cycles, 100 cycles, and 150 cycles ALD LAZO coated LNO (50LAZO@LNO, 100LAZO@LNO, 150LAZO@LNO) cathodes for ASSLBs (65% CAM ratio) in the voltage range of 2.6-4.3 V (vs. Li+/Li) at 0.2 C, 35° C. and 150 MPa.

For simplicity and clarity of illustration, elements shown in the figures are not necessarily drawn to scale, and the dimensions of some elements may be exaggerated relative to other elements. In addition, reference numerals may be repeated among the figures to indicate corresponding or analogous elements.

### DETAILED DESCRIPTION

### Ultrathin and Uniform Surface Coating and Near-Surface Doping

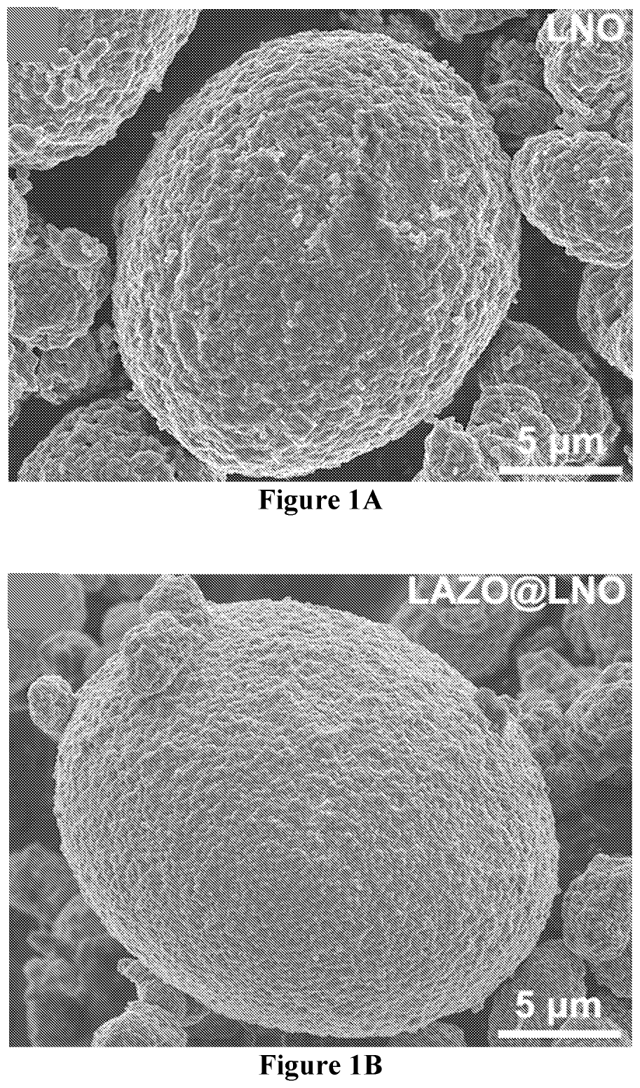

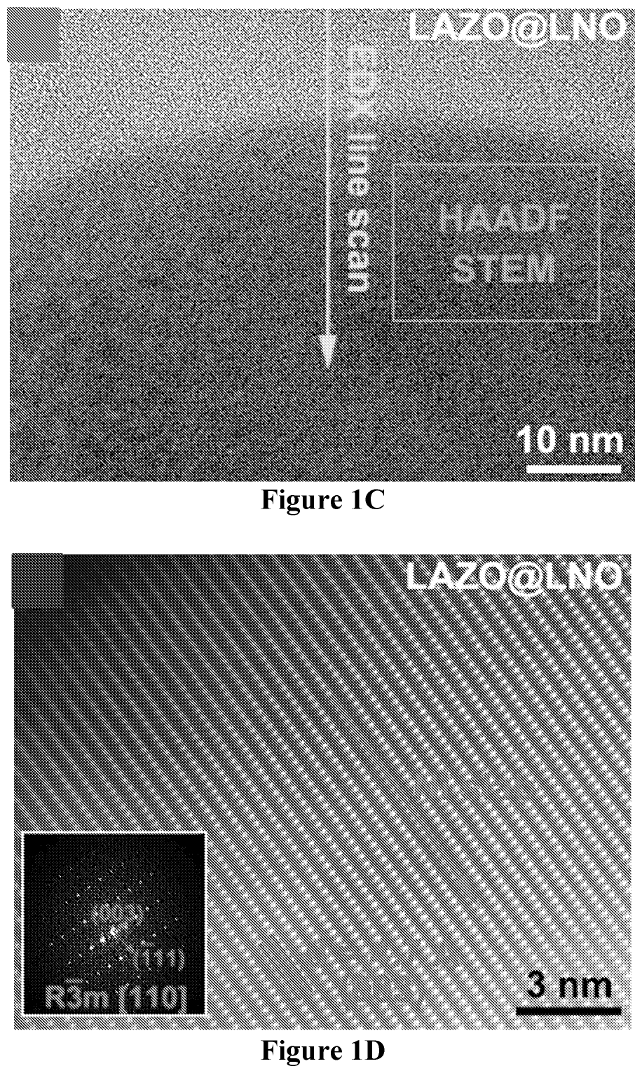

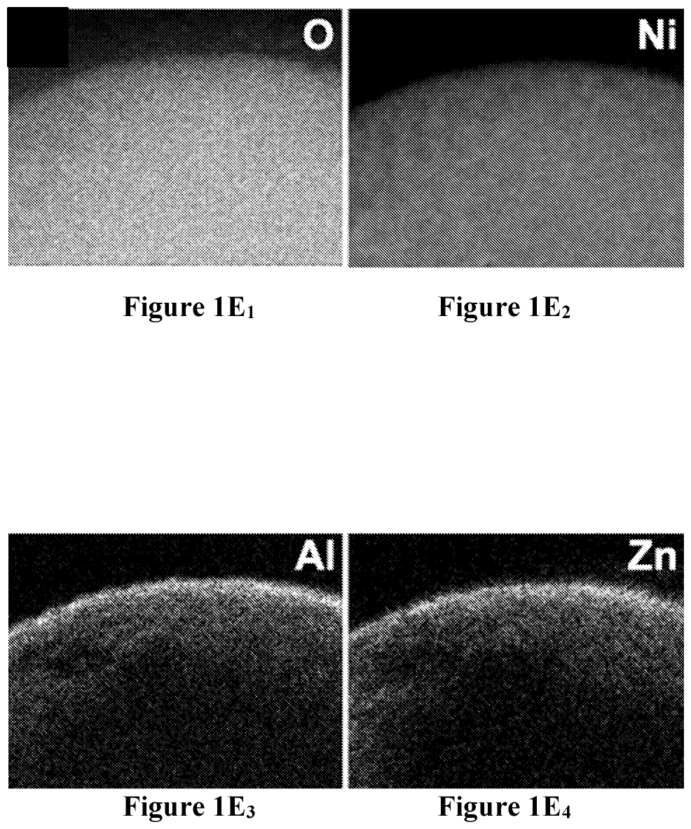

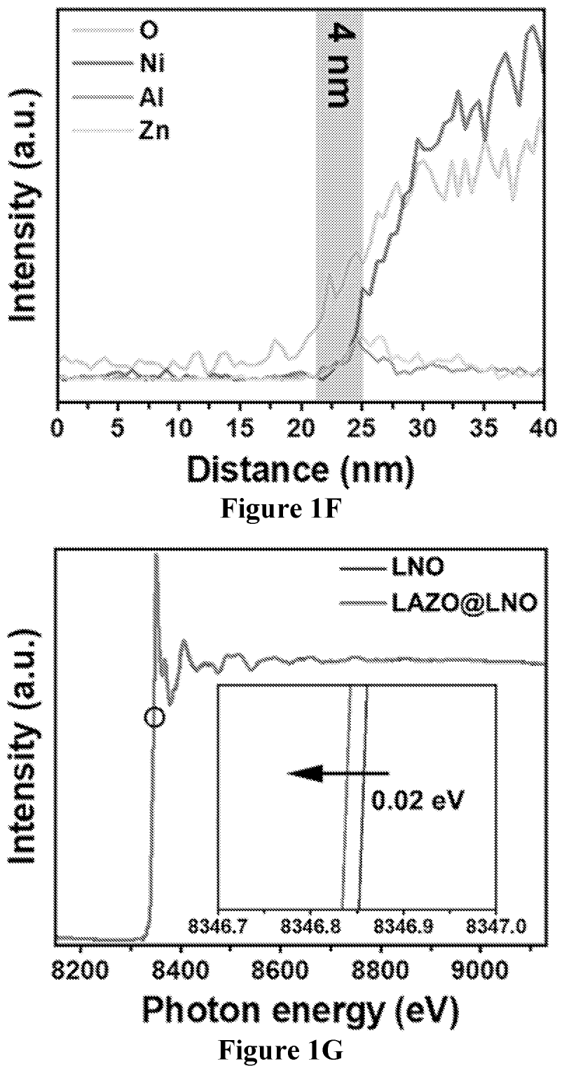

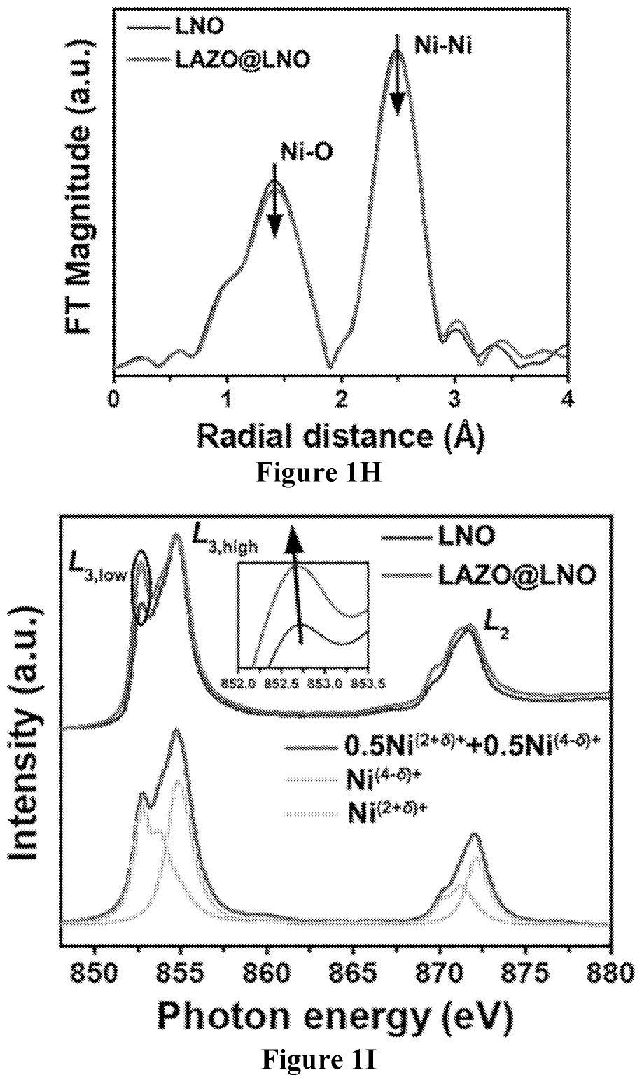

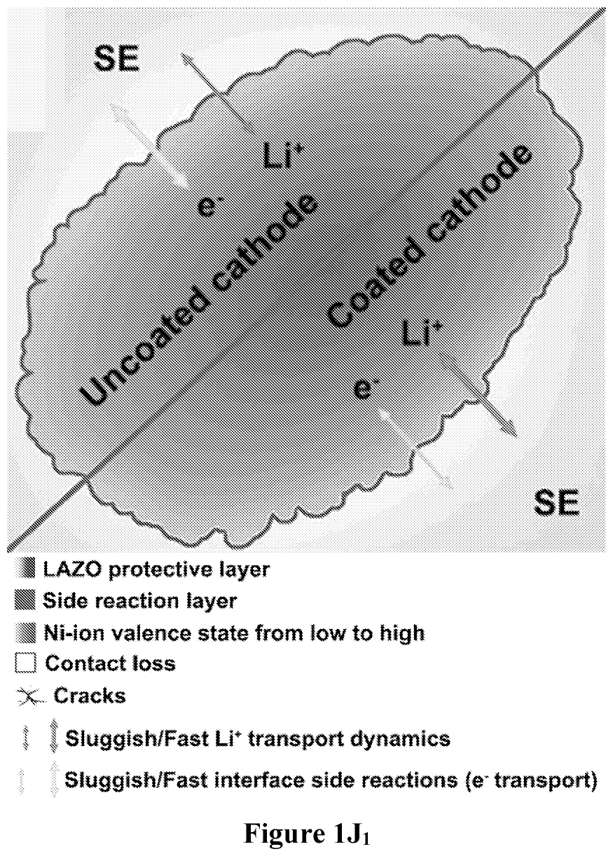

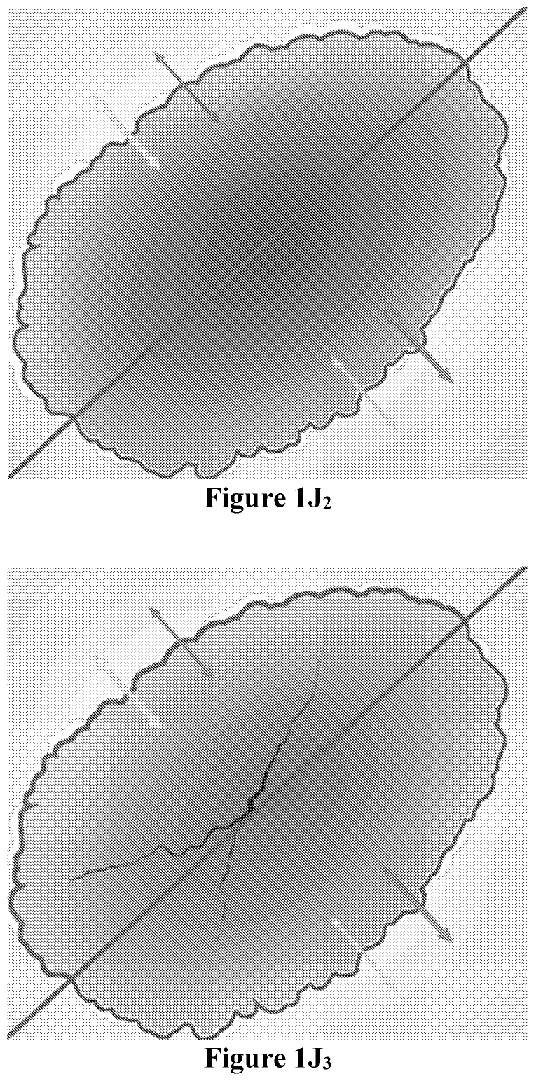

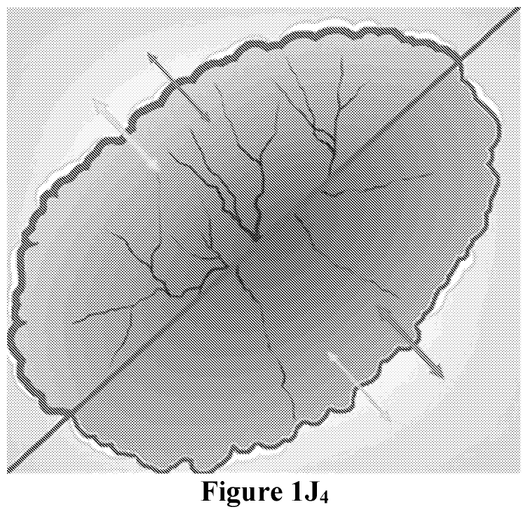

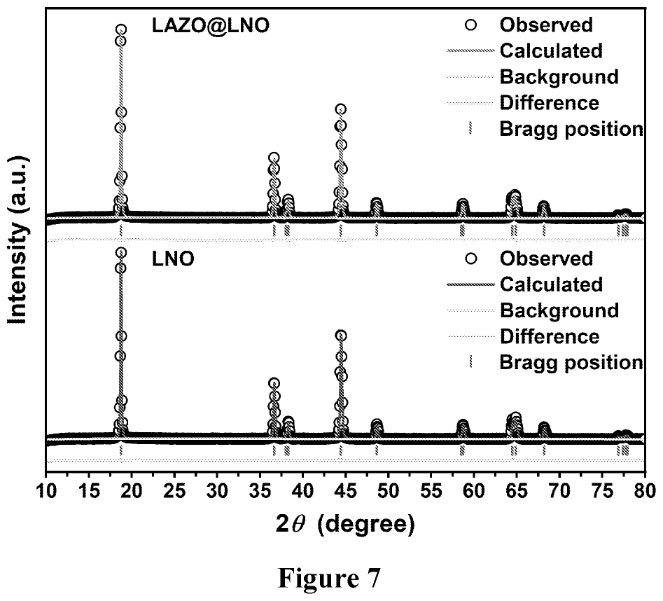

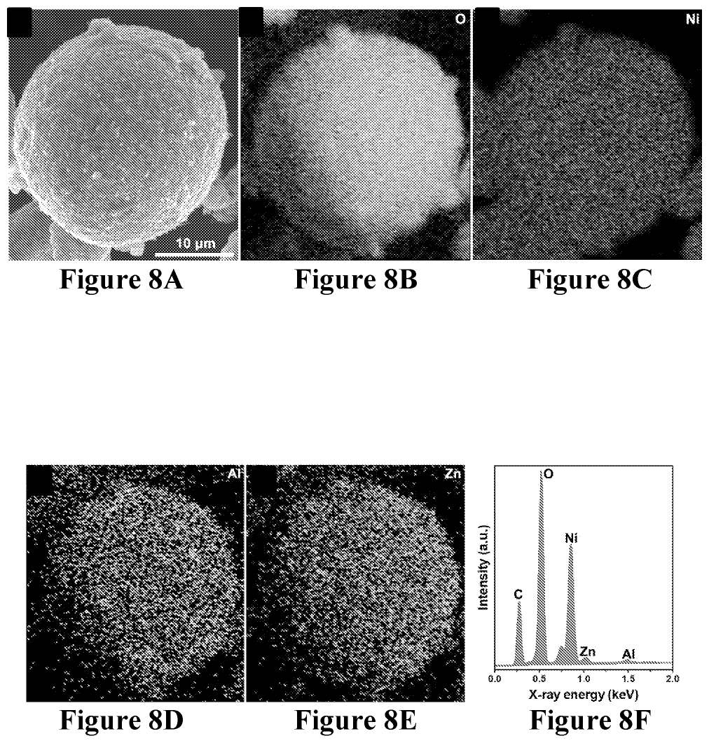

To understand how the ultrathin ALD LAZO protective layer affects the electrochemical performance of the LNO cathodes, the structural and chemical features of as-prepared LNO and LAZO@LNO cathode powders are shown in their fresh state. X-ray diffraction (XRD) results (FIG. 7 and Table 1) show that the LNO and LAZO@LNO powders both display a hexagonal R3̅m structure and an ultralow (<1%) cation mixing (Li/Ni antisite defects). The clear separation of (006)/(102) and (018)/(110) peaks in these two XRD patterns is indicative of a well-developed layered structure for both types of samples. This means that the ALD process does not affect the bulk crystalline structure of LNO. Scanning electron microscopy (SEM) images (FIGS. 1B and 1C) reveal that the morphology of LNO and LAZO@LNO consists of spherical polycrystalline particles with an average particle size of 10-15 μm. The spherical secondary particles consist of agglomerated primary particles with estimated particle sizes of about 50-200 nm. After being modified with ALD LAZO, the surface of the secondary particles becomes somewhat compact and fuzzy because of the infusion of LAZO. The SEM-energy dispersive X-ray (SEM-EDX) mapping results (FIG. 8) show that both Al and Zn are uniformly dispersed on the surface of the LNO particles after ALD LAZO protection, indicating that the LAZO protective layer has been uniformly modified on the surface of the LNO particles.

FIG. 1A and FIG. 1B show typical SEM images of LNO and LAZO@LNO secondary particles. FIG. 1C shows low-magnification a HAADF-STEM image of a LAZO@LNO lamella. FIG. 1D shows a high-magnification HAADF-STEM image of the same LAZO@LNO lamella along the [110] zone axis (rectangular region in FIG. 1C). The inset of FIG. 1D shows a fast Fourier transform pattern showing crystalline LAZO@LNO. FIG. 1E and FIG. 1F show STEM-EDX mapping and line scans (O, Ni, Al, and Zn) of the area shown in FIG. 1C. FIG. 1G shows Ni—K XANES spectra of LNO and LAZO@LNO powders. FIG. 1H shows Fourier transform radial distribution function for the Ni—K EXAFS spectra of LNO and LAZO@LNO powders. FIG. 1I shows total electron yield (TEY) Ni-L_{2,3} SXAS data of LNO and LAZO@LNO powders; Bottom: The calculated Ni-L_{2,3} SXAS data (purple line) of LNO (Ni³⁺) reference, which is simulated with Ni^{(2+δ)+} (green line) and Ni^{(4-δ)+} (yellow line). FIG. 1J shows a schematic illustration of the role of the LAZO protective layer.

TABLE 1
Refined structure parameters of LNO and LAZO@LNO.

| | | | | | | |
|---|---|---|---|---|---|---|
| Atom | Site | x | y | z | Occupancy | Bᵢₛₒ |

LNO (R_{wp} = 2.32%, Rₚ = 1.61%, χ² = 2.45)
LiNiO₂ (Space group: R3̅m)
Lattice parameters: a = b = 2.8721(5) Å,
c = 14.1854(5) Å, V = 101.3416(5) Å³

| | | | | | | |
|---|---|---|---|---|---|---|
| Li | 3a | 0 | 0 | 0 | 1.0 | 0.472(3) |
| Ni | 3b | 0 | 0 | 0.5 | 1.0 | 0.086(3) |
| O | 6c | 0 | 0 | 0.2449(8) | 1.0 | 0.349(3) |

LAZO@LNO (R_{wp} = 2.33%, Rₚ = 1.58%, χ² = 2.50)
LiNiO₂ (Space group: R3̅m)
Lattice parameters: a = b = 2.8745(9) Å,
c = 14.1894(6) Å, V = 101.5424(7) Å³

| | | | | | | |
|---|---|---|---|---|---|---|
| Li1 | 3a | 0 | 0 | 0 | 0.99(1) | 0.219(6) |
| Ni1 | 3a | 0 | 0 | 0 | 0.00(9) | 0.219(6) |
| Li2 | 3b | 0 | 0 | 0.5 | 0.00(9) | 0.033(6) |
| Ni2 | 3b | 0 | 0 | 0.5 | 0.99(1) | 0.033(6) |
| O | 6c | 0 | 0 | 0.2441(2) | 1.0 | 0.412(0) |

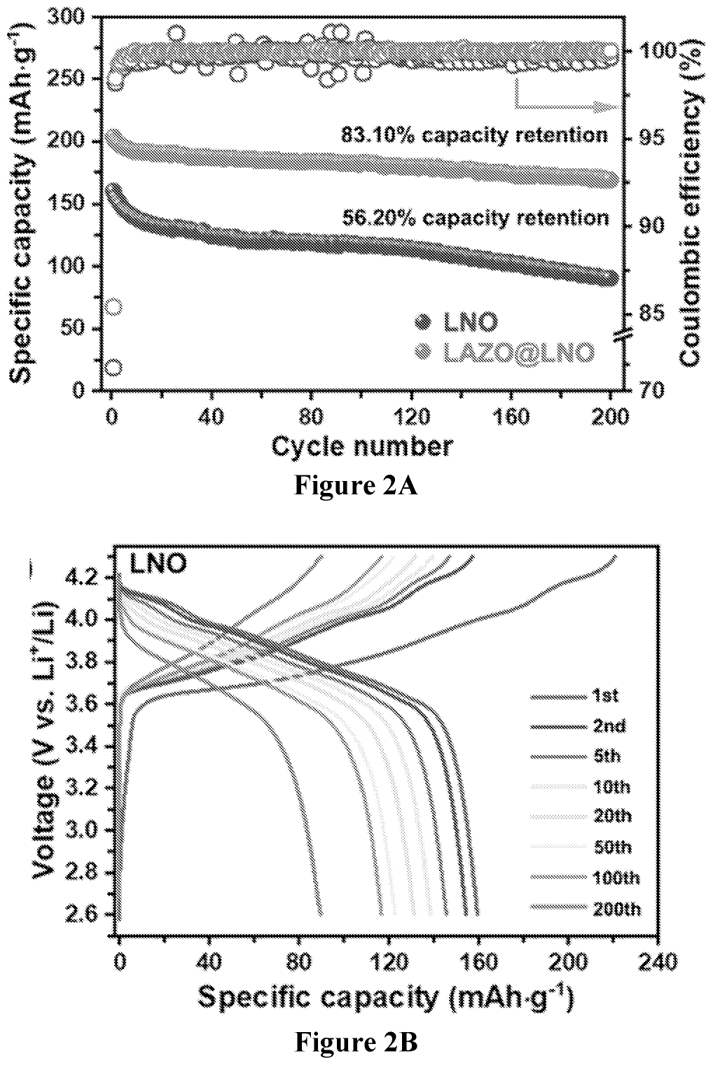

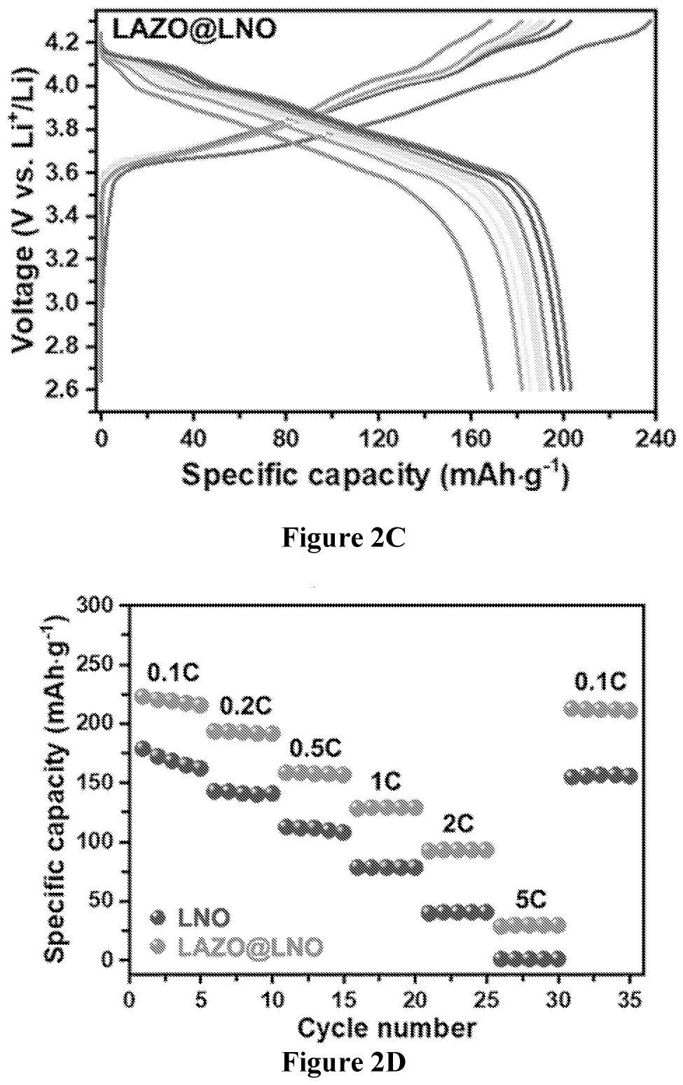

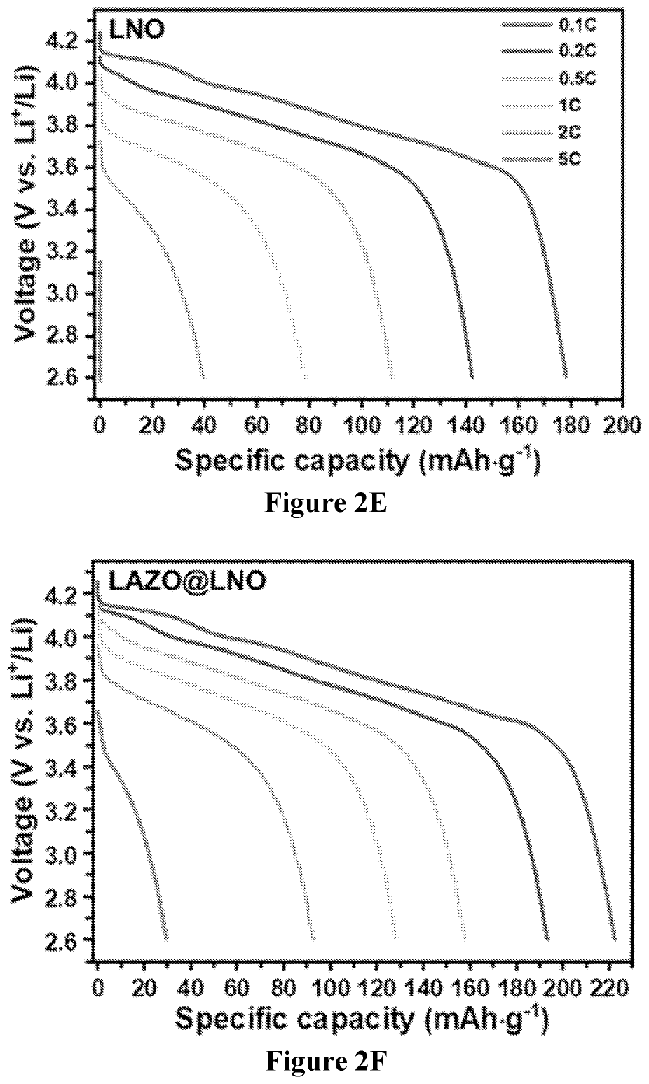

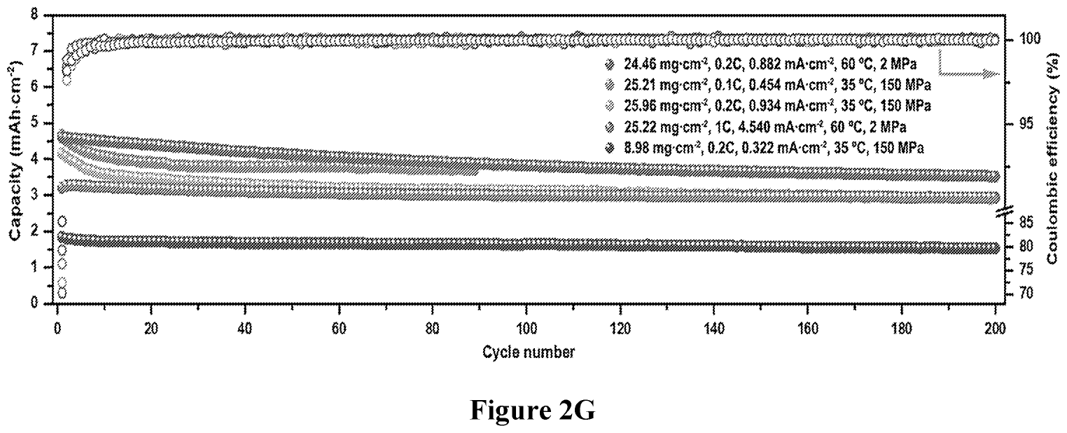

FIG. 2A shows the cycling stability and Coulombic efficiency of LNO- and LAZO@LNO-based ASSLBs at 0.2 C, 35° C. and 150 MPa. FIG. 2B and FIG. 2C show galvanostatic charge-discharge voltage profiles of LNO- and LAZO@LNO-based ASSLBs at the 1st, 2nd, 5th, 10th, 20th, 50th, 100th, and 200th cycles at 0.2 C, 35° C. and 150 MPa. FIG. 2D shows the rate capability of LNO- and LAZO@LNO-based ASSLBs at 35° C. and 150 MPa. FIG. 2E and FIG. 2F show the discharge voltage curves of LNO- and LAZO@LNO-based ASSLBs at different current densities. FIG. 2G shows the electrochemical performance of the LAZO@LNO-based ASSLB at high loading. The CAM ratio of ASSLBs tested at 35° C. and 60° C. is 65% and 75%, respectively. All experiments were performed between 2.0 and 3.7 V vs. LiIn/In, corresponding to approximately 2.6-4.3 V vs. Li+/Li.

Density functional theory (DFT) calculations confirm that the metal heteroatoms of ALD precursors can favorably dope transition metal oxide substrates by insertion of cations into interstitial sites in the near-surface zones, which alters the superficial microstructure, composition and the oxidation state of the transition metal cations in the near-surface zones of the particles. High-angle annular dark-field scanning transmission electron microscopy (HAADF-STEM) is used herein to verify the effects of the ALD LAZO protective layer, which includes a LAZO surface coating region and an Al+Zn near-surface doping region (FIGS. 2D-G). Contrast in the HAADF-STEM images exhibits a Z^{1.7} dependence, where Z is the atomic number. As a result, the HAADF-STEM image in FIG. 2E displays the 3b-site Ni atoms in the transition-metal layer. The 3b-site Ni slabs exhibit well-ordered distributions and typical diffraction patterns of (003) after fast Fourier transform (FFT) along the [110] direction, demonstrating their good crystalline layered structure. The Al+Zn doping depth is in the order of a nanometer or less. STEM-EDX mapping (FIG. 2F) and O, Ni, Al, and Zn line scans (FIG. 2G) of the LAZO@LNO lamella indicate that the LAZO protective layer (˜4 nm) consisting of a LAZO surface coating region and an Al+Zn near-surface doping region, is uniformly dispersed on the surface of the LNO secondary particles.

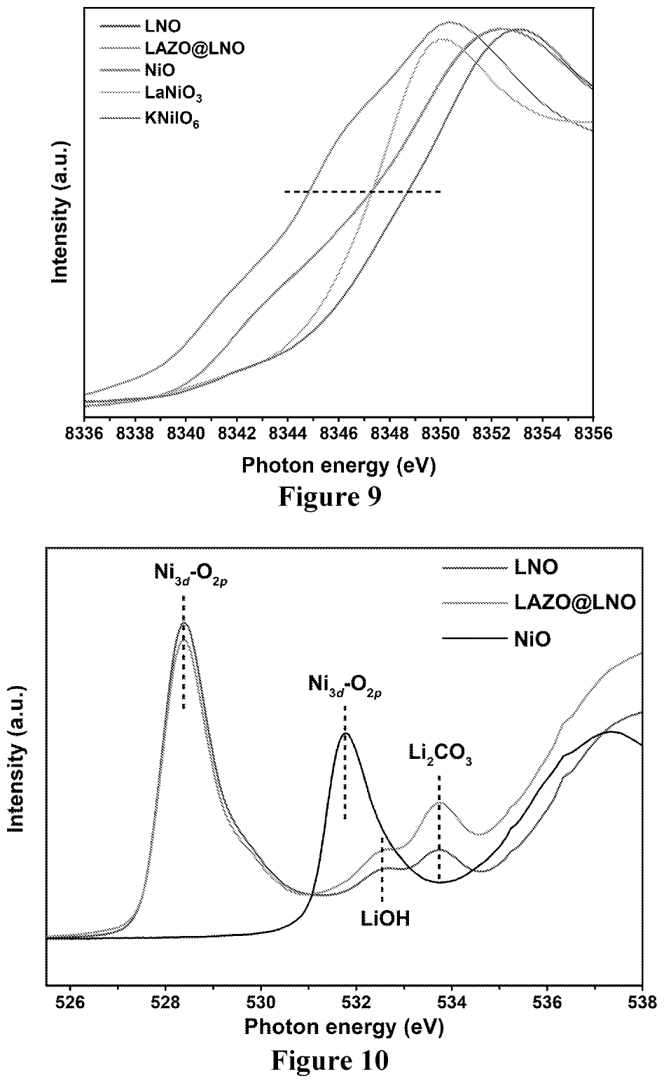

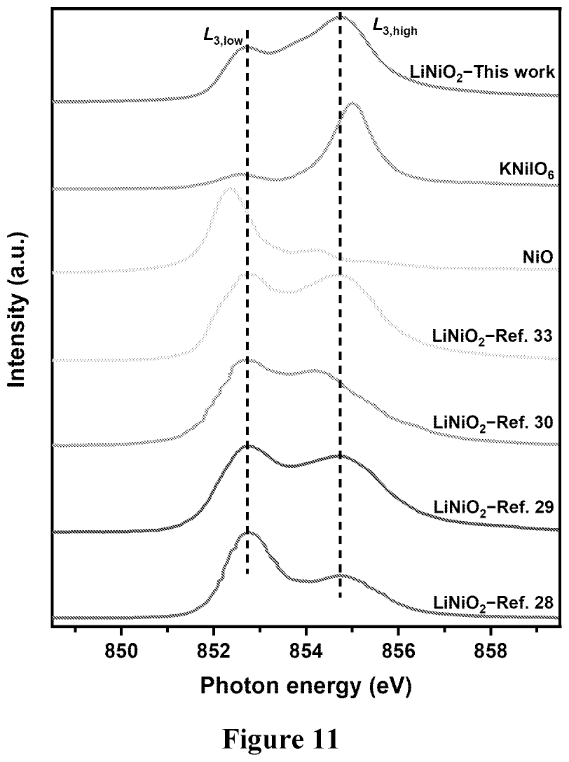

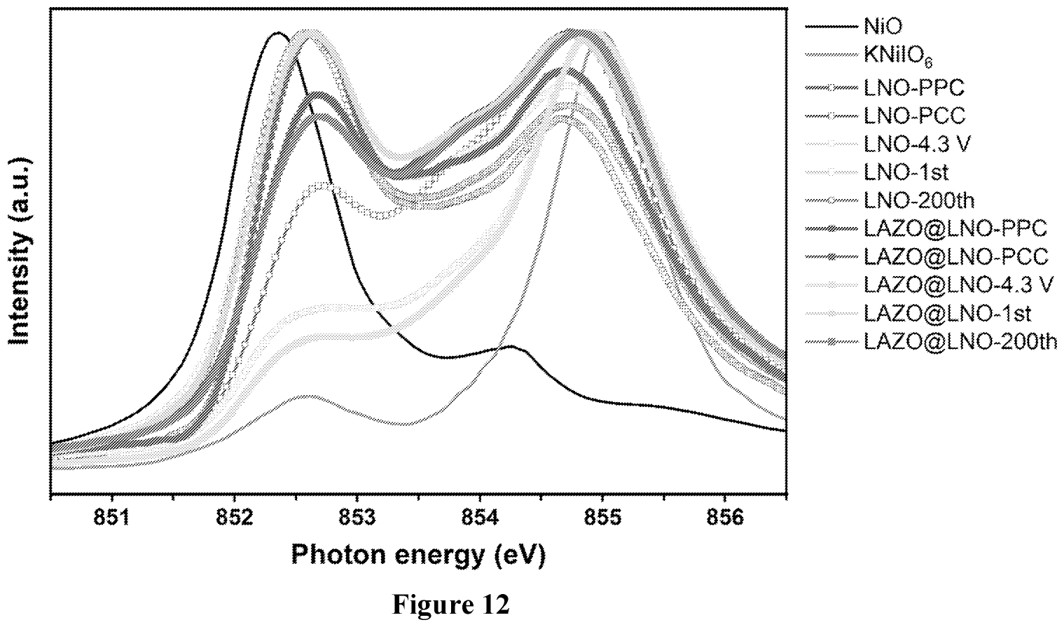

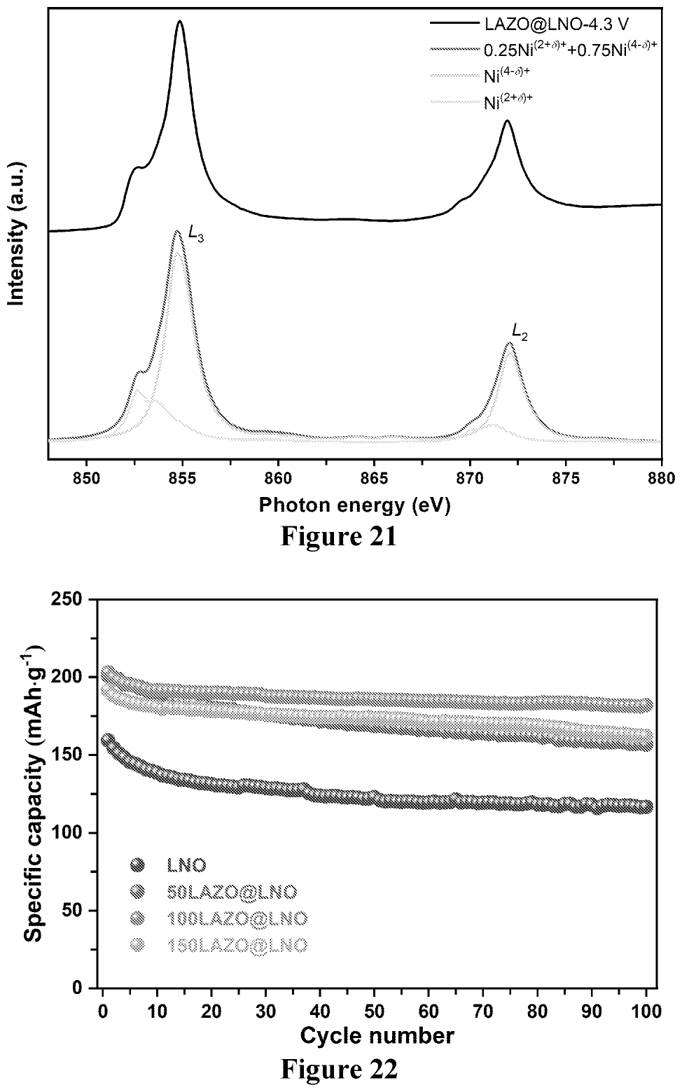

To show the influence of the ALD LAZO protective layer on the electronic structure of LNO, hard and soft X-ray absorption spectroscopy (HXAS and SXAS) techniques were used, which are bulk- and surface-sensitive, respectively, to probe the oxidation state, spin state, and local environment. Bulk-sensitive Ni—K edge X-ray absorption near edge structure (XANES) and extended X-ray absorption fine structure (EXAFS) spectra were collected in the transmission mode (FIGS. 1H-1I). The absorption edge of the Ni—K XANES spectrum is shifted (˜0.02 eV) to lower energy after the addition of the ALD LAZO protective layer (FIG. 1H), revealing a slight decrease (˜0.8%, FIG. 9) in the overall valence state of Ni ions owing to Al+Zn near-surface doping. Moreover, the intensity of the signals corresponding to Ni—O and Ni—Ni in the Fourier-transform Ni—K EXAFS spectrum also declines very slightly, because of the decrease in the coordination number of the central Ni atoms (FIG. 1I), indicating that some Ni atoms are displaced by other atoms (namely, Al+Zn atoms from the coating layer). To further explore the electronic structure at the surface of LNO after the ALD LAZO protection, surface-sensitive Ni-L_{2,3} edge (FIG. 1J) and O—K edge (FIG. 10) SXAS data were collected in the total electron yield (TEY) mode with a typical probing depth of 2-5 nm. LNO displays superior electrochemical performance, since high-pressure O₂ is needed to obtain the stoichiometric LNO. It is noted that the present LNO samples are free from Ni²⁺ ions as shown in FIG. 11. It is clear that the present LNO samples have a very high oxidization state of Ni ions. Presented herein is a detailed study on the intrinsic electronic struture of LNO by theoretical calculation of its Ni-L_{2,3} SXAS data. It is well known that Ni³⁺ ions exhibit a negative charger transfer energy, which leads to electron holes on the oxygen atoms. The holes on oxygen atoms spread disproportionately and the content of holes transfers from one side to the another. In such case, the ground state can be well described by a double configuration of d⁸L^{1-δ}d⁸L^{1+δ} (L denotes hole at O2p orbitals). Then, the Ni-L_{2,3} SXAS data was simulated by performing the configurational interaction cluster (CIC) calculation to capture the effect of the hole-disproportionation. As shown in FIG. 21 the experimental SXAS data of LNO can be nicely reproduced by the coherent sum of the two different final state configurations: pd⁹L^{1-δ} (yellow line) configuration and pd⁹L^{1+δ} (green line) configuration (p stands for 2p core hole), which are assigned to an exciton created on the d⁸L^{1-δ} site and d⁸L^{1+δ} site and basically corresponds to the SXAS data of Ni^{(2+δ)+} ions and Ni^{(4-δ)+} ions, respectively. The present disclosure demonstrates that the equal amount of Ni^{(2+δ)+} and Ni^{(4-δ)+} ions (δ=0.4) presents nicely the pristine LNO material, which echoes the average of 3+ oxidization state imposed on Ni ions in LNO. It should be noted that the lower energy component and the higher energy component have different energy positions as Ni²⁺ and Ni⁴⁺ reference materials as shown in FIG. 12.

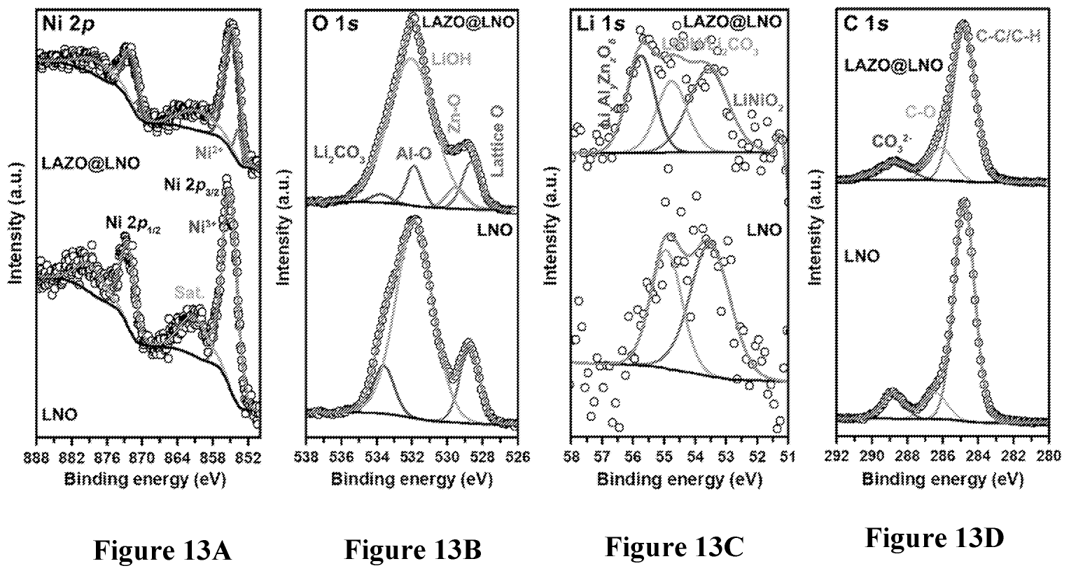

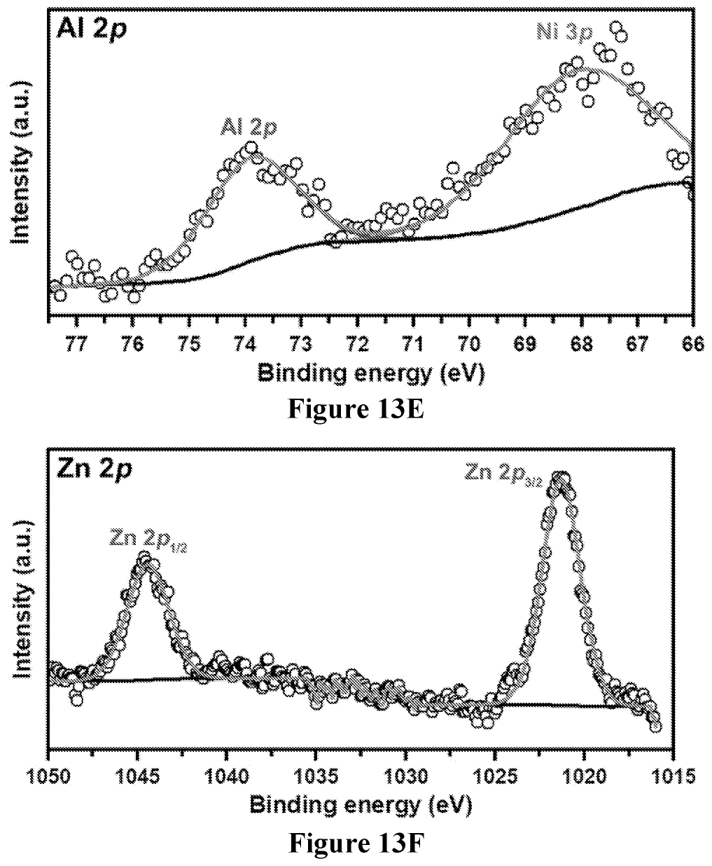

Valence-state changes can be qualitatively obtained from the Ni-L_{2,3} SXAS data via the deconvolution of the Ni-L₃ edge into low-energy (L_{3,low}) and high-energy (L_{3,high}) states, where the ratio L_{3,low}/L_{3,high} is negatively correlated with the valence state of Ni ions. Upon addition of the ALD LAZO protective layer, the L_{3,low}/L_{3,high} ratio increases from 0.65 to 0.86, indicating a lower valence state on the surface of LAZO@LNO. In the O—K SXAS data (FIG. 10), the dominant pre-edge peak below 532 eV originates from the unoccupied O2p state derived from the covalent interaction between the O2p and TM3d orbitals, and its spectral intensity increases with the valence while its energy position shifts to lower energy with an increase of the valence state of 3d elements. Of note is a decrease in the number of unoccupied states in the Ni3d-O2p hybridized orbitals upon the addition of the ALD LAZO protective layer; this decrease is attributed to the reduced number of d-holes and the sharing of these holes with the oxygen ligands, including the associated decrease in covalency. The O—K SXAS data are consistent with the Ni-L_{2,3} SXAS data. The weak peaks are assigned at 532.6 eV and 533.7 eV to LiOH and Li₂CO₃, respectively. The X-ray photoelectron spectroscopy (XPS) data (FIG. 13) show that the amount of LiOH and Li₂CO₃ at the surface of LNO secondary particles decreases slightly upon coating with the ALD LAZO protective layer. The residual Li species (e.g., LiOH, Li₂CO₃) have been demonstrated to help improve the performance of ASSLBs compared to uncoated cathodes, albeit capacity fading still occurs. The XPS results also confirm the existence of a LAZO protective layer on the surface of the LNO particles.

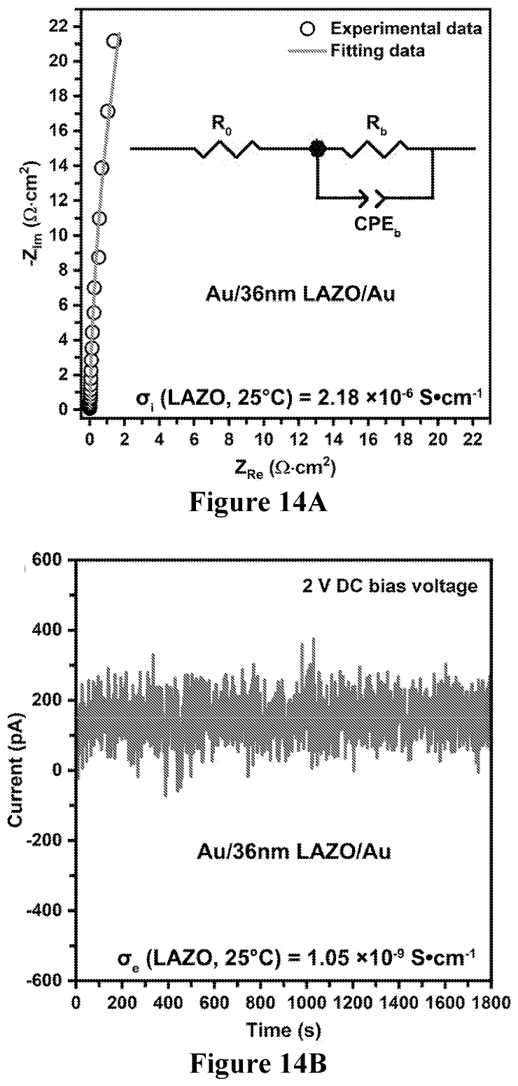

The as-prepared ultrathin ALD LAZO protective layer consisting of a LAZO surface coating region and an Al+Zn near-surface doping region has several benefits (FIG. 1J): (i) The ultrathin and stable interphase enables fast interfacial Li-ions transport dynamics. The experimentally measured ionic conductivity of the as-prepared LAZO protective layer is ˜2.18×10⁻⁶ S·cm⁻¹ (FIG. 14A), which is much higher than the commonly used but expensive LiNbO₃ coating layer (˜6.39×10⁻⁸ S·cm⁻¹).²³ (ii) The ultrathin quaternar oxide fast ionic conductors with appropriate electronic conductivity (˜1.05×10⁻⁹ S·cm⁻¹, FIG. 14B) help to passivate against further chemical/electrochemical interfacial side reactions but don't block the electronic conduction. (iii) Al+Zn near-surface doping improves the structural stability of LNO during the charge-discharge process. The doping positively affects Ni-rich LiNi_{1-x-y}CoₓMn_{y}O₂ cathodes and improves their stability. (iv) The slight decrease in Ni valence state in the near surface can restrain the contact side reactions between the cathodes and sulfide-based SEs, thus enhancing the capacity of ASSLBs. (v) By applying surface treatments based on compounds comprising abundant elements only, the cost of ASSLBs can be further reduced without sacrificing the battery performance.

### Enhanced Cycling Stability and Rate Capability

To reveal the impact of the ALD LAZO protective layer on the LNO cathodes, electrochemical performances of the reference (untreated LNO) and LAZO-protected LNO cathodes in ASSLBs with argyrodite Li₆PS₅Cl (LPSC) as the SE and LiIn as the anode, are measured. Initially, electrochemical measurements are performed with a relatively low cathode loading of 8.28-9.11 mg·cm⁻². Long-term cycling stability tests at a rate of 0.2 C (36 mA·g⁻¹) were performed with LNO and LAZO@LNO cathodes cycled between 2.6 V and 4.3 V (vs. Li⁺/Li). As shown in FIG. 2A, the LAZO@LNO-based ASSLBs exhibit an initial discharge capacity of ˜203.08 mAh·g⁻¹ and a Coulombic efficiency ˜85.39%—far better values (namely, 27.41% and 13.19% improvement in the initial discharge capacity and Coulombic efficiency, respectively) than those of cells with unprotected LNO cathodes (only 159.39 mAh·g⁻¹ initial discharge capacity and 72.20% Coulombic efficiency). Of note, the LAZO@LNO-based ASSLBs display only a minor capacity decay of 0.845% per cycle, maintaining an 83.10% capacity retention after 200 cycles. In contrast, the capacity of the unprotected LNO-based ASSLBs fades rapidly, with only a 56.20% capacity retention after 200 cycles. The voltage profiles show that the unprotected LNO-based ASSLBs display a much larger polarization than the LAZO@LNO-based ASSLBs (FIGS. 2b-2C). This difference might be the result of a much more pronounced internal impedance increase in LNO-based ASSLBs than that in LAZO@LNO-based ASSLBs, a consequence of severe microstructural and mechanical degradation from side reactions between the unprotected LNO cathodes and argyrodite sulfide-based SEs.

The rate capability is also an important indicator of an exceptional performance of ASSLBs. The rate capability of the LNO- and LAZO@LNO-based ASSLBs at 0.1 C, 0.2 C, 0.5 C, 1 C, 2 C and 5 C (1 C=180 mA·g⁻¹) is compared (FIGS. 2D-2F). The LAZO@LNO-based ASSLBs clearly display a much better rate capability than the LNO-based ASSLBs. In particular, the LAZO@LNO-based ASSLBs still exhibit a specific capacity of 29.49 mAh·g⁻¹ at a very high current density of 5 C (900 mA·g⁻¹), whereas that of the unprotected LNO-based ASSLBs drops to zero at such a high rate (FIG. 2D). With increasing current density, the voltage drop and overpotential of the LAZO@LNO-based ASSLBs are clearly lower than those of the unprotected LNO-based ASSLBs as a result of the smaller polarization (FIGS. 2E-2F).

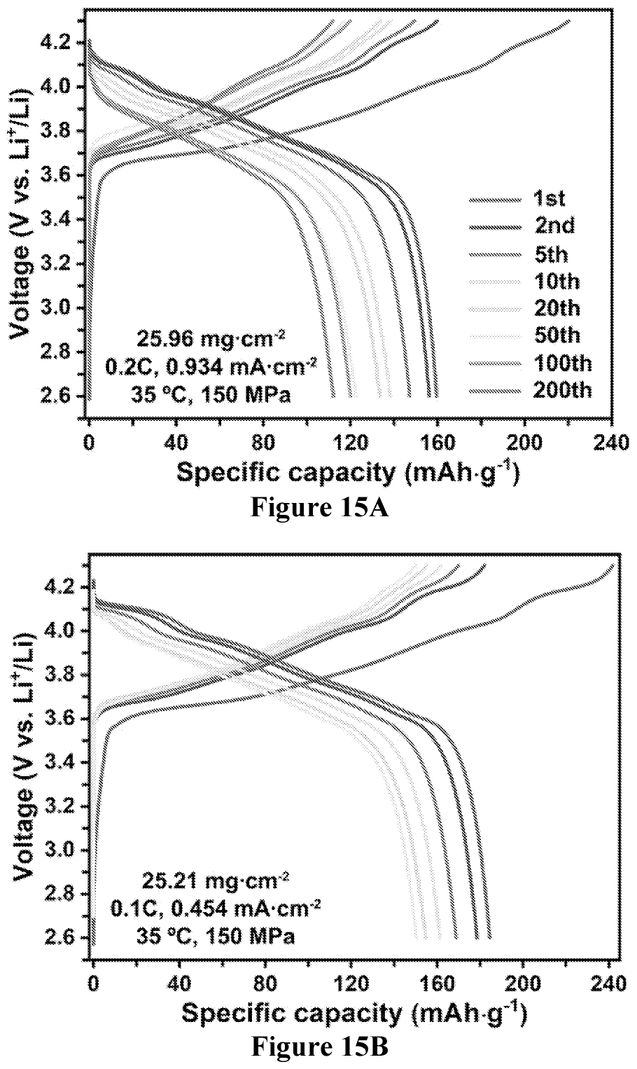

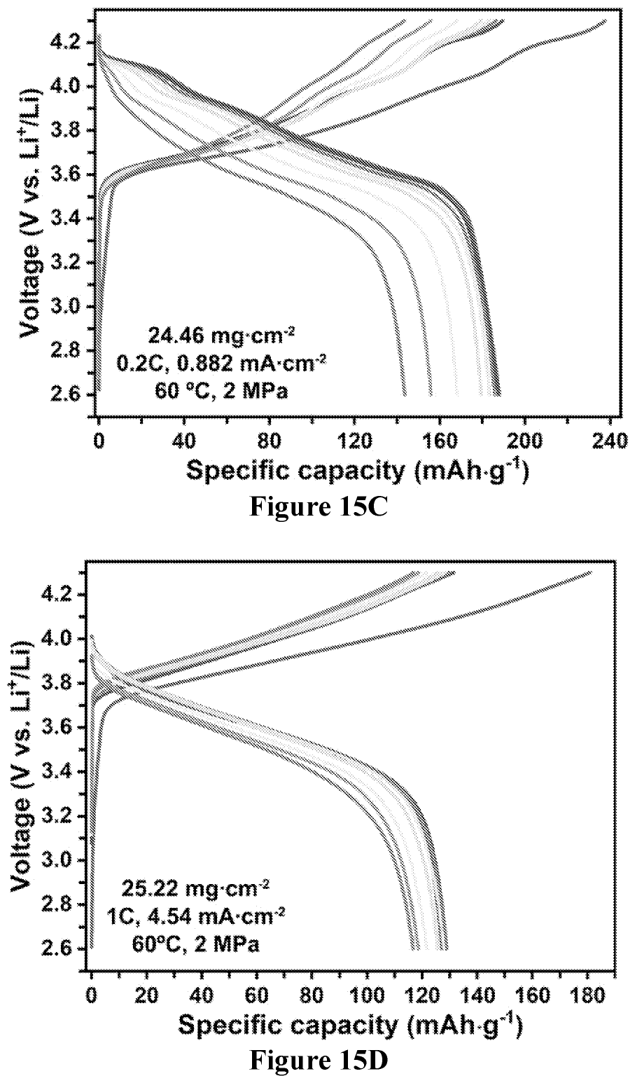

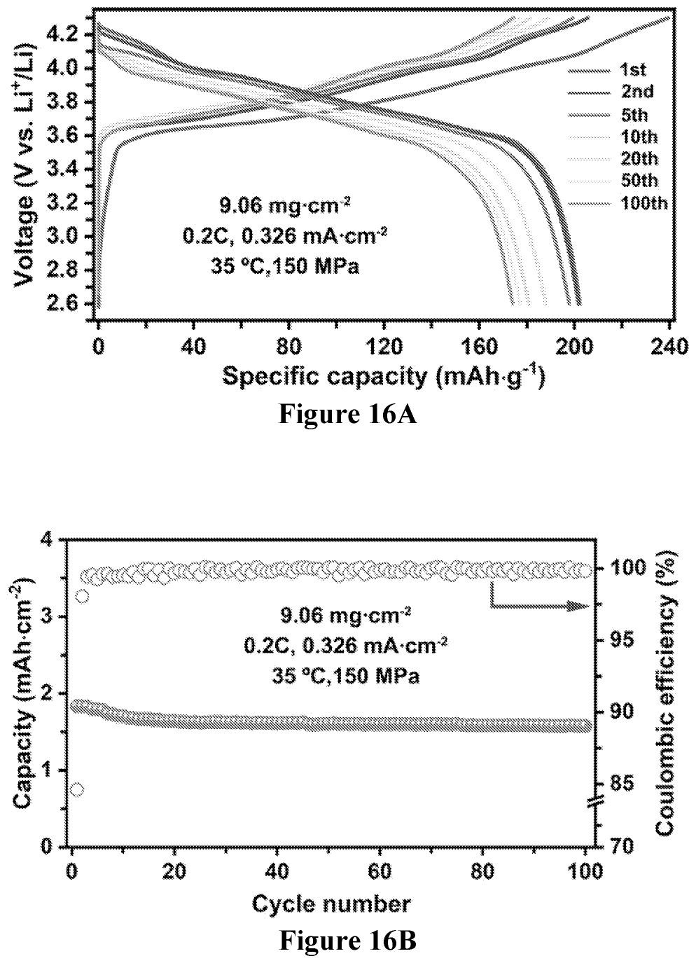

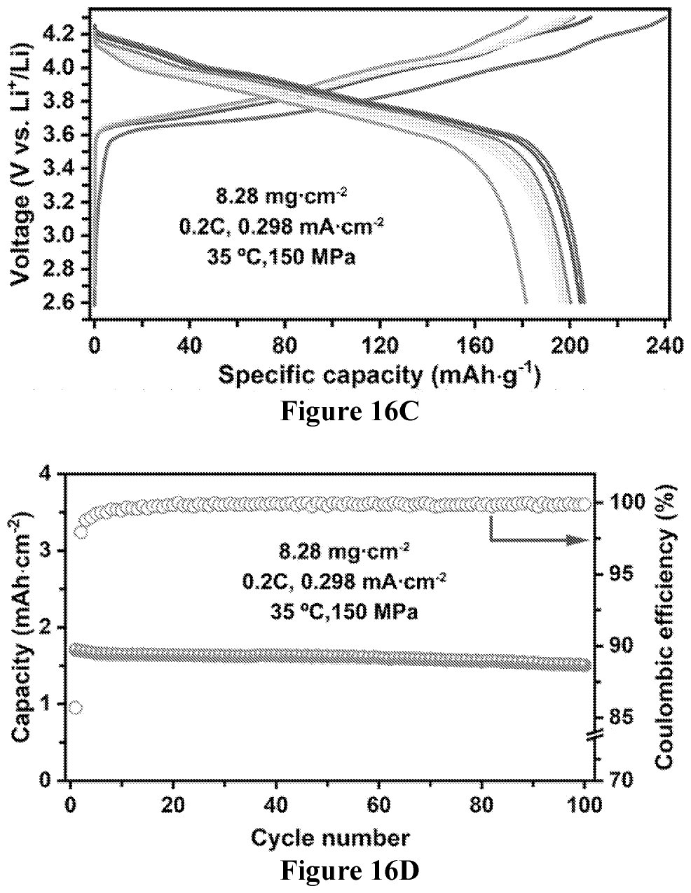

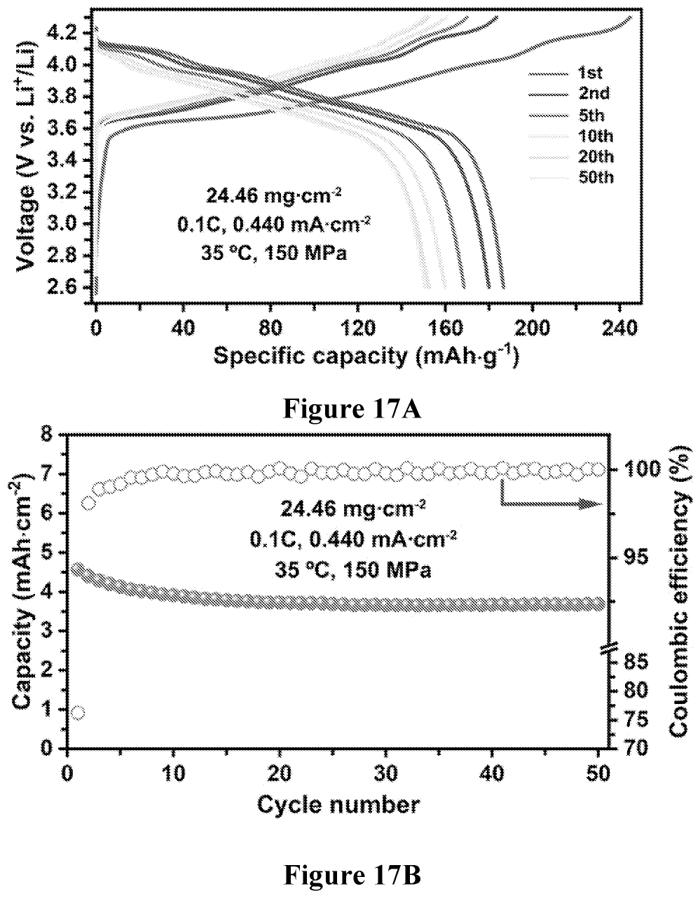

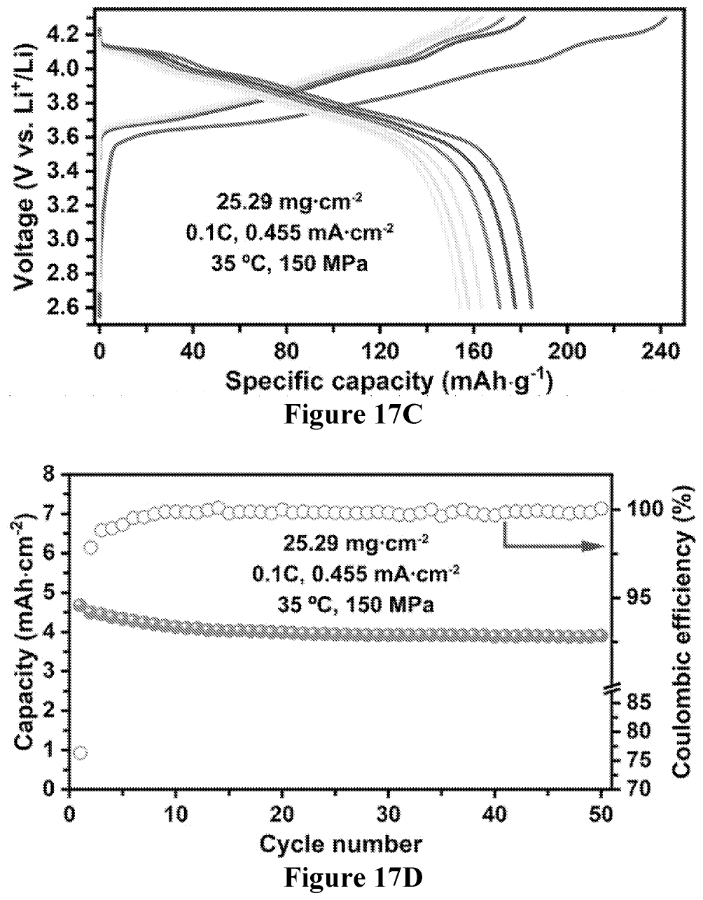

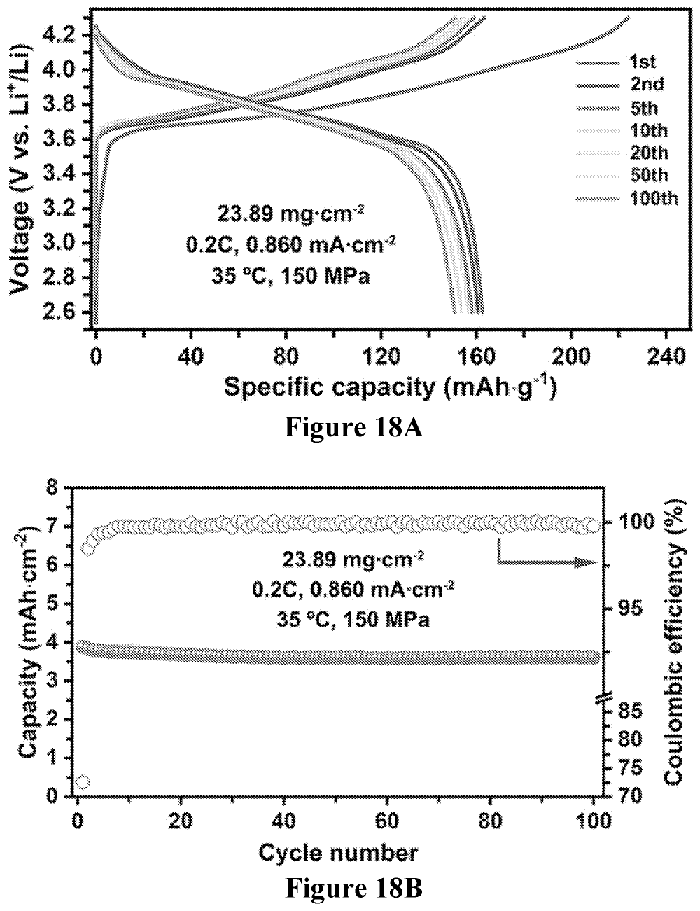

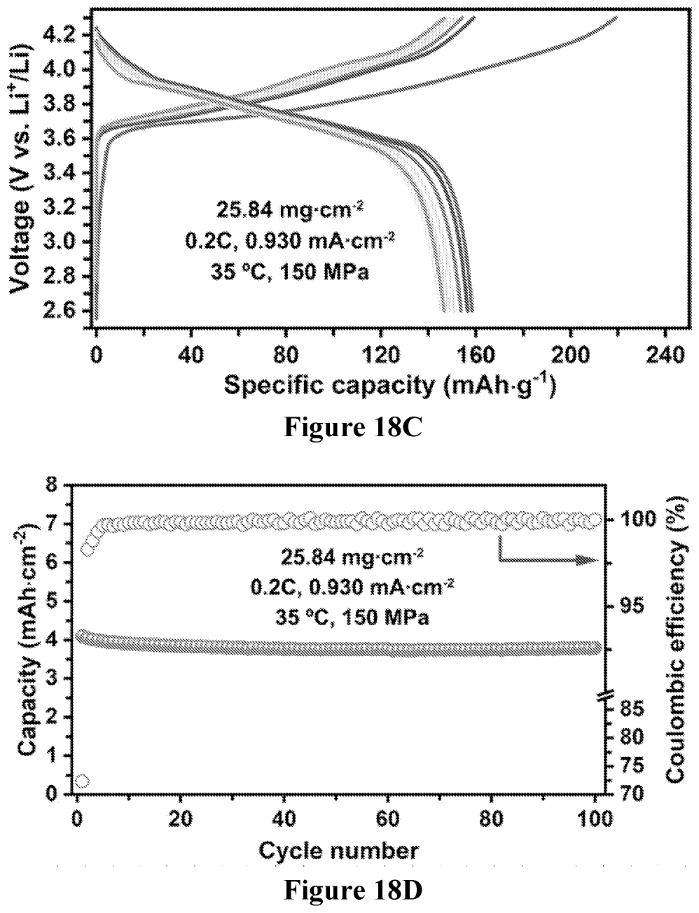

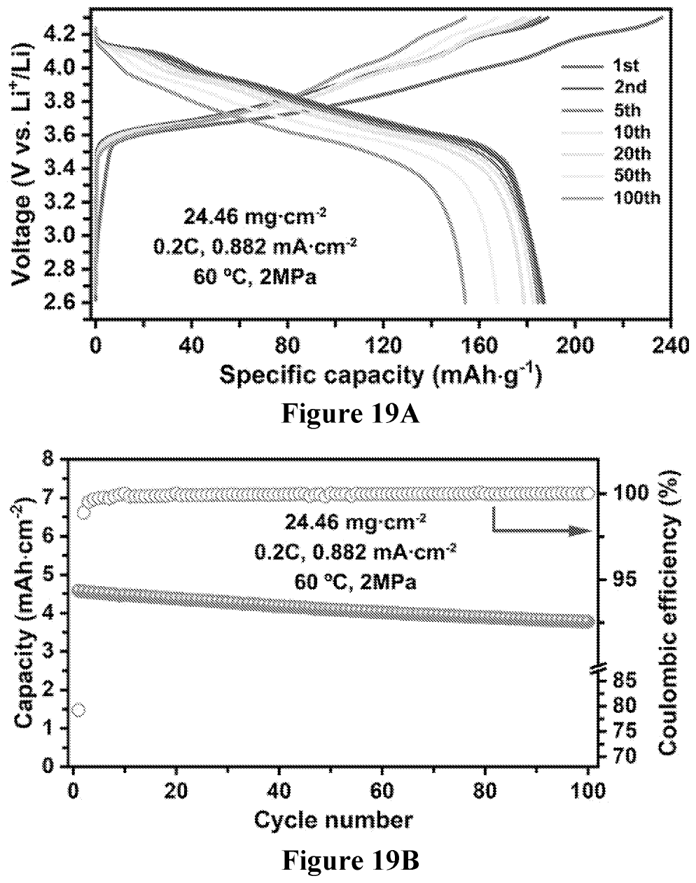

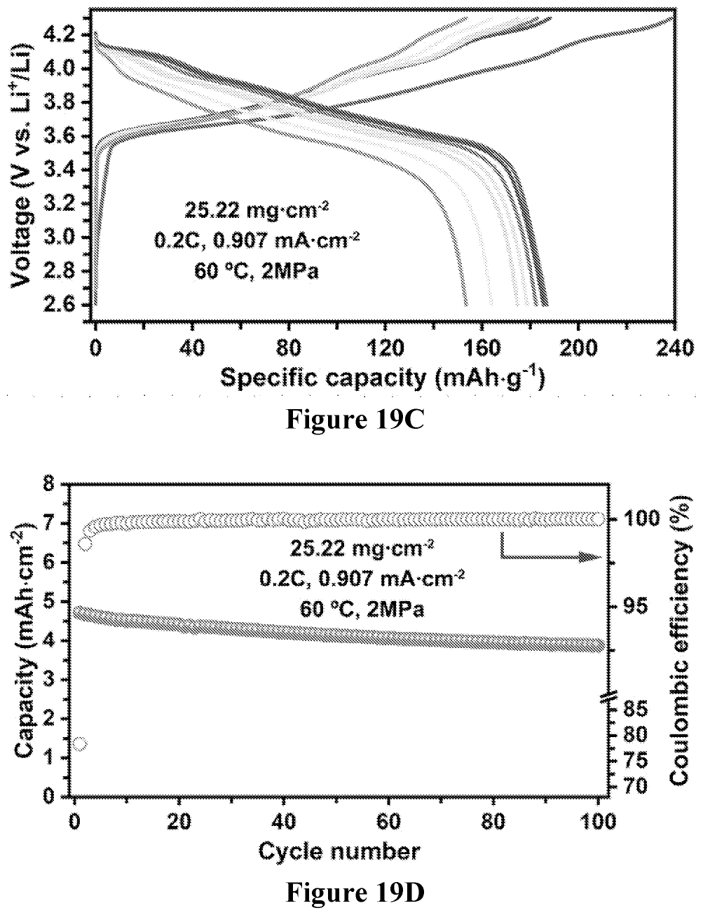

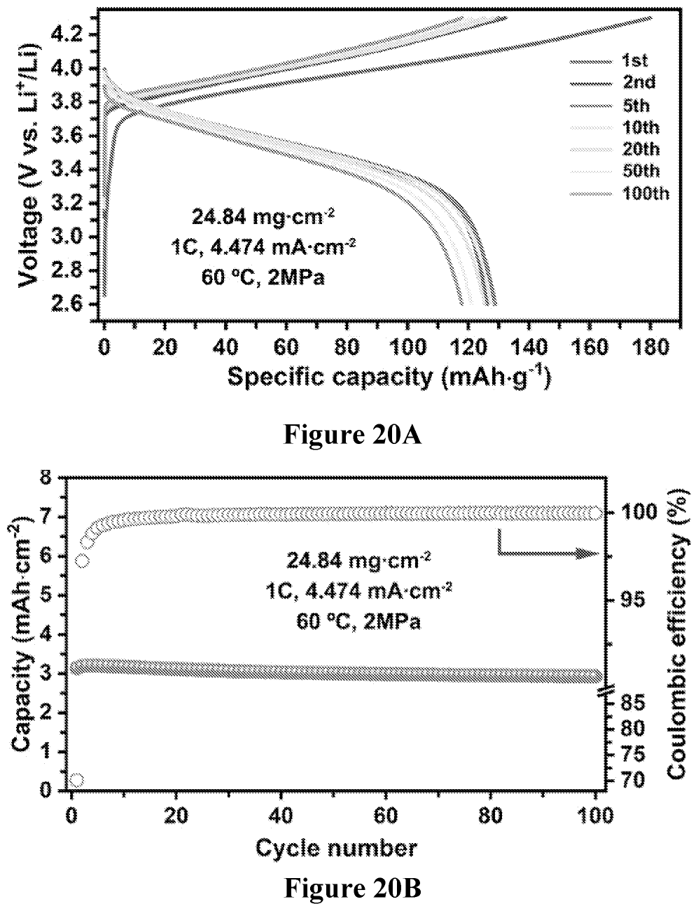

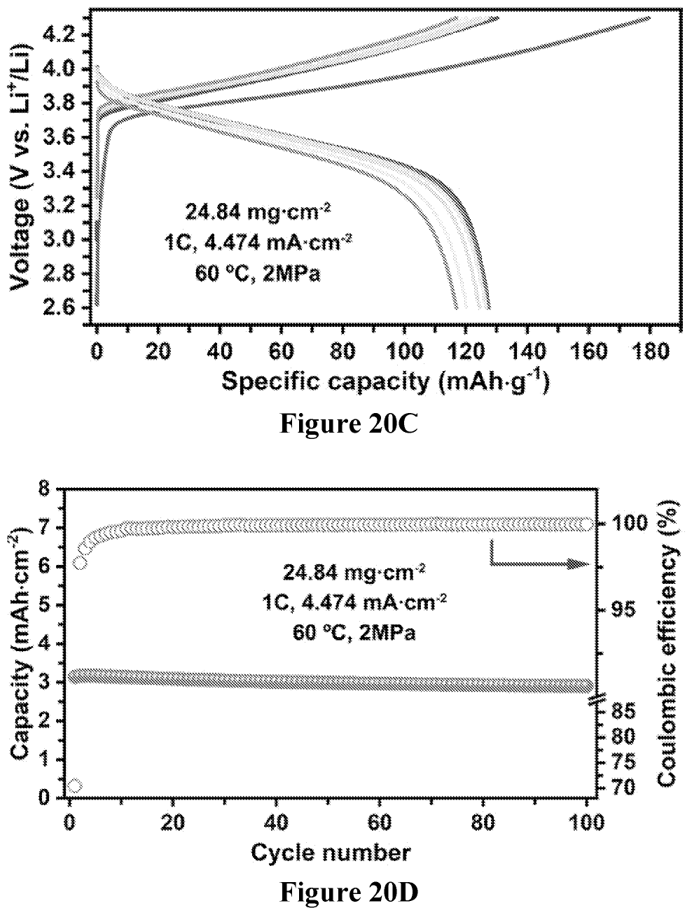

To further verify the effectiveness of the ALD LAZO protective layer at an areal capacity comparable to that of commercial LIBs (typically >3 mAh·cm⁻²), the loading of the LAZO@LNO cathode active materials (CAMs) was increased from ˜9 mg·cm⁻² (˜1.82 mAh·cm⁻²) to ˜25 mg·cm⁻² (>4 mAh·cm⁻²). FIG. 2G and FIG. 15 show that high-loading LAZO@LNO-based ASSLBs can still deliver a high specific capacity of 4.65 mAh·cm⁻² (184.48 mAh·g⁻¹) and 4.14 mAh·cm⁻² (159.5 mAh·g⁻¹) with a good capacity retention of 81.46% after 60 cycles and 70.31% after 200 cycles at a current density of 0.454 mA·cm⁻² (0.1 C, 35° C., 150 MPa) and 0.934 mA·cm² (0.2 C, 35° C., 150 MPa), respectively. As shown herein, even at a low stack pressure of 2 MPa and a higher CAM ratio of 75%, these high-loading LAZO@LNO-based ASSLBs also display a high specific capacity of 4.60 mAh·cm⁻² (187.99 mAh·g⁻¹) and 3.26 mAh·cm⁻² (129.25 mAh·g⁻¹) with a good capacity retention of 76.33% and 91.86% after 200 cycles at a current density of 0.882 mA·cm⁻² (0.2 C, 60° C.) and 4.540 mA·cm⁻² (1 C, 60° C.), respectively. All the ASSLBs in FIG. 2G were repeated twice (FIG. 16-20), essentially providing the same results and demonstrating reproducibility. In the high-loading cells with thicker composite cathodes, there is a much longer Li diffusion path that will result in more Li loss and thus lower first-cycle Coulombic efficiency (˜72.44%) compared to the low-loading cells (˜85.39%). Additionally, high testing temperature helps enhance the Li⁺ diffusion rate of CAMs and SEs, and thus is also beneficial to the first-cycle Coulombic efficiency (˜79.13%). The high stack pressure used in this work might not completely eliminate the contact loss due to the volume change of CAMs, which will lead to more accumulation of contact loss in the high-loading cells and thus lower CAM utilization. Thus, the adverse mechanical effects also play a certain role on the lower first-cycle Coulombic efficiency of the high-loading cells. It is noted that Co element plays a pivotal role in Li insertion cathodes' performance (e.g., improving structural stability, electronic conductivity), so Co-free LNO cathodes are totally different from other Ni-rich cathodes containing Co element because they are supposed to suffer from a more severe challenge related to structural/interfacial instability and sluggish transport dynamics in ASSLBs. Nevertheless, demonstrated herein is a significantly enhanced performance, which can be comparable to that of ceramic ASSLBs with Ni-rich high-energy cathodes containing Co element (Ni≥0.8) (Table 2). Actually, based on estimations (Table 3), the total increase of the cost to the kWh is less than 1% (negligible) after introducing an ALD LAZO coating layer, but the performance of ASSLBs is enhanced significantly. Considering the absence of expensive elements (Co, Nb, Zr, etc.), the present LAZO@LNO-based ASSLBs provide a significantly high-performance ASSLBs. The challenge of performance versus cost is noted, on the cathode side in ASSLBs, so the LiIn anode is just selected as a stable counter electrode. High-performance and low-cost anode materials (e.g., Si, Li) can be integrated with the present cathode design, and thus further reduce the cost of ASSLBs without sacrificing battery performance.

TABLE 2

| | CAM | Voltage | Current | First specific | | Average |
|---|---|---|---|---|---|---|
| Cell | ratio/loading | range (V | density | capacity | | CE after |
| configuration | (mg · cm⁻²) | vs, Li⁺/Li) | (mg · cm⁻²) | (mAg · g⁻¹)/CE | Cyclability | 1st cycle |
| LiₓAl_{y}Zn_{z}O_{δ}@ | 65%/8.98 | 2.6-4.3 | 0.322 | 203.1/85% | 83.10% | 99.95% |
| LNO/LPSC/ | (manual | | (0.2 C, | | (200 cycles) | |
| LiIn | mixing) | | 35 ° C., | | | |
| (This work) | | | 150 MPa) | | | |
| | 65%/25.96 | 2.6-4.3 | 0.934 | 159.5/72% | 70.31% | 99.94% |
| | (manual | | (0.2 C, | | (200 cycles) | |
| | mixing) | | 35 ° C., | | | |
| | | | 150 MPa) | | | |
| | 65%/25.21 | 2.6-4.3 | 0.454 | 184.48/76% | 81.46% | 99.90% |
| | (manual | | (0.1 C, | | (60 cycles) | |
| | mixing) | | 35 ° C., | | | |
| | | | 150 MPa) | | | |
| | 75%/24.46 | 2.6-4.3 | 0.882 | 187.99/79% | 76.33% | 99.99% |
| | (manual | | (0.2 C, | | (200 cycles) | |
| | mixing) | | 60 ° C., | | | |
| | | | 2 MPa) | | | |
| | 75%/25.22 | 2.6-4.3 | 4.540 | 127.14/70% | 91.86% | 99.92% |
| | (manual | | (1 C, | | (200 cycles) | |
| | mixing) | | 60° C., | | | |
| | | | 2 MPa) | | | |

### Improved Interfacial Li-Ion Transport Dynamics

The electrochemical performance of ASSLBs is directly related to their internal resistance, which may be dominated by the properties of the cathodes. Therefore, electrochemical impedance spectroscopy (EIS) was conducted to investigate the effect of the LAZO protective layer on the interfacial stability and Li-ion transport dynamics related to the LNO cathodes and SEs.

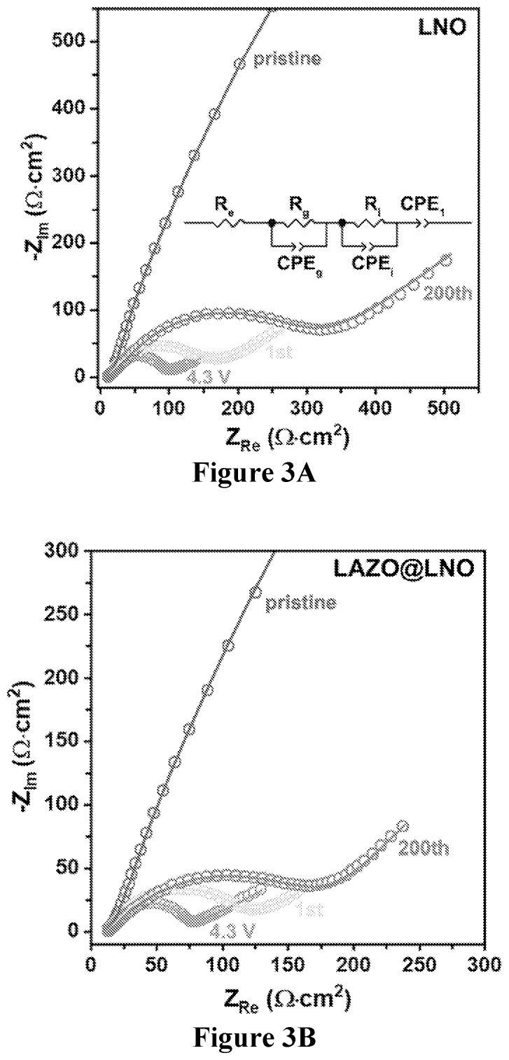

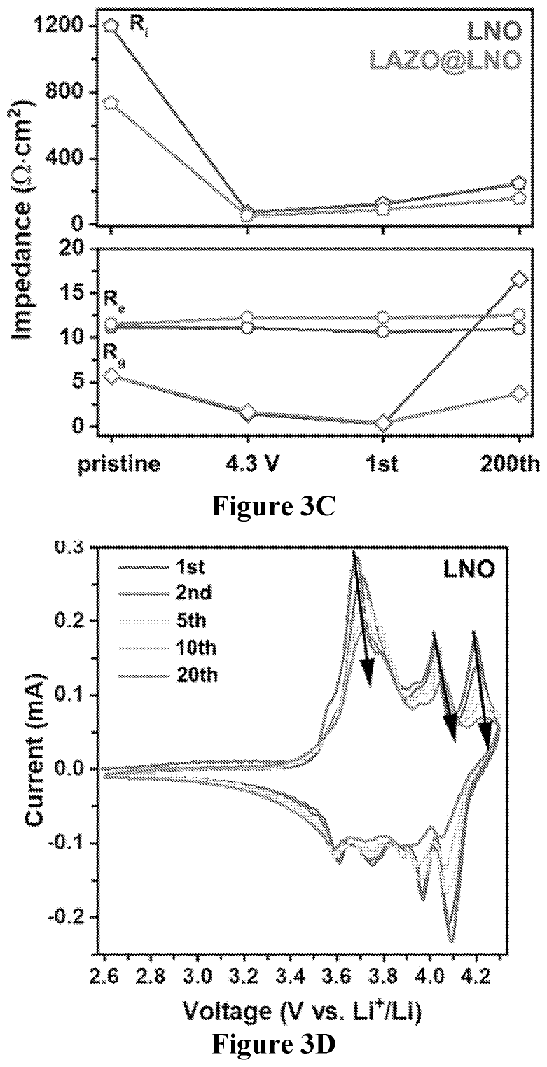

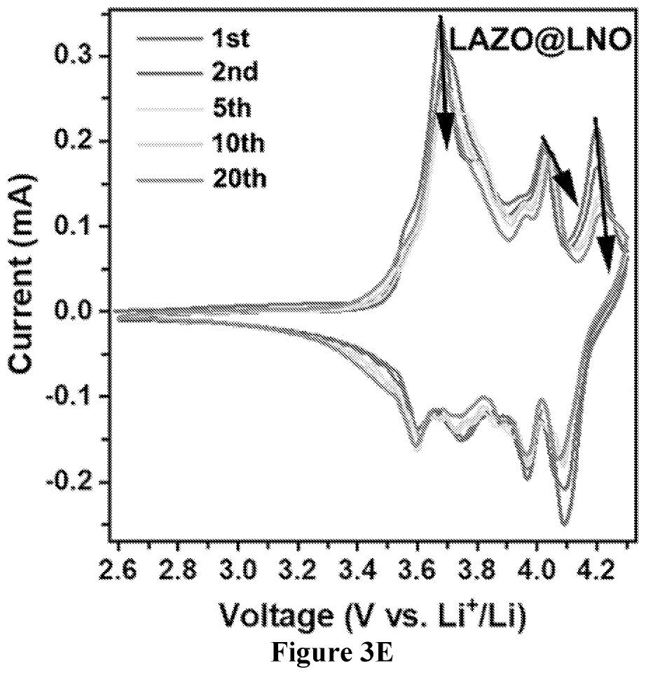

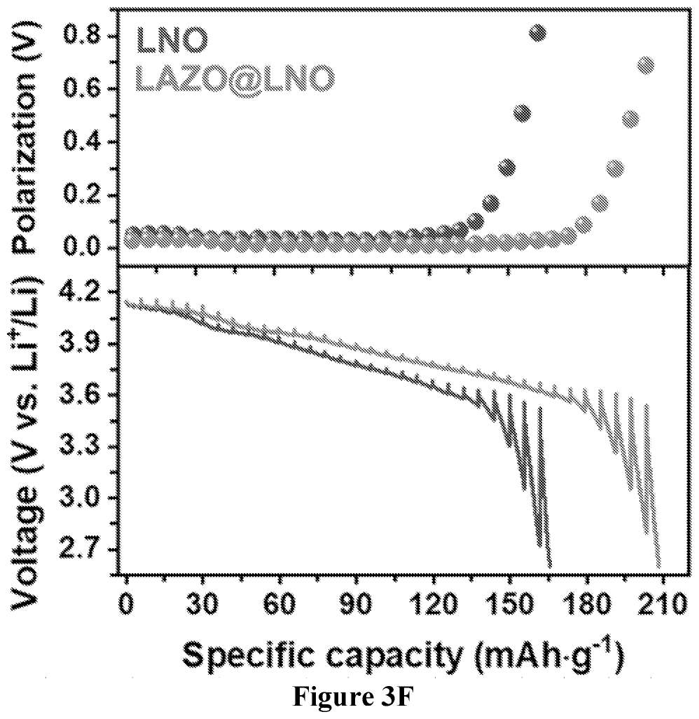

FIGS. 3A-3C show the impedance evolution of LNO- and LAZO@LNO-based ASSLBs at the pristine, 4.3 V charged, 1st cycle discharged, and 200th cycle discharged states. In FIGS. 3A and 3B, open circles indicate the measured data, and solid lines represent the fitted results. FIG. 3D and FIG. 3E show CV profiles of LNO- and LAZO@LNO-based ASSLBs at the 1st, 2nd, 5th, 10th, and 20th cycles. The potential scan rate is 0.02 mV·s⁻¹. FIG. 3F shows GITT curves and corresponding battery polarization of LNO- and LAZO@LNO-based ASSLBs.

The EIS results for the LNO- and LAZO@LNO-based ASSLBs at the pristine, 4.3 V charged, 1st cycle discharged, and 200th cycle discharged states are compared in FIGS. 3A-3C. The suggested (logical) equivalent circuit is shown in the inset of FIG. 3A, where Rₑ, R_{g}, and Rᵢ are used to denote the electrolyte bulk resistance, electrolyte grain-boundary resistance, and interfacial resistance from both the cathode and anode interfaces, respectively. It should be noted that the change in Rᵢ completely results from the cathode side because the anode side is the same in both types of ASSLBs. At the pristine state, the Rᵢ of the LNO-based ASSLBs reaches ˜1196 Ω·cm², which is far larger than that of the LAZO@LNO-based ASSLBs. This might be because the interphase resulting from contact side reactions between the LNO cathodes and LPSC sulfide-based SEs has very poor ionic conductivities. Upon protection with ultrathin ALD LAZO, Rᵢ decreases to ˜732.7 Ω·cm² because of the stable and highly conductive interphases in LAZO@LNO-based ASSLBs. When charged to 4.3 V, the Rᵢ values of the LNO- and LAZO@LNO-based ASSLBs decrease sharply to −74.2 Ω·cm² and ˜53.2 Ω·cm², respectively, owing to interface activation and changes in the electronic and ionic conductivities of the LNO during delithiation. In the next discharge and long-term cycling process, ongoing oxidative decomposition of the LPSC sulfide-based SEs and interface deterioration of the LNO cathodes further increase both Rᵢ values. However, the Rᵢ of the LAZO@LNO-based ASSLBs (˜93.5 Ω·cm² after 1 cycle; ˜157.8 Ω·cm² after 200 cycles) remains lower than that of the LNO-based ASSLBs (˜126.9 Ω·cm² after 1 cycle; ˜248.8 Ω·cm² after 200 cycles) at each corresponding state. More importantly, the interface of the LAZO@LNO-based ASSLBs (196% Rᵢ increase) deteriorates much more slowly than that of the LNO-based ASSLBs (235% Rᵢ increase) after 200 cycles. This highly improved cathode interface stability is attributed to the highly stable and conductive ultrathin LAZO coating layer and the enhanced structural stability, and thus Li-ion transport dynamics at the near-surface of the LNO cathode, itself a product of the near-surface Al+Zn doping. In addition, the R_{g} of the LNO-based ASSLBs also increases much more than that of the LAZO@LNO-based ASSLBs after 200 cycles, indicating that the accumulation of LNO/LPSC interface deterioration products has a severe effect on the Li-ion transport dynamics between electrolyte grains.

Cyclic voltammetry (CV) and galvanostatic intermittent titration technique (GITT) measurements were performed to study the electrochemical kinetic properties inside the composite cathodes. Three redox peaks are seen in the CV profiles: they correspond to the phase transitions between a first hexagonal phase H1 and the monoclinic phase M (H1/M), M/H2 and H2/H3, respectively. Although the intensity of the oxidation and reduction peak currents decreases upon consecutive cycling, the peak currents of the LAZO@LNO-based ASSLBs remain larger than those of the LNO-based ASSLBs (FIGS. 3D-3E). Additionally, the intensity of the peak currents in CVs related to the LAZO@LNO-based ASSLBs decreases less rapidly compared to the CVs measured in the LNO-based ASSLBs. These results of CV measurements are consistent with the observations related to the galvanostatic measurements of the discharge capacity and capacity retention of these systems. Furthermore, the polarization voltage between the first oxidization and reduction peaks of the LAZO@LNO-based ASSLB (˜0.095 V) is much smaller than that of the LNO-based ASSLB after 20 cycles (˜0.121 V), further verifying that the ultrathin ALD LAZO coating enhances the structural reversibility and Li-ion transport kinetics. GITT results (FIG. 3F) also show that the LAZO@LNO-based ASSLBs exhibit a much lower polarization than the LNO-based ASSLBs, indicating the better kinetic properties of the coated cathodes. Both the CV and GITT results are consistent with the above-mentioned EIS results.

### Alleviating Mechanical Degradation

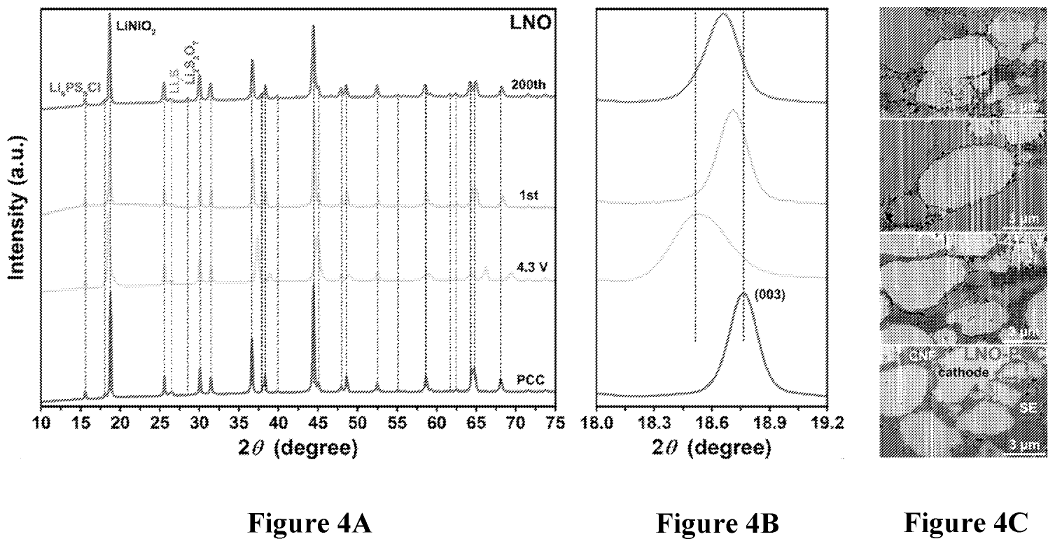

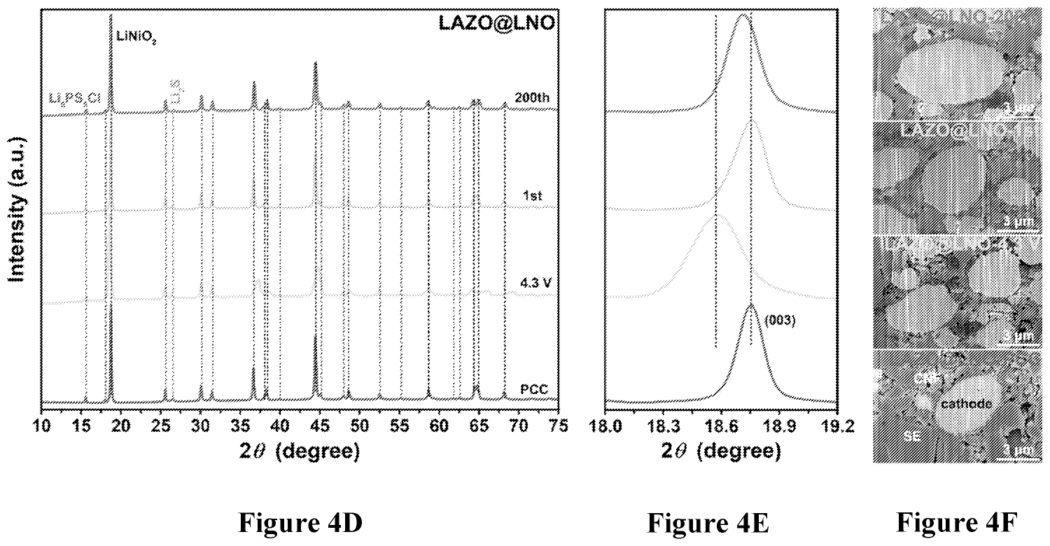

The volume changes during repeated lithiation/delithiation processes could delaminate the cathode active particles from the SE matrix due to the rigid mechanical contact, which would lead to the increased interfacial resistance and capacity fading. XRD and plasma focused ion beam SEM (PFIB-SEM) measurements were used to study the structural and mechanical evolution of LNO and LAZO@LNO before and after cycling (FIG. 4).

FIGS. 4A-4C show XRD patterns and typical cross-sectional PFIB-SEM images of pristine, 4.3 V charged, 1st cycle discharged, and 200th cycle discharged LNO composite cathodes (PCC, 4.3 V, 1st, 200th). FIG. 4D-4F shows XRD patterns and typical cross-sectional PFIB-SEM images of pristine, 4.3 V charged, 1st cycle discharged, and 200th cycle discharged LAZO@LNO composite cathodes (PCC, 4.3 V, 1st, 200th).

As shown in FIG. 4A and FIG. 4D, it can be shown that the LAZO@LNO displays a lower cation mixing (higher I₍₀₀₃₎/I₍₀₀₄₎ ratio) than LNO in the pristine composite cathodes owing to the less formation of low-valent Ni ions (e.g., Ni²⁺) from the interfacial side reactions. After charging, LAZO@LNO exhibits smaller volume change (FIG. 4B and FIG. 4E) but achieves a deeper charged state (higher specific capacity) because of the smaller amount of interfacial side reactions (less irreversible Li loss) with the LAZO@LNO cathodes than with the unprotected LNO cathodes. Typical cross-sectional PFIB-SEM images at the charged state indicate that the larger volume contraction of LNO causes much more contact loss in the composite cathode layer than LAZO@LNO (FIG. 4C and FIG. 4F), which severely deteriorates the mixed ionic/electronic percolation networks in the LNO composite cathode and thus decreases the CAM utilization. After the 1st and 200th discharge, LAZO@LNO displays less change in structure and volume compared with LNO. Both results suggest that the ALD LAZO protective layer also helps enhance the cathode structural and mechanical stability.

### Mitigating Microstructural Failure and Side Reactions

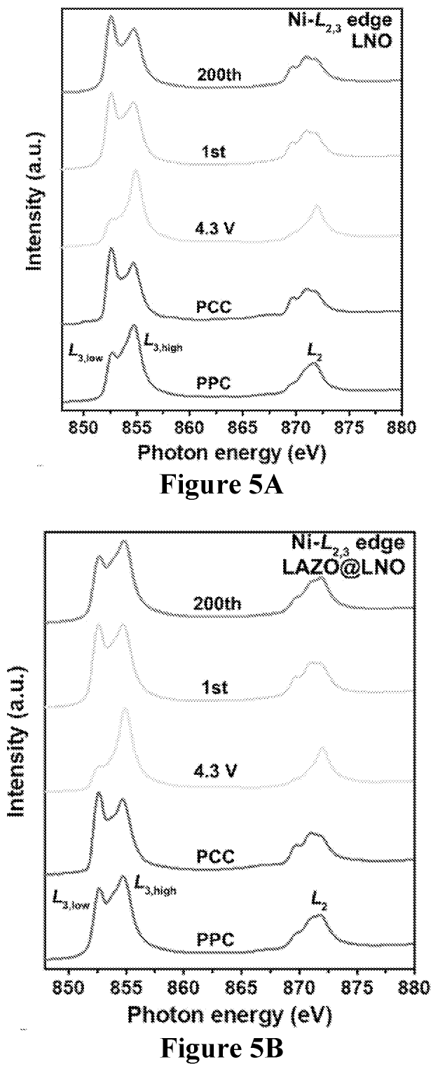

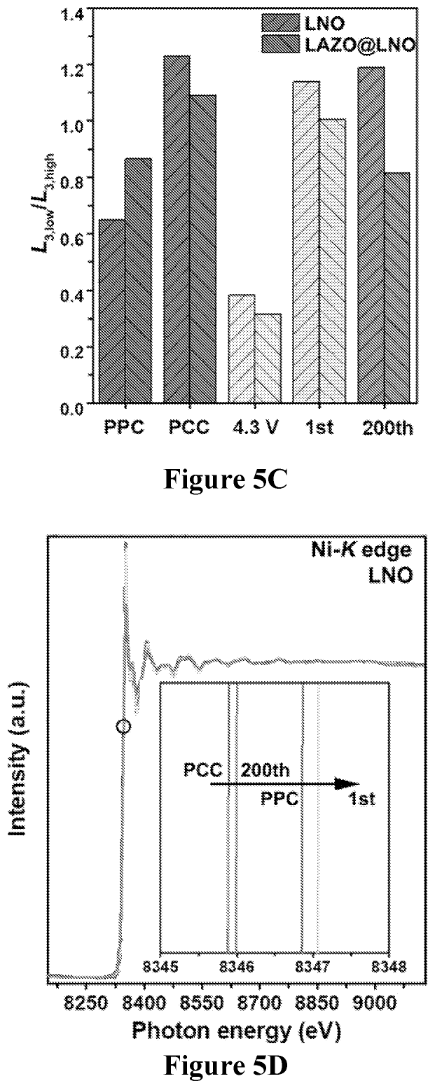

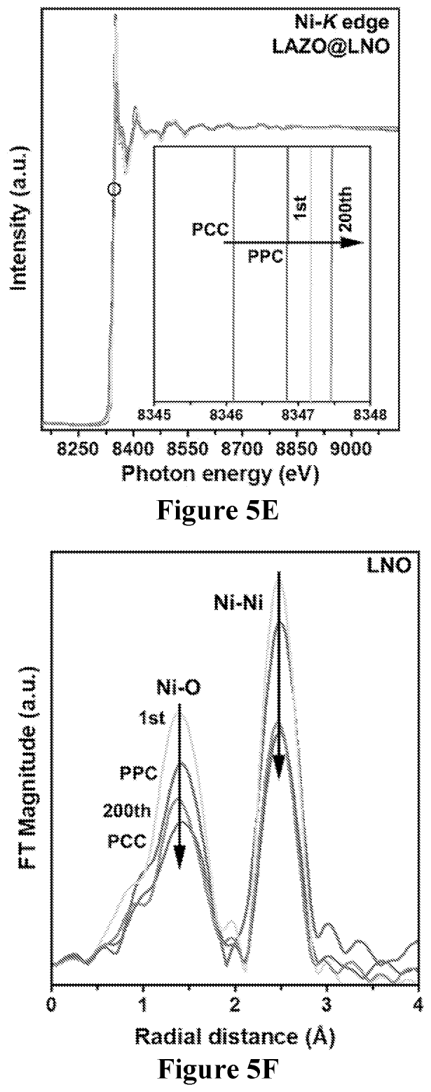

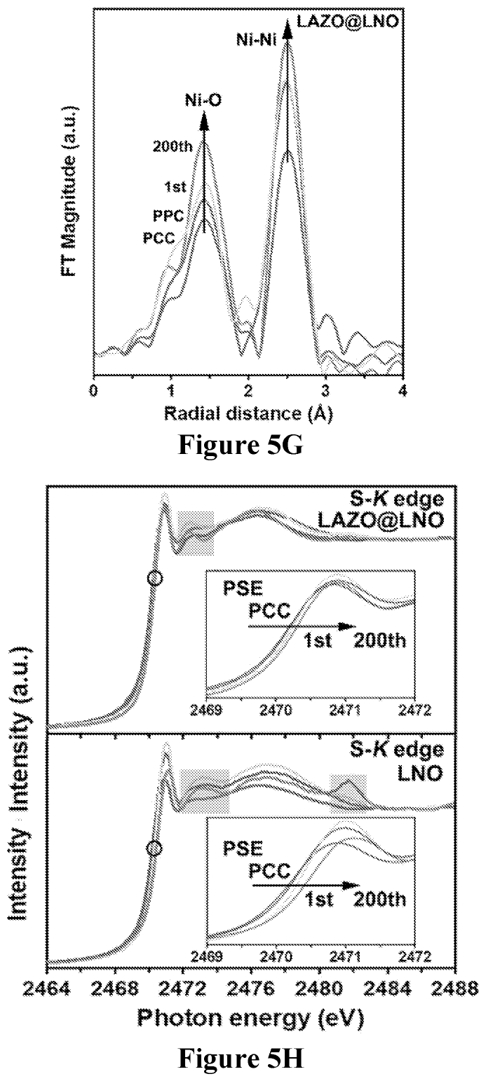

SXAS and HXAS measurements were employed to elucidate the charge-compensation mechanism and local structure evolution of LNO, LAZO@LNO, and LPSC in the composite cathodes at different stages. First, the variation in the LNO and LAZO@LNO cathode surface properties is demonstrated via TEY Ni-L_{2,3} SXAS (FIGS. 5A-5C and FIG. 12, FIG. 15).

FIG. 5A and FIG. 5B show TEY Ni-L_{2,3} SXAS data of pristine pure LNO and LAZO@LNO cathodes (PPC) and pristine, 4.3 V charged, 1st cycle discharged, and 200th cycle discharged LNO and LAZO@LNO composite cathodes (PCC, 4.3 V, 1st, 200th). FIG. 5C shows L_{3,low}/L_{3,high} ratios of all these LNO and LAZO@LNO samples at different stages. FIG. 5D and FIG. 5E, Ni—K XANES spectra of pristine pure LNO and LAZO@LNO cathodes (PPC) and the pristine, 1st cycle discharged, and 200th cycle discharged LNO and LAZO@LNO composite cathodes (PCC, 1st, 200th). FIG. 5F and FIG. 5G show Fourier transform radial distribution function for Ni—K EXAFS spectra of pristine pure LNO and LAZO@LNO cathodes (PPC) and the pristine, 1st cycle discharged, and 200th cycle discharged LNO and LAZO@LNO composite cathodes (PCC, 4.3 V, 1st, 200th). FIG. 5H and FIG. 5I show S—K and P—K XANES spectra of pristine LPSC (PSE), and the pristine, 1st cycle discharged, and 200th cycle discharged LAZO@LNO composite cathodes (PCC, 1st, 200th).

The L_{3,low}/L_{3,high} ratio increases upon contact between the LNO cathodes and LPSC SEs (FIG. 5A, FIG. 5C), indicating that interfacial side reactions lead to the presence of more irreversible low-valent Ni ions (e.g., Ni²⁺) than in the pristine state. In contrast, a smaller increase in the number of low-valent Ni ions in the pristine LAZO@LNO composite cathodes is observed on account of the good protection by the ultrathin ALD LAZO interlayer (FIG. 5B, FIG. 5C). After charging, the L_{3,low}/L_{3,high} ratios of LNO and LAZO@LNO cathodes are both lower than those in their pristine state, owing to Ni oxidation. However, compared with unprotected LNO, LAZO@LNO achieves a deeper charged state because of the smaller amount of interfacial contact loss and side reactions with the LPSC SEs. Interestingly, after the first discharge, the L_{3,low}/L_{3,high} ratios of LNO and LAZO@LNO are both larger than those of the corresponding pristine pure cathodes (PPC) but slightly smaller than those of their pristine composite cathodes (PCC). This means that the Ni reduction after the discharge is not complete (i.e., some high-valent Ni ions have formed) owing to the contact loss resulting from the volume change of LNO. As a result, at least two mechanisms affect the Ni valence state: interfacial side reactions lead to the generation of low-valent Ni ions (e.g., Ni²⁺), and contact loss results in the formation of high-valent Ni ions (e.g., Ni^{3.5+}) Nevertheless, because the LAZO protective layer suppresses interfacial contact loss and side reactions, the Ni valence state of LAZO@LNO is slightly higher than that of LNO after the first discharge. After 200 cycles, the evolution of the Ni valence state in LNO cathodes is obviously different from that in LAZO@LNO cathodes: the Ni valence state of LNO is further reduced after 200 cycles because the accumulation of low-valent Ni ions resulting from continuous interfacial side reactions is greater than the accumulation of high-valent Ni ions resulting from contact loss. In contrast, the Ni valence state of LAZO@LNO further increases after 200 cycles: the contribution of high-valent Ni ions resulting from contact loss still dominates, because the interfacial side reactions are suppressed by the LAZO protective layer.

Ni—K XANES and EXAFS spectra were recorded to understand the evolution of the bulk structure of LNO and LAZO@LNO during cycling (FIGS. 5D-5G). The evolution of the bulk Ni valence state is consistent with the surface results (FIG. 5D, FIG. 5E). Besides the valence change, the Ni—K EXAFS results (FIG. 5F, FIG. 5G) also reveal the evolution of structural disorder by the change in the Ni—O and Ni—Ni peaks. The intensity of the Ni—O and Ni—Ni peaks for the pristine and 200th cycle LNO composite cathodes is clearly lower than that for the pristine pure LNO cathodes. This decrease is at least partially attributed to the aggravation of local Jahn-Teller distortions of the NiO₆ octahedra owing to low spin Ni³⁺. It should be noted that high-valent Ni ions (e.g., Ni^{3.5+}) resulting from contact loss can reduce the local distortion of NiO₆ octahedra, while low-valent Ni ions (e.g., Ni²⁺) resulting from continuous interfacial side reactions lead to severe local distortion because of the reduced mean valence state of Ni ions. As a result, the intensity of the Ni—O and Ni—Ni peaks is higher for the LNO composite cathodes after first cycle than for the pristine LNO composite cathodes. Interestingly, the intensity change of the Ni—O and Ni—Ni peaks between the pristine and 1st cycle cathodes is smaller for the LAZO@LNO composite cathodes than for the LNO composite cathodes because of the suppression of interfacial side reactions. After 200 cycles, the obvious difference between LNO and LAZO@LNO composite cathodes is that the intensity of the Ni—O and Ni—Ni peaks is further increased for LAZO@LNO composite cathodes owing to the reduced local distortion from the LAZO protective layer, while is decreased for LNO composite cathodes because of the accumulative local distortion. Overall, ex-situ Ni SXAS and HXAS results confirm that the ultrathin ALD LAZO protective layer hinders the formation of irreversible low-valent Ni ions (e.g., Ni²⁺) resulting from continuous interfacial side reactions and improves the cathode structural stability.

To complement these results, interfacial charge-compensation mechanisms via S—K and P—K XANES analysis of LPSC at different stages were demonstrated (FIG. 5H, FIG. 5I). The S—K edge of LPSC shifts (by ˜0.25 eV) to higher energy after contact with LNO and extended cycling. This shift was accompanied by a clear increase in the intensity of the peaks at ˜2472 eV (typically Li₂S) and ˜2481 eV (typically sulfites and sulfates), indicating significant oxidation reactions and a rearrangement of the local atomic environment in LPSC. As for the S—K edge of LPSC, it is slightly shifted (by ˜0.12 eV) to higher energy after contact with LAZO@LNO and after extended cycling, and it exhibits minor changes in the peak shape. The sulfide-based SE oxidative decomposition is, in principle, at least, caused by both the cathodes and carbon additives. Considering that carbon nanofiber (CNF) additives were used herein to increase the electronic conductivity of the composite cathode layer, some oxidative decomposition of sulfide-based SEs at the LPSC/CNF contacts is unavoidable. However, the slight change in the S—K edge of LPSC in the LAZO@LNO composite layer indicates that the side reactions between LPSC and CNF are not severe—likely because the specific surface area of CNF is very small—which also demonstrates the enhanced stability of LPSC in contact with LAZO protective layer. On the other hand, the P—K edge of LPSC isn't shifted to higher energy, either for LNO or LAZO@LNO composite cathodes, but the peak intensity does change to a larger extent for LNO composite cathodes than for LAZO@LNO composite cathodes. This difference can be explained, at least, by more pronounced variations in the local structural environment around P atoms of LPSC in LNO composite cathodes than in LAZO@LNO composite cathodes.

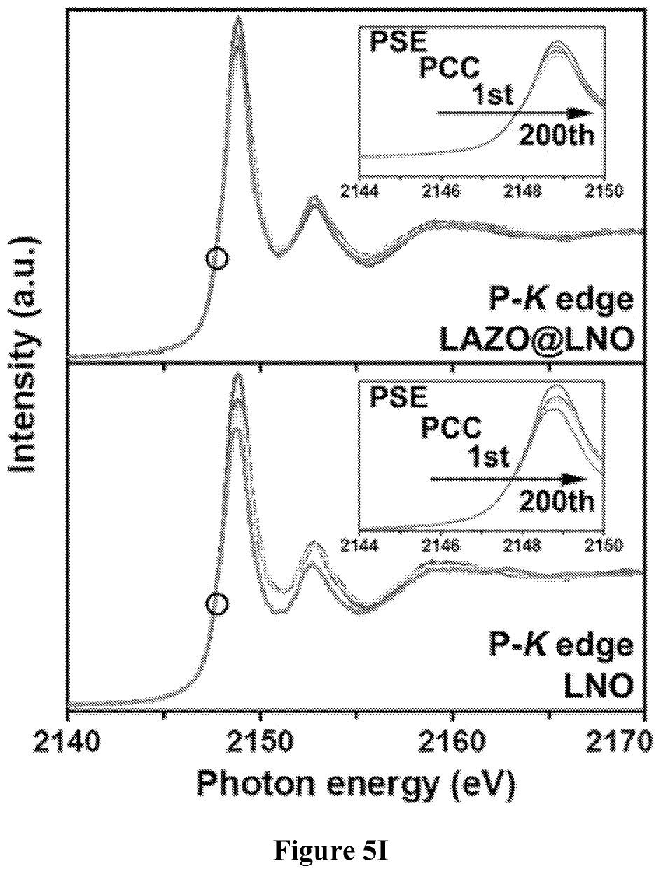

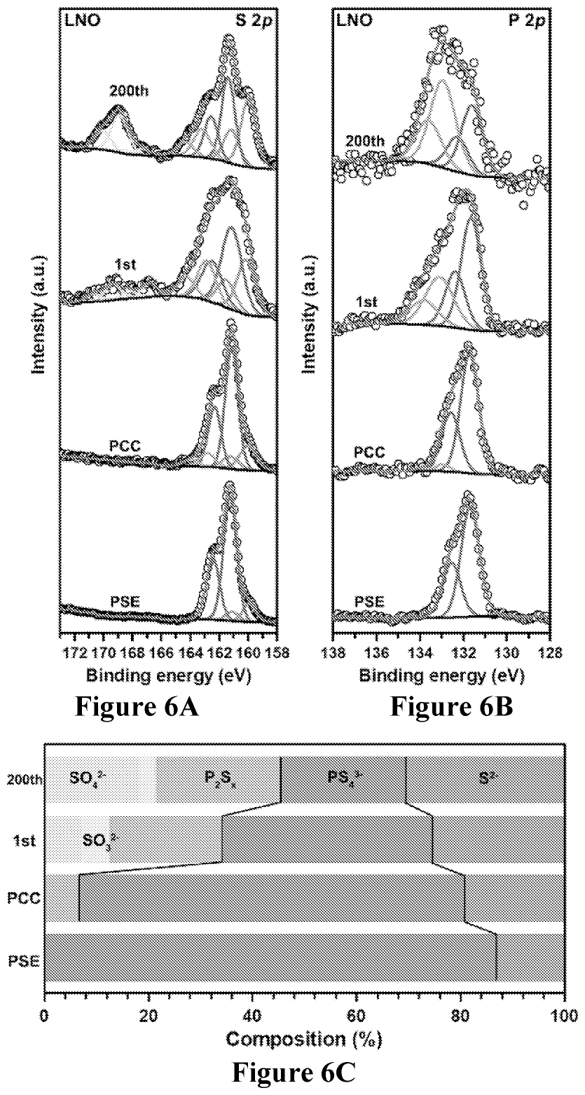

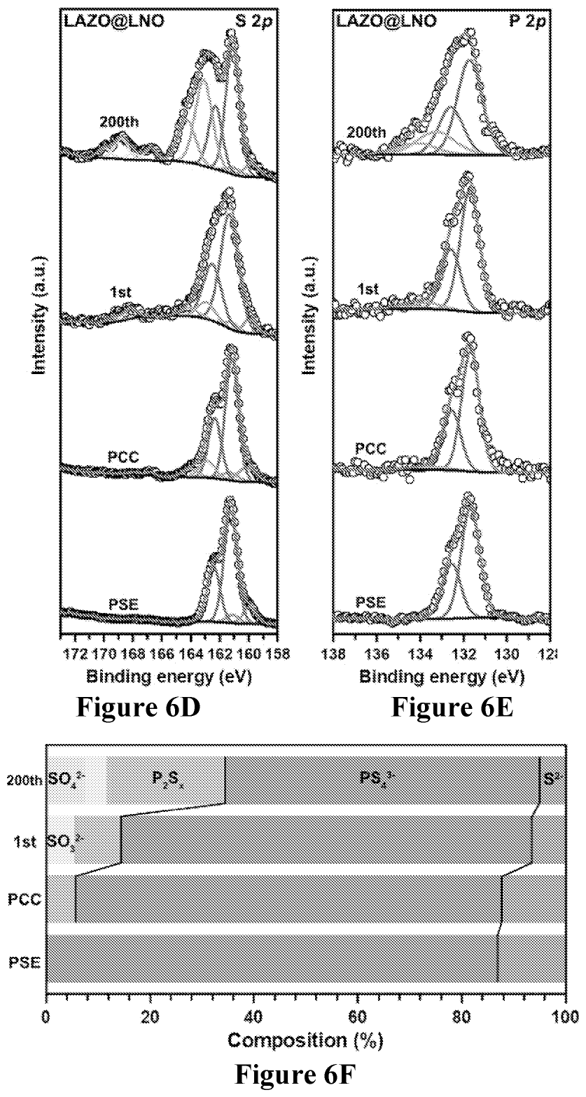

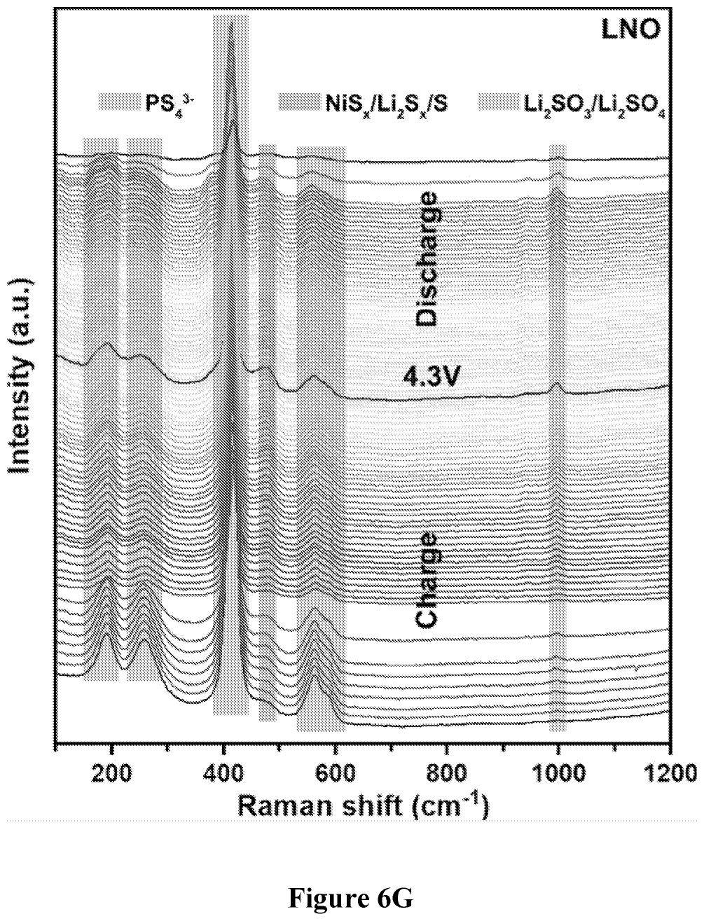

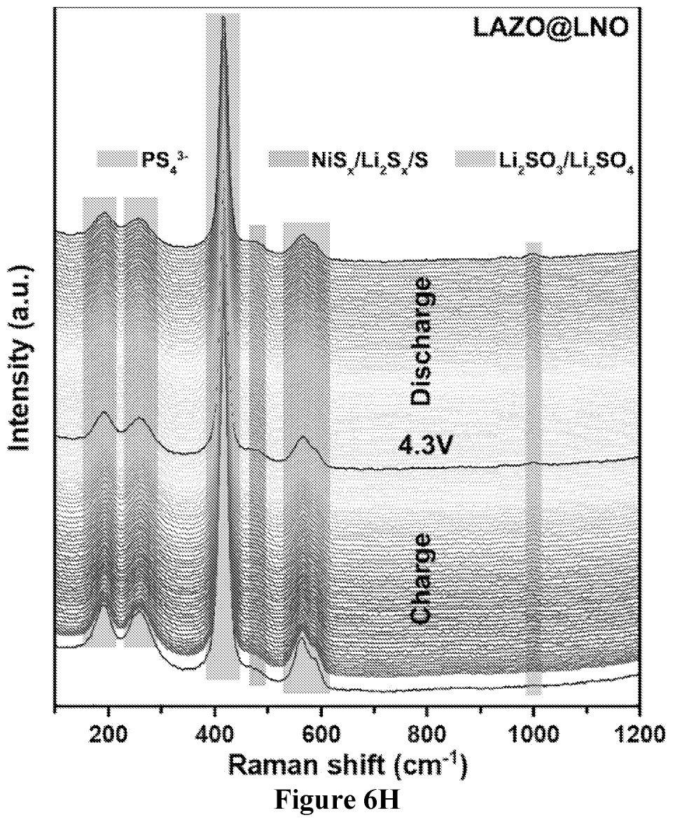

In order to gain detailed chemical insights into the evolution of the LPSC surface composition, X-ray photoelectron spectroscopy (XPS) measurements were performed on the LNO (FIGS. 6A-6C) and LAZO@LNO (FIG. 6D-6F) composite cathode samples at different stages.

FIGS. 6A-6C show S 2p and P 2p XPS data and corresponding compositional analysis for pristine LPSC (PSE) and the pristine, 1st cycle discharged, and 200th cycle discharged LNO composite cathodes (PCC, 1st, 200th). FIGS. 6D-6F show S 2p and P 2p XPS data and corresponding compositional analysis for pristine LPSC (PSE) and the pristine, 1st cycle discharged, and 200th cycle discharged LAZO@LNO composite cathodes (PCC, 1st, 200th). FIG. 6G and FIG. 6H show in operando Raman characterization of LPSC decomposition in the LNO and LAZO@LNO composite cathodes during the charge-discharge process.

The results of the semi-quantified composition analysis are exhibited in FIG. 6C and FIG. 6F to give a clearer picture of the evolution process of the LPSC surface composition. Because the LPSC sulfide-based SEs are very sensitive to oxygen and water, the ASSLBs were disassembled in a Ar-filled glovebox, and the pellets were then transferred into the XPS instrument without any exposure to the ambient atmosphere. The S 2p core-level (FIG. 6A) spectra for the pristine LPSC SE shows two doublets (2p_{3/2}/2p_{1/2}), which can be attributed to the free S²⁻ anions (S 2p_{3/2} at 159.89 eV, 86.65%) and the PS₄³⁻ tetrahedra (S 2p_{3/2} at 161.31 eV, 13.35%) of the argyrodite structure, respectively. After the LPSC SEs contacting with the LNO cathodes and CNF additives, some lower-oxidation-state sulfur species (e.g., Li₂P₂S₆ and P₂Sₓ with x>5) appear (6.51%) at a binding energy of 162.87 eV (S 2p_{3/2}), which are attributed to spontaneous decomposition reactions between LPSC and LNO/CNF. Moreover, the formation of S²⁻-containing side products (e.g., Li₂S, NiS, Ni₂S₃) also slightly increases the relative intensity of the S²⁻ anions signal (19.16%). After the 1st cycle, the S 2p spectrum displays two new doublets with the 2p_{3/2} peak at a binding energy of 166.81 eV and 169.33 eV, suggesting the generation of higher-oxidation-state sulfite (SO₃²⁻, 5.70%) and sulfate (SO₄²⁻, 6.81%) species. After an extended number of cycles, the content of oxidized species (totaling 45.36%: 18.32% SO₄²⁻+3.22% SO₃²⁻+23.82% P₂Sₓ) and S²⁻-containing side products (30.70%) further increases because of the prolongation and accumulation of these interfacial decomposition side products. The P 2p core-level spectra of LPSC in contact with LNO cathode samples show an evolutionary trend similar to that observed in the S 2p XPS data (FIG. 6B). However, higher-oxidation-state metaphosphate (PO₃³⁻) and phosphates (PO₄³⁻) species are not detected, at least because the side reactions between LNO and LPSC mainly result in the oxidation of S rather than P in LPSC. Upon protection with ultrathin ALD LAZO, the percentage of oxidized species resulting from the LPSC decomposition only reaches a total of 34.55% after 200 cycles (FIGS. 6D-6F). They consist of a mixture of species at a high (7.49% SO₄²⁻ and 4.2% SO₃²⁻) and low oxidation state (22.86% P₂Sₓ). These results convincingly show that the chemical/electrochemical formation of higher oxidation state species (e.g., SO₄²⁻, SO₃²⁻) can be effectively limited by protecting the cathodes via an ALD process with an ultrathin LAZO layer. As a synergistic improvement, the ultrathin ALD LAZO layer also protects against the formation of S²⁻-containing side products with low ionic conductivity (Li₂S, NiSₓ) but high electronic conductivity (NiSₓ). Used herein is in operando Raman spectroscopy to further verify the formation of low ionic- but high electronic-conductivity species and higher-oxidation-state side products during the charge-discharge process. It reveals an obvious accumulation of NiSₓ/Li₂Sₓ/S and SO₃²⁻/SO₄²⁻ during the charge process, owing to the gradually increasing amount of interfacial side reactions between highly oxidized Ni ions (from the LNO cathode) and LPSC (FIG. 6G). The poor ionic but high electronic conductivities of these interfacial side products cannot passivate against further chemical/electrochemical oxidation of the electrolytes and stabilize the interface. These continuous interfacial side reactions will evidently decay the mixed ionic/electronic percolation networks inside the composite cathode layer and thus increase interfacial impedances, leading to lower utilization of the CAMs and significantly deteriorated battery performance. Protecting the cathodes with an ultrathin LAZO layer achieved by ALD can significantly alleviate these severe interfacial side reactions between highly oxidized Ni ions and LPSC (FIG. 6H), and passivate against further interfacial side reactions. Furthermore, this ultrathin protective layer can provide fast ionic conductivity and appropriate electronic conductivity. All above benefits of the ultrathin LAZO protective layer contribute to excellent performance of high-energy ASSLBs containing LNO cathodes.

Demonstrated here is the preparation of a cost-effective and high-energy Co-free LNO-based ASSLB prototype, enabled by the formation of an ultrathin nano-structured LAZO protective layer on the cathodes via ALD processes. The rationally designed high-quality interphase consisting of a LAZO surface coating region and an Al+Zn near-surface doping region greatly enhances the structural stability of the cathodes and mitigates the contact loss and continuous side reactions at the cathode/solid electrolyte interface. Consequently, this multifunctional protective layer greatly reduces the accumulation of irreversible low-valent Ni ions (e.g., Ni²⁺), higher oxidation state species (e.g., moieties containing SO₄²⁻ and SO₃²⁻) and side products with low ionic- (e.g., polysulfides, Li₂S, NiSₓ) and high electronic-conductivities (e.g., NiSₓ). Therefore, the LAZO@LNO-based ASSLBs are endowed with high areal capacity (>4.5 mAh·cm⁻²), high specific capacity (>200/185 mAh·g⁻¹), superior cycling stability (>80% capacity retention after 200 cycles), and good rate capability (>90 mAh·g⁻¹ at 360 mA·g⁻¹, ˜30 mAh·g⁻¹ at 900 mA·g⁻¹) at a near-room temperature of 35° C. or at a low stack pressure of 2 MPa. This present disclosure demonstrates a high-quality artificial interphase with a good balance among the ionic conductivity, electronic conductivity, interfacial stability, and mechanical stability, on the highly challenging but cost-effective high-energy Co-free LNO-based ASSLBs, for the large-scale deployment of ASSLBs for electromobility.

### LAZO Material

In some embodiments the present invention is directed to a material with a general formula LiₓAl_{y}Zn_{z}O_{δ} (LAZO), wherein:
x is a whole number greater than or equal to 1;
y is a whole number greater than or equal to 1;
z is a whole number greater than or equal to 1; and
δ is a whole number greater than or equal to 1.

In some embodiments the present invention is directed to a material with a general formula LiₓAl_{y}Zn_{z}O_{δ} (LAZO), wherein:
x, y, z and δ, or any combination thereof, is a whole number greater than or equal to 1.

In some embodiments the present invention is directed to a material with a general formula LiₓAl_{y}Zn_{z}O_{δ} (LAZO), wherein:
x, y, z and δ, or any combination thereof, is a whole number ranging between 1 and 10.

In some embodiments the present invention is directed to a material with a general formula LiₓAl_{y}Zn_{z}O_{δ} (LAZO), wherein:
x, y, z and δ, or any combination thereof, is a whole number ranging between 1 and 10, or is equal to 0.

Since each component of LAZO can be any whole number greater than 1, there are many variations. For example, (x, y, z, δ) can be any of the following non-limiting variations: (1, 1, 1, 1), (1, 1, 1, 2), (1, 1, 1, 3), (1, 1, 1, 4), (1, 1, 1, 5), (1, 1, 1, 6), (1, 1, 1, 7), (1, 1, 1, 8), (1, 1, 2, 1), (1, 1, 2, 2), (1, 1, 2, 3), (1, 1, 2, 4), (1, 1, 2, 5), (1, 1, 2, 6), (1, 1, 2, 7), (1, 1, 2, 8), (1, 1, 3, 1), (1, 1, 3, 2), (1, 1, 3, 3), (1, 1, 3, 4), (1, 1, 3, 5), (1, 1, 3, 6), (1, 1, 3, 7), (1, 1, 3, 8), (1, 1, 4, 1), (1, 1, 4, 2), (1, 1, 4, 3), (1, 1, 4, 4), (1, 1, 4, 5), (1, 1, 4, 6), (1, 1, 4, 7), (1, 1, 4, 8), etc.

In some embodiments each component (i.e., x, y, z, δ) is the same number. In other embodiments each component is a different number. In some embodiments some components have the same number whereas other components have a different number. In some embodiments at least one of the components (i.e., x, y, z, δ) is 0.

Some material compositions will not allow for a limitless value for each component. As such, in some embodiments each component (i.e., x, y, z and 6 or any combination thereof) has a maximum value of 1. In some embodiments each component (i.e., x, y, z and 6 or any combination thereof) has a maximum value of 2. In some embodiments each component (i.e., x, y, z and 6 or any combination thereof) has a maximum value of 3. In some embodiments each component (i.e., x, y, z and 6 or any combination thereof) has a maximum value of 4. In some embodiments each component (i.e., x, y, z and 6 or any combination thereof) has a maximum value of 5. In some embodiments each component (i.e., x, y, z and 6 or any combination thereof) has a maximum value of 6. In some embodiments each component (i.e., x, y, z and 6 or any combination thereof) has a maximum value of 7. In some embodiments each component (i.e., x, y, z and δ or any combination thereof) has a maximum value of 8. In some embodiments each component (i.e., x, y, z and δ or any combination thereof) has a maximum value of 9. In some embodiments each component (i.e., x, y, z and δ or any combination thereof) has a maximum value of 10.

In some embodiments each component (i.e., x, y, z and δ or any combination thereof) is a whole number ranging between 1 and 10. In some embodiments each component (i.e., x, y, z and δ or any combination thereof) is a whole number ranging between 1 and 5. In some embodiments each component (i.e., x, y, z and δ or any combination thereof) is a whole number ranging between 1 and 2. In some embodiments each component (i.e., x, y, z and δ or any combination thereof) is a whole number ranging between 3 and 5. In some embodiments each component (i.e., x, y, z and δ or any combination thereof) is a whole number ranging between 2 and 5.

LAZO can take the form of various nanoscopic and/or microscopic structures. In some embodiments the LAZO material comprises at least one Li atom, at least one Al atom, at least one Zn atom and at least one O atom. In some embodiments LAZO takes the form of a layer or a coating. As will be shown, the deposition of the material can be carried out more than once forming layers of different thicknesses. According to the deposition parameters, a single layer of LAZO can comprise regions of varying crystallinity, which is controlled by changing the deposition parameters in each deposition cycle (e.g., changing the deposition temperature, pulse rate, reaction rate, precursor composition, pressure, etc.). In one embodiment, a LAZO layer comprises one crystal form. In one embodiment, a LAZO layer comprises at least one crystal form. In another embodiment a LAZO layer comprises at least two crystal forms i.e., distinct layers with different crystal forms. Furthermore, LAZO can be deposited in alternate layers forming multilayer with other materials comprised therebetween. In some embodiments LAZO is deposited on a pre-existing structure. Examples of structures include: platonic solids, tubes, quantum dots, particles, wires, spheres, rods, porous materials, films, layers, multi-layers and planes or any combination thereof. In some embodiments LAZO is comprised within a cathode for a battery. In some embodiments LAZO is comprised within a cathode coating. In some embodiments LAZO is deposited on an electrochemically active material. In some embodiments LAZO is deposited on LiNiO₂ or other electrochemically active materials that do not comprise cobalt. In some embodiments LAZO forms a 3D structure selected from: platonic solids, tubes, quantum dots, particles, wires, spheres, rods, porous materials, films, layers, multi-layers and planes or any combination thereof.

A primary function of LAZO is in coating pre-existing materials. As used herein, terms such as “coating”, “layer”, “film”, “thin film” and “ultrathin film” are used interchangeably. LAZO layers can be deposited on pre-existing structures using processes such as atomic layer deposition (ALD). The processes described herein provide a controlled method of producing pristine thin films. In some embodiments the thickness of the LAZO layer ranges between 1 to 1000 nm. In some embodiments the thickness of the LAZO layer ranges between 1 to 500 nm. In some embodiments the thickness of the LAZO layer ranges between 1 to 200 nm. In some embodiments the thickness of the LAZO layer ranges between 1 to 100 nm. In some embodiments the thickness of the LAZO layer ranges between 1 to 50 nm. In some embodiments the thickness of the LAZO layer ranges between 1 to 10 nm. In some embodiments the thickness of the LAZO layer ranges between 1 to 5 nm. In some embodiments the thickness of the LAZO layer ranges between 0.1 to 5 nm. In some embodiments the thickness of the LAZO layer is about 4 nm.

### Cathodes of the Invention

Cathodes in solid-state lithium batteries (used interchangeably with ‘all-solid-state lithium batteries’, ASSLBs) play a crucial role in the electrochemical reactions within the battery. They act as the site for lithium-ion extraction and insertion during charge and discharge cycles. Cathodes facilitate the movement of lithium ions between the anode and cathode through the solid-state electrolyte, enabling the flow of electric current and the storage and release of energy in the battery.

The present invention is directed towards a cathode comprising:
a first layer comprising lithium; and
a second layer comprising LiₓAl_{y}Zn_{z}O_{δ} (LAZO).

As above, the LAZO material comprised in the cathode is such that x, y, z and δ, or any combination thereof, are whole numbers greater than or equal to 1. In other embodiments x, y, z and δ, or any combination thereof, are whole numbers ranging between 1 and 10. In some embodiment the cathode refers to the first layer whereas in other embodiments the cathode refers to the first and second layer together. Where additional layers are described, the cathode refers to all of the layers comprised within the cathode. In some embodiments the first layer does not comprise cobalt. In some embodiments the first layer comprises a transition metal oxide. In some embodiments the first layer comprises at least one transition metal oxide. In some embodiments the first layer comprises LiNiO₂ (LNO). In some embodiments the first layer consists of LiNiO₂ (LNO). In some embodiments the first layer comprises any of the following selected from: Li₃MCl₆ and Li₂M_{2/3}Cl₄ where the M is selected from: Y, Tb—Lu, Sc, and In.

In some embodiments the first layer comprises cobalt. Examples of cathode materials that comprise cobalt include: LiCoO₂, LiN_{1/3}Co_{1/3}Mn_{1/3}O₂, LiMn₂O₄, and LiNi_{0.8}Co_{0.15}Al_{0.5}O₂. In some embodiments the first layer comprises LiNbO₃, Li₂ZrO₃, LiOH and Li₃PO₄. In some embodiments the first electrode comprises sulfur. In one embodiment the first layer further comprises at least one more electrochemically active material.

In some embodiments the cathode comprises:
a first layer comprising a transition metal oxide; and
a second layer comprising LiₓAl_{y}Zn_{z}O_{δ} (LAZO).

In some embodiments the LAZO material comprises at least one Li atom, at least one Al atom, at least one Zn atom and at least one O atom. The first and second layer are in contact with one another. In some embodiment the first and second layer are at least partly in contact. “Contact” refers to physically or chemically interacting with one another e.g., electrostatically, van der Waals forces, chemical bonds, etc. In some embodiments the first layer at least partly diffuses into the second layer. In other embodiments the second layer at least partly diffuses into the first layer. In some embodiments the contact between the first and second layer is about 100%. In some embodiments the contact between the first and second layer ranges between 90-100%. In some embodiments the contact between the first and second layer ranges between 80-100%. In some embodiments the contact between the first and second layer ranges between 70-100%. In some embodiments the contact between the first and second layer ranges between 90-100%. In some embodiments the contact between the first and second layer ranges between 80-90%.

In some embodiments the second layer further comprises an Al+Zn near-surface doping region disposed on the surface of the first layer. In some embodiments the near-surface doping region has a thickness of about 1 nm. In some embodiments the near-surface doping region has a thickness of about 2 nm. In some embodiments the near-surface doping region has a thickness ranging between 0.1-5 nm. In some embodiments the near-surface doping region has a thickness ranging between 0.1-2 nm.

In some embodiments the cathode comprises:
a first layer comprising LiNiO₂ (LNO); and
a second layer comprising LiₓAl_{y}Zn_{z}O_{δ} (LAZO).

In some embodiments the cathode comprises:
a first layer which does not comprise cobalt; and
a second layer comprising LiₓAl_{y}Zn_{z}O_{δ} (LAZO).

In some embodiments the cathode comprises:
a first layer comprising lithium; and
a second layer comprising LiₓAl_{y}Zn_{z}O_{δ} (LAZO) wherein an Al+Zn near-surface doping region is disposed on the surface of the first layer.

In some embodiments the cathode comprises:
a first layer comprising LiNiO₂ (LNO); and
a second layer comprising LiₓAl_{y}Zn_{z}O_{δ} (LAZO) wherein an Al+Zn near-surface doping region is disposed on the surface of the first layer.

In some embodiments the first layer comprises a continuous surface. In some embodiments the first layer comprises a uniform surface i.e., it is smooth. In some embodiments the deposition of the first layer may be of the lithium-based material in powder form. Common methods of powder deposition include spraying and printing, as described herein. As such, the first layer may comprise a continuous layer of aggregated particles (i.e., formed from the initial powder) that are in contact throughout the layer. The modulated topography of such a layer arises across the surface due to it being a composite of a powder deposition. In some embodiments the powder, once deposited on a current collector is additionally heated or annealed. Nonetheless, and in some embodiments, the layer is continuous with a uniform coverage. The first layer can also be deposited on any current collecting material. For example: LNO powder is deposited on an Al current collector forming the first layer; after which LAZO is deposited on the LNO. In some embodiments the powder deposition of Li-based materials forms polycrystalline particles on the surface of a current collector e.g., spherical particles. In some embodiments the current collector comprises any of the following selected from: aluminum (Al), copper (Cu), stainless steel and nickel (Ni) or any combination thereof.

The powder can be deposited on the current collector in any number of methods such as dry slot printing and other dry printing methods. Other power-based printing methods include: inkjet printing, powder jetting, powder dispersion printing, etc.

In some embodiments the first layer comprises 3-dimensional modulating structures. These modulating structures may be on the surface of the first layer and/or comprise the material of the first layer. In some embodiments the first layer is comprised of modulating structures. In some embodiments the first layer comprises any of the following (3D) modulating structures selected from: spherical particles, cuboidal particles, wave-like structure and platonic solids or any combinations thereof. In some embodiments the modulating structure is polycrystalline. In some embodiments the first layer comprises polycrystalline particles. In some embodiments the polycrystalline particles are spherical. For example, a first layer comprising LiNiO₂ (LNO) can be in the form of a continuous layer and also comprise spherical polycrystalline particles which modulate the topography of the surface of the first layer. In such a scenario the polycrystalline particles are in contact with the bulk of the LNO layer and modulate the surface topography of the first layer. As such, and in some embodiments, the first layer comprises a bulk structure (or layer) and a modulating structure of the same material. In one embodiment the modulating structure is disposed on the surface of the first layer. In some embodiments the ‘bulk structure’ refers to a pristine first layer upon which other structures are disposed thereon.

The size of the modulating structure can vary with various deposition parameters. As referred to herein, with regards to any structure, the “size” refers to at least one dimension of the structure. For example, the “size” can refer to the diameter of a spherical structure or the cross-sectional diameter of a rod-like structure or the height of a wave-like structure or the wavelength of an undulation on the surface or the thickness of a layer, etc. As used herein “modulating structure” refers to an additional structure that modifies another structure e.g., a continuous layer modulated by a sinusoidal wave structure. In some embodiments the size of the modulating structure ranges between 1 and 100 μm. In some embodiments the size of the modulating structure ranges between 1 and 50 μm. In some embodiments the size of the modulating structure ranges between 1 and 10 μm. In some embodiments the size of the modulating structure ranges between 1 and 2 μm. In some embodiments the size of the modulating structure ranges between 1 to 1000 nm. In some embodiments the size of the modulating structure ranges between 500 to 1000 nm. In some embodiments the size of the modulating structure ranges between 1 to 500 nm. In some embodiments the size of the modulating structure ranges between 1 to 100 nm. The size of modulating structures can vary across the first layer. In some embodiments the “first layer” refers interchangeably to a layers with or without a modulating structure. In other embodiments the “first layer” refers to a bulk structure (e.g., a layer) comprising a modulating structure and a secondary structure of the same material.

In some embodiments the first layer further comprises a secondary structure disposed on the first layer. In some embodiments the secondary structure comprises particles. In some embodiments the secondary structure comprises the same material as the modulating and bulk material. In some embodiments the secondary particles are disposed on the modulating structure on the first layer. In some embodiment the secondary structure comprises the same material as the first layer. In some embodiments the secondary structure has a 3D shape which is a platonic solid. In some embodiments the secondary structure has a 3D shape which is a tube, dot, sphere, wire, rod, particle and cube or any combinations thereof. Examples of platonic solids include: tetrahedron, cube, octahedron, dodecahedron, icosahedron, and hexahedron.

In some embodiments the size of the secondary structure ranges from 10 to 500 nm. In some embodiments the size of the secondary structure ranges from 10 to 100 nm. In some embodiments the size of the secondary structure ranges from 10 to 50 nm. In some embodiments the size of the secondary structure ranges from 1 to 10 nm. The size of secondary structures can vary across the first layer.

The LAZO layer is generally disposed on the first layer. It serves as a coating or thin film on a cathode, in various embodiments. In some embodiments, LAZO is deposited on a lithium-comprising cathode layer. In some embodiments, LAZO is deposited on a first layer comprising LNO. In some embodiments the thickness of the LAZO layer ranges between 1 to 1000 nm. In some embodiments the thickness of the LAZO layer ranges between 1 to 500 nm. In some embodiments the thickness of the LAZO layer ranges between 1 to 200 nm. In some embodiments the thickness of the LAZO layer ranges between 1 to 100 nm. In some embodiments the thickness of the LAZO layer ranges between 1 to 50 nm. In some embodiments the thickness of the LAZO layer ranges between 1 to 10 nm. In some embodiments the thickness of the LAZO layer ranges between 1 to 5 nm. In some embodiments the thickness of the LAZO layer ranges between 0.1 to 5 nm. In some embodiments the thickness of the LAZO layer is about 4 nm.

The performance of the present cathode shows advantageous characteristics in comparison to those known to an expert in the art. There are different ways of measuring the capacity of a battery. Such as the areal density or cathode loading (typically measured in mg/cm²), areal capacity (typically measured in mAh/cm²) or the capacity (typically measured in mAh). In some embodiments the capacity and the areal capacity are used interchangeably. The areal density or the cathode loading refers to the amount of active material present in a given area of the cathode electrode (surface). In some embodiments the cathode loading ranges between 5 to 25 mg/cm². In some embodiments the cathode loading ranges between 5 to 10 mg/cm². In some embodiments the cathode loading is about 9 mg/cm².

In some embodiments the cathode areal capacity ranges between 1 and 10 mAh/cm². In some embodiments the cathode areal capacity ranges between 1 and 5 mAh/cm². In some embodiments the cathode areal capacity ranges between 5 and 10 mAh/cm². In some embodiments the cathode areal capacity is about 2 mAh/cm².

The cyclability (or ‘cycling stability’) refers to the ability of the battery to undergo repeated charge and discharge cycles while maintaining its capacity and/or performance. This is not to be confused with ‘cycling’ as referred to regarding ALD processes. In some embodiments the cyclability refers to the percentage of the initial capacity retained after a certain number of cycles. In other embodiments it refers to the percentage of the initial performance after a certain number of cycles. In one embodiment the cycling stability is about 80% after 200 cycles. In some embodiments the cycling stability ranges between about 70.31-91.86% after 200 cycles. In some embodiments the cycling stability ranges between about 70-95% after 200 cycles. In some embodiments the cycling stability ranges between about 70-100% after 200 cycles. In some embodiments the cycling stability ranges between about 70-80% after 200 cycles. In some embodiments the cycling stability ranges between about 70-90% after 200 cycles. In some embodiments the cycling stability ranges between about 80-90% after 200 cycles. In some embodiments the cycling stability ranges between about 90-100% after 200 cycles. In some embodiments the cycling stability ranges between about 90-95% after 200 cycles.

In one embodiment the cycling stability is about 75% after 500 cycles. In some embodiments the cycling stability ranges between about 70-95% after 500 cycles. In some embodiments the cycling stability ranges between about 70-100% after 500 cycles. In some embodiments the cycling stability ranges between about 70-80% after 500 cycles. In some embodiments the cycling stability ranges between about 70-90% after 500 cycles. In some embodiments the cycling stability ranges between about 80-90% after 500 cycles. In some embodiments the cycling stability ranges between about 90-100% after 500 cycles. In some embodiments the cycling stability ranges between about 90-95% after 500 cycles.

In some embodiments the cathode further comprises a current collector disposed on the cathode. In some embodiments the current collector is disposed on the substrate. In some embodiments the current collector is disposed on the first layer. For example, the layer structure comprising the current collector can be as follows: Al (current collector), LNO (cathode), LAZO (coating). Thus, the current collector is disposed on the side of the cathode that is not in contact with the solid electrolyte, as described herein. In some embodiments the current collector material comprises any of the following selected from: aluminum (Al), copper (Cu), stainless steel and nickel (Ni) or any combination thereof. Therefore, in some embodiments the cathode further comprises a current collector which the first layer is disposed thereon.

In one embodiment the first layer further comprises carbon nanofibers.

### Methods of Producing LiNiO₂ (LNO)

The method described herein involves optimization of the temperature, duration of heating and ramping rate to achieve, in some embodiments, a highly aggregated layer of primary particles. Such primary particles may include powders. The methods described provide the basis for a uniform and continuous layer.

The present invention provides a method of producing LiNiO₂ (LNO), the method comprises:
mixing at least two precursors, producing a mixture; and
calcinating the mixture by placing the mixture in an O₂ atmosphere at high temperature.

In some embodiments the method of producing LiNiO₂ (LNO), comprises:
mixing a plurality of precursors, producing a mixture; and
calcinating the mixture by placing the mixture in an O₂ atmosphere at high temperature.

In some embodiments precursors comprise compounds which comprise Li, N and O atoms. In some embodiments, calcinating the mixture produces a powder. In some embodiments the plurality of precursors comprise compounds which comprise Li, N and O atoms. In some embodiments the plurality of precursors comprises: nickel salts, lithium compounds, metal oxides and organic precursors or any combinations thereof. Examples of nickel salts include, but are not limited to: nickel hydroxide (Ni(OH)₂), nickel nitrate, nickel acetate, nickel chloride, nickel sulfate, nickel carbonate, nickel oxalate, etc. Examples of lithium compounds include, but are not limited to: lithium hydroxide (LiOH), lithium carbonate, lithium nitrate, lithium acetate, etc. In some embodiments the at least two precursors comprise nickel hydroxide (Ni(OH)₂) and lithium hydroxide monohydrate (LiOH·H₂O). In some embodiments the precursors are in a form selected from: solid, liquid and gas, or a combination thereof. Thus, mixing of various precursors is carried out in a manner that is appropriate for the state of matter of that precursor. For example, precursor mixing can include solution mixing (e.g., in a solvent), solid mixing (e.g., grinding, milling, sieving, blending, etc.), co-precipitation, slurry casting, gas mixing, etc. For example: solid mixing can include manual mixing, ball milling and the like. In some embodiments the mixing of precursors can further comprise heating the mixture. In some embodiments the mixing further comprises placing the mixture in gas atmosphere. Precursor mixing can also include mixing at high pressure.

In some embodiments the mixing of the precursors is carried out at a mole ratio of Li:Ni of about 1.10:1. In some embodiments the mixing of the precursors is carried out at a mole ratio of Li:Ni of about 1.20:1. In some embodiments the mixing of the precursors is carried out at a mole ratio of Li:Ni of about 1.0:0.9.

Calcining mixtures is typically carried out in a calcining chamber or furnace. Typically, a variety of parameters are selected to optimize a particular process. Examples of parameters included for optimization include: precursor composition, nature of the precursor composition, temperature, atmosphere, holding time (duration the precursors are kept at the calcination temperature), chamber pressure and heating/cooling rate.

In some embodiments the calcination temperature is about 650° C. In some embodiments the calcination temperature ranges between 300-800° C. In some embodiments the calcination temperature ranges between 300-500° C. In some embodiments the calcination temperature ranges between 500-700° C. In some embodiments the calcination temperature ranges between 600-700° C. In some embodiments the calcination temperature ranges between 700-800° C. In some embodiments the “calcination temperature” is referred to simply as the “temperature”.

In some embodiments the atmosphere comprises O₂. In some embodiments the atmosphere comprises any of the following selected from: air, nitrogen, oxygen and inert gas or any combination thereof. In some embodiments the O₂ is flowed through the calcination chamber during the calcination. In some embodiments the gas comprised within the calcination chamber changes between steps. For example, during the steps of: heating, the calcination step (i.e., at the holding temperature) and cooling, the gases can be the same at each step, or different at each step, or the same in two steps but different in the other step.

As used herein the “holding time” refers to the duration that the precursors are kept at the calcination temperature. Although calcination also occurs above and below the ‘calcination temperature’ which is set, it will be understood by experts in the art that the holding time refers to the amount of time where a constant temperature is maintained. In some embodiments the holding time is about 10 hours. In some embodiments the holding time ranges between 2 to 15 hours. In some embodiments the holding time ranges between 2 to 5 hours. In some embodiments the holding time ranges between 5 to 10 hours. In some embodiments the holding time ranges between 10 to 15 hours. In some embodiments the holding time ranges between 8 to 12 hours.

In some embodiments the method further comprises cooling the mixture to about room temperature.

As used herein the “heating rate” and “cooling rate” refer to the increase or decrease (respectively) of the temperature per unit time (e.g., minute). In some embodiments the heating rate is the same as the cooling rate. In some embodiments the rate of change in temperature to reach the high temperature or the room temperature, or a combination thereof, ranges between 1-20° C. per minute. In some embodiments the heating rate and cooling rate are different. Sometimes the heating or cooling rate are referred to as the rate of change of temperature i.e., for either heating or cooling or both. In some embodiments the rate of change of temperature is about 5° C./min. In some embodiments the rate of change of temperature ranges between 1 and 20° C./min. In some embodiments the rate of change of temperature ranges between 1 and 5° C./min. In some embodiments the rate of change of temperature ranges between 5 and 10° C./min. In some embodiments the rate of change of temperature ranges between 15 and 20° C./min. In some embodiments the rate of change of temperature ranges between 2° and 50° C./min.

In some embodiments the method further comprises increasing the atmospheric pressure in the calcination chamber during the cooling step. In some embodiments the method does not comprise increasing the atmospheric pressure in the calcination chamber during the cooling step. The terms “atmospheric pressure”, “pressure” and “gas pressure” (e.g., O₂ pressure) are used interchangeably in this step, referring to the pressure in the calcination chamber. As stated herein, the atmosphere can comprise different gases at various stages. This increase in atmospheric pressure can be done for the duration of the whole cooling step or only for part of it. In some embodiments the increase in atmospheric pressure is for an O₂ atmosphere. In some embodiments the increase in pressure is to about 100 bar. In some embodiments the increase in pressure is to between 20 to 150 bar. In some embodiments the increase in pressure is to between 50 to 100 bar. In some embodiments the increase in pressure is to between 75 to 125 bar. In some embodiments the increase in pressure is to between 100 to 150 bar. In some embodiments the increase in pressure is to between 125 to 150 bar. In some embodiments the pressure during the calcination step is lower than the pressure during the cooling step.

In some embodiments the cathode comprises LNO, LPSC and carbon nanofibers. In some embodiments the mass ratio of these three comprises is 65:30:5 or 75:22:3. In some embodiments these components are hand mixed, followed by milling. The mixed powder is then homogenously distributed on one side of a solid-electrolyte (e.g., in pellet form) by processes such as spraying or printing. Following this, the composite cathode material, deposited on the solid-electrolyte material, is pressed under high pressure. In some embodiments the pressure is between 300 to 500 MPa. In some embodiments the pressing occurs for between 1 to 10 minutes.

### Method of Depositing LAZO on a Substrate

The present invention is further directed towards methods of depositing LiₓAl_{y}Zn_{z}O_{δ} (LAZO) on a substrate. Typically, the LAZO layer is thinner than the substrate onto which it is deposited.

In some embodiments the invention is directed towards a method of depositing LiₓAl_{y}Zn_{z}O_{δ} (LAZO) on a substrate, the method comprising:
providing a substrate;
providing a plurality of precursors; and
carrying out atomic layer deposition (ALD) on the substrate by cycling alternately between the plurality of precursors, producing a LAZO layer disposed on the substrate.

In some embodiments the substrate comprises lithium. In some embodiments the substrate forms a continuous layer sourced from a powder. In some embodiments the substrate comprises LiNiO₂ (LNO). In some embodiments the substrate comprises any of the following selected from: Li₃MCl₆ and Li₂M_{2/3}Cl₄ wherein M is selected from: Y, Tb—Lu, Sc, and In; and LiMn₂O₄. In some embodiments the plurality of precursors comprise Li, Al, Zn and O or a combination thereof. In some embodiments the plurality of precursors comprise lithium tert-butoxide (LiO^{t}Bu), trimethylaluminum (TMA), diethylzinc (DEZ) and water (H₂O). In some embodiments the plurality of precursors consist of lithium tert-butoxide (LiO^{t}Bu), trimethylaluminum (TMA), diethylzinc (DEZ) and water (H₂O). In some embodiments the water precursor is deionized water.

As used herein the term “precursor”, “precursors” and “plurality of precursors” are sometimes used interchangeably to describe one or more of the precursors. In some embodiments a precursor comprises an organometallic compound. In some embodiments the organometallic compound is volatile. The terms “volatile organometallic precursors”, “organometallic-based precursor”, “volatile organometallic compounds”, “organometallic compounds” and “organometallic precursor” are used interchangeably.

Examples of organometallic-based precursors comprising lithium include: lithium tert-butoxide (LiO^{t}Bu), lithium cyclopentadienyl (LiCp), n-BuLi (n-butyllithium), lithium diisopropylamide (LiDIPA), lithium dicyclohexylamide, Li-THD (THD=2,2,6,6-tetramethyl-3,5-heptanedionate), lithium alkyls, lithium alkyl n-butyllithium and LiN(Si(CH₃)₃)₂ (LiHMDS).

Examples of organometallic-based precursors comprising aluminum include: trimethylaluminum (TMA), tris(dimethylamino)aluminum (TDMAAI) and aluminum isopropoxide (Al(O-i-Pr)₃, where i-Pr is the isopropyl group (—CH(CH₃)₂)).

Examples of organometallic-based precursors comprising zinc include: diethylzinc (DEZ), dimethylzinc (DMZ) and diisopropylzinc (DIZ).

In some embodiments the plurality of precursors comprise the following selected from: lithium tert-butoxide (LiO^{t}Bu), lithium cyclopentadienyl (LiCp), n-BuLi (n-butyllithium), lithium diisopropylamide (LiDIPA), lithium dicyclohexylamide, Li-THD, lithium alkyls, lithium alkyl n-butyllithium, LiHMDS, trimethylaluminum (TMA), tris(dimethylamino)aluminum (TDMAAI), aluminum isopropoxide (Al(O-i-Pr)₃), diethylzinc (DEZ), dimethylzinc (DMZ) and diisopropylzinc (DIZ) and deionized water or any combinations thereof.

A number of ALD parameters affect the optimization of thin layer production. As such, and not limited to these parameters alone, the process temperature (or simply the “temperature”), the carrier gas, flow rate, precursor sequence, pulse time, reaction time and evacuation time are considered. The ‘pulse time’ is the duration for which the precursor is introduced into the ALD chamber (or ‘reaction chamber’). The ‘reaction time’ is the duration for which the precursor reacts with the substrate which it is reacting with. The ‘evacuation time’ refers to when excess precursor and reaction by-products are removed from the reaction chamber before the next precursor gas is introduced. The terms “evacuation” and “purging” are understood interchangeably. The pulse time, reaction time and evacuation time need to be optimized for a particular ALD chamber, for the various material components used and for the desired result to be achieved. Typically, an elevated temperature is set during precursor injection and for the duration of the reaction, to facilitate chemical reactions and optimize film growth.

In some embodiments each precursor is exposed to a different temperature. In one embodiment each precursor is exposed to the same temperature. As used herein, when referring to the temperature of the ALD process, this refers to the duration of the step of introducing a precursor, or the duration of the step of the precursor reaction, or a combination thereof. In some embodiments the ALD process is carried out at about 200° C. In some embodiments the ALD process is carried at a temperature ranging between 150-400° C. In some embodiments the ALD process is carried at a temperature ranging between 150-250° C. In some embodiments the ALD process is carried out at a temperature ranging between 150-200° C. In some embodiments the ALD process is carried out at a temperature ranging between 200-250° C. In some embodiments the ALD process is carried out at a temperature ranging between 175-225° C. In some embodiments the ALD process is carried out at a temperature ranging between 200-300° C. In some embodiments the ALD process is carried out at a temperature ranging between 300-400° C.

In some embodiments the ALD process includes the use of a carrier gas. When a carrier gas is used, the carrier gas is selected from argon or nitrogen. In some embodiments the ALD process does not include the use of a carrier gas. In some embodiments the carrier gas has a flow rate of about 20 sccm. In some embodiments the carrier gas has a flow rate ranging between 10 to 200 sccm. In some embodiments the carrier gas has a flow rate ranging between 10 to 100 sccm. In some embodiments the carrier gas has a flow rate ranging between 10 to 50 sccm. In some embodiments the carrier gas has a flow rate ranging between 10 to 30 sccm.

ALD cycling is required to produce uniform thin films with atomic precision. This cycling refers to a repeated sequence of steps. The sequence can include, at least: introducing a substance (e.g., a precursor) into the ALD chamber, carrying out a reaction, and evacuating the excess substance (and byproducts) from the chamber and repeating these steps with another (or the same) substance (e.g., a precursor). Where several precursors are used sequentially in the cycle, “a cycle” may refer to all of the sequential steps comprising each step for each precursor. Alternatively, “a cycle” may refer to the ALD deposition resulting from a single precursor deposition step. Each ALD precursor deposition step can include a pulse time, a reaction time and evacuation time. For example, if precursors X, Y and Z are separately used in the ALD process, one cycle may refer to the sequence: X (pulse, reaction, evacuation), Y (pulse, reaction, evacuation) and Z (pulse, reaction, evacuation). However, any combination of X, Y and Z can be used in one cycle, each being used at least once. For example: one cycle may include the steps as follows: X, Y, X, Z, X, which is then repeated in another cycle, or X, X, Y, Y, Z, Z, etc.

In one embodiment one ALD cycle comprises introducing the precursors in the following step sequence: Al-comprising precursor, O-comprising precursor, Li-comprising precursor, O-comprising precursor, Zn-comprising precursor, and O-comprising precursor. In one embodiment one ALD cycle comprises introducing the precursors in the following step sequence: TMA, H₂O, LiO^{t}Bu, H₂O, DEZ and H₂O. In some embodiments the H₂O is deionized water. In some embodiments, the sequence of these precursors can be changed to achieve the same resulting layer.

In some embodiments each precursor step sequence has a pulse time of about 0.02 s, a reaction time of about 10 s and an evacuation time of about 30 s. In some embodiments the pulse time ranges between 0.01 to 5 s. In some embodiments the pulse time ranges between 0.01 to 1 s.

In some embodiments the reaction time ranges between 1 to 30 s. In some embodiments the reaction time ranges between 1 to 10 s. In some embodiments the reaction time ranges between 5 to 15 s. In some embodiments the reaction time ranges between 10 to 20 s. In some embodiments the reaction time ranges between 20 to 30 s.

In some embodiments the evacuation time ranges between 10 to 60 seconds. In some embodiments the evacuation time ranges between 10 to 30 seconds. In some embodiments the evacuation time ranges between 20 to 40 seconds. In some embodiments the evacuation time ranges between 30 to 50 seconds. In some embodiments the evacuation time ranges between 60 s to 5 mins.

In ALD processes the number of cycles carried out, and the associated growth per cycle, determines how thick the final layer of the material will be. Such a value will depend on several factors, such as the precursors used, the materials, rates, temperatures, etc. The number of ALD cycles should be optimized for the desired thickness and nature of the film that is being grown or deposited, all of which are considered within the scope of the present deposition process.

In some embodiments the ALD cycling comprises between 10 and 10,000 cycles. In some embodiments the ALD cycling comprises between 10 and 1000 cycles. In some embodiments the ALD cycling comprises between 10 and 500 cycles. In some embodiments the ALD cycling comprises between 10 and 100 cycles. In some embodiments the ALD cycling comprises between 50 and 200 cycles.

### All Solid-State Lithium Battery (ASSLB)

The main components of a solid-state lithium battery is presently disclosed. As will become clear, the cathode and materials comprised therein, are incorporated into the solid-state battery. As used herein the terms “battery” and “cell” are used interchangeably. Generally, the term “solid-state” in the context of batteries refers to the use of solid electrolytes in the battery assembly. As used herein, the term “all-solid-state lithium battery” and “solid-state lithium battery” are used interchangeably; otherwise, these terms are referred to simply as “lithium battery” or “solid-state battery”.

The invention provides a solid-state battery comprising:
a cathode as described herein;
a solid electrolyte; and
an anode;
wherein the solid electrolyte is disposed between the cathode, as described herein, and the anode, as described herein.

In various embodiments the solid-state battery comprises lithium. In some embodiments the cathode comprises a first layer comprising lithium and a second layer comprising LAZO. The thickness of the LAZO layer in the battery configuration can be selected for an optimal use. In some embodiments the thickness of the LAZO layer ranges between 1 to 1000 nm. In some embodiments the thickness of the LAZO layer ranges between 1 to 500 nm. In some embodiments the thickness of the LAZO layer ranges between 1 to 200 nm. In some embodiments the thickness of the LAZO layer ranges between 1 to 100 nm. In some embodiments the thickness of the LAZO layer ranges between 1 to 50 nm. In some embodiments the thickness of the LAZO layer ranges between 1 to 10 nm. In some embodiments the thickness of the LAZO layer ranges between 1 to 5 nm. In some embodiments the thickness of the LAZO layer is about 4 nm. In some embodiments the thickness of the LAZO layer ranges between 0.1 to 5 nm.

In some embodiments the solid electrolyte comprises an argyrodite-like material. In some embodiments the argyrodite-like material is in the form Li_{7-θ}BCh_{6-θ}X_{θ}. In some embodiments θ is between 0 and 1, B is selected from: phosphor or arsenic, Ch is selected from: sulfur or selenium, X is selected from: chlorine, bromine or iodine.

In some embodiments the solid electrolyte is selected from an inorganic solid electrolyte (ISE), a solid polymer electrolyte (SPE) and a composite polymer electrolyte (CPE) or any combination thereof. In some embodiments the solid electrolyte is selected from oxide-, sulfide- or phosphate-based. In some embodiments the ISE comprises any of the following selected from: LISICON (lithium superionic conductor, Li₂₊₂ₓZ₁₋ₓGeO₄) (e.g. LGPS, LiSiPS, LiPS), argyrodite-like (e.g. Li₆PS₅X, X═Cl, Br, I), garnets (LLZO), NASICON (sodium superionic conductor) (e.g. LTP, LATP, LAGP), lithium nitrides (e.g. Li₃N), lithium hydrides (LiBH₄), lithium phosphidotrielates, phoshidotetrelates, perovskites (e.g. lithium lanthanum titanate, LLTO), lithium halides (LYC, LYB), RbAg₄I₅, lithium phosphorus oxynitride (LIPON) and lithium thiophosphates (Li₂S—P₂S₅). In some embodiments the solid electrolyte comprises: LPSC (Li₆PS₅Cl), LSPSSC (Li_{9.54}Si_{1.74}(P_{0.9}Sb_{0.1})_{1.44}S_{1.7}Cl_{0.3}), LSPS (Li₁₀SnP₂S₁₂), LGPS (Li₁₀GeP₂S₁₂), LSSSI (Li_{6.7}Si_{0.7}Sb_{0.3}S₅I), LISC (Li₂In_{1/3}Sc_{1/3}Cl₄), LHC (Li_{2.73}Ho_{1.09}Cl₆) and LSC (Li₂Sc_{2/3}Cl₄).

In some embodiments the solid electrolyte comprises: LISICON, argyrodite-like material, garnets, NASICON, lithium nitrides, lithium hydrides, lithium phosphidotrielates, phoshidotetrelates, perovskites, lithium halides, RbAg₄I₅, lithium phosphorus oxynitride, lithium thiophosphates, LPSC, LSPSSC, LSPS, LGPS, LSSSI, LISC, LHC, LSC, polyethylene oxide (PEO) based, polyvinylidene fluoride (PVDF) based, polyacrylonitrile (PAN) based, polyethylene oxide/polypropylene oxide (PEO/PPO) blends and polyphosphazene-based electrolytes or any combination thereof.

In some embodiments solid polymer electrolytes comprise any of the following selected from: polyethylene oxide (PEO) based electrolytes (e.g., PEO-LiClO₄, PEO-LiCF₃SO₃, or PEO-LiN(CF₃SO₂)₂), polyvinylidene fluoride (PVDF) based electrolytes (e.g., PVDF-HFP (hexafluoropropylene) doped with LiPF₆), polyacrylonitrile (PAN) based electrolytes (e.g., PAN-LiClO₄, PAN-LiBF₄, or PAN-LiCF₃SO₃), polyethylene oxide/polypropylene oxide (PEO/PPO) blends and polyphosphazene-based electrolytes (e.g., polyphosphazene polymers, such as poly[bis(methoxyethoxyethoxy)phosphazene](MEEP)) or any combinations thereof.

In some embodiments the crystalline structure of the solid electrolyte is selected from: polymer-ceramic composites, polymer-nanoparticle composites and polymer-salt composites or any combination thereof.

The anode selection can vary to optimize the performance of the battery and is selected for its compatibility with the components of a particular battery configuration. Furthermore, different combinations of materials across the battery will be suitable for different types of anode materials and configurations (e.g., type of electrolyte). The anode is selected accordingly.

In some embodiments the anode comprises LiIn. In some embodiments the anode consists of LiIn. In some embodiments the Li and In are deposited separately. For example, a sheet of Li and a sheet of In are deposited separately onto the solid-electrolyte. Once each sheet is deposited on the solid-electrolyte, the combination of sheets are pressed to ensure good contact. In one embodiment the Li and In sheets are disposed on the solid-electrolyte and undergo a pressure ranging between 100 to 300 MPa. In some embodiments the pressing of the Li and In sheets is carried out for about 2 minutes. In some embodiments the pressing is carried out for between 1 and 10 mins. In some embodiments the thickness of each component sheet of the anode is a different thickness. In some embodiments the composition of the anode is about Li_{0.5}In. As such, and in some embodiments, the Li sheet is about 0.25 mm thick and the In sheet is about 0.1 mm thick. The principle of applying various layers of sheets, and pressing them to produce an anode can be extended to other materials described herein.

In some embodiments the anode comprises Si. In some embodiments the anode comprises Li. In some embodiments the anode comprises any of the following selected from: Li, Al, Si, In and Sn or any combination thereof. In some embodiments the anode comprises any of the following selected from: Li, LiIn, Li-alloys (e.g., lithium-silicon (Li—Si), lithium-tin (Li—Sn), and lithium-aluminum (Li—Al) alloys), Li₄Ti₅O₁₂ (LTO), Ag—C, lithium graphite (Li-G), In, lithium niobate (LiNbO₃), carbon, metal oxides (e.g., TiO₂, SnO₂), metal sulfides (e.g., Cu₂S) or any combinations thereof. In some embodiments the anode comprises any of the following selected from: In, Si, GeₓSi₁₋ₓ, SnO—B₂O₃, SnS—P₂S₅, Li₂FeS₂, FeS, NiP₂, and Li₂SiS₃.

In one embodiment, the anode is selected from any of the following selected from: Li, LiIn, Li-alloys, LTO, Ag—C, Li-G, In, LiNbO₃, carbon, metal oxides, metal sulfides, In, Si, GeₓSi₁₋ₓ, SnO—B₂O₃, SnS—P₂S₅, Li₂FeS₂, FeS, NiP₂, and Li₂SiS₃ or any combinations thereof.

In some embodiments the battery further comprises a first current collector connected to the cathode and a second current collector connected to the anode. In some embodiments the first current collector and the second current collector comprise metal. In some embodiments the first current collector and the second current collector comprise any of the following metals selected from: aluminum (Al), copper (Cu), stainless steel, nickel (Ni), an alloy comprising Al, Cu or Ni, or any combination thereof. In some embodiments the first current collector and the second current collector are the same. In some embodiments the first current collector and the second current collector are the different.

In some embodiments the battery further comprises a battery housing configured to house the cathode, the anode and the solid electrolyte. In some embodiments the battery housing comprises terminal contacts. In some embodiments the battery further comprises at least one sealant. The sealant serves to protect the battery from external damage and/or exposure to the atmosphere. In some embodiments the battery further comprises an additional conductive material to ensure efficient charge transfer across interfaces.

In some embodiments the solid-state battery is connected to at least one other solid-state battery in parallel. In some embodiments the solid-state battery is connected to at least one other solid-state battery in series. Any number of batteries can be used in parallel or in series to achieve a particular optimization or specification for use in an application.

### Methods of Manufacturing a Solid-State Battery

The present invention is directed towards methods of manufacturing a solid-state battery. In some embodiments the method comprises:
providing a solid electrolyte;
depositing the cathode material on a first side the solid electrolyte;
pressing the cathode material on said first side;
providing at least one anode material and depositing it on a second side of the solid electrolyte.

In one embodiment the solid electrolyte comprises a first side and a second side. In some embodiments the cathode material is deposited on the solid electrolyte by any of the following: slate printing, dry printing and spray coating or any combination thereof. In some embodiments the depositing of the cathode material can further comprise uniaxial pressing of the cathode material onto the solid electrolyte. In some embodiments the uniaxial pressure of pressing is about 150 MPa. In some embodiments the uniaxial pressure ranges between 100 to 300 MPa. In some embodiments this pressure is applied for between 1 and 10 mins.

In one embodiment the anode material is provided in the form of a foil or sheet. In some embodiments the at least one anode material comprises: Li, In, Al, Cu or any combinations thereof. In one embodiment the anode material is LiIn. In some embodiments an In foil is deposited on the solid-electrolyte, followed by an Li foil. In some embodiments the In foil has a thickness of about 0.1 mm. In some embodiments the In foil has a thickness ranging between 0.05 to 1 mm. In some embodiments the Li foil has a thickness of about 0.25 mm. In some embodiments the thickness of the Li foil ranges between 0.1 to 1 mm. In various embodiments the In foil is deposited on the solid-electrolyte, followed by Li foil deposited thereon.

In some embodiments the method further comprises pressing a first anode material on the SE at an elevated pressure. For example, for between 100 to 300 MPa for about 2 mins. This is followed by pressing a second (or any subsequent) foil onto the first anode material. Each additional anode material can undergo pressing at the pressures and times outlined herein.

In some embodiments the method further comprises depositing a first current collector on the cathode and depositing a second current collector on the anode.

In some embodiments the method of manufacturing further comprises an encapsulation step to seal the components from environmental damage. In some embodiments the method of manufacturing further comprises encapsulation of the battery components in a housing structure.

In one embodiment, the term “a” or “one” or “an” refers to at least one. In one embodiment the phrase “two or more” may be of any denomination, which will suit a particular purpose. In one embodiment, “about” or “approximately” may comprise a deviance from the indicated term of +1%, or in some embodiments, −1%, or in some embodiments, ±2.5%, or in some embodiments, ±5%, or in some embodiments, ±7.5%, or in some embodiments, ±10%, or in some embodiments, ±15%, or in some embodiments, ±20%, or in some embodiments, ±25%.

Those skilled in the art to which this invention pertains will readily appreciate that numerous changes, variations, and modifications can be made without departing from the scope of the presently disclosed subject matter, mutatis mutandis.

### EXAMPLES

### Example 1

### Material Synthesis

LNO cathode powders were synthetized via a solid-phase reaction at high temperature. Typically, Ni(OH)₂ (Ni: 60.0-70.0%, Sigma-Aldrich) and LiOH·H₂O (99.995%, Sigma-Aldrich) precursors were mixed at a desirable mole ratio (Li:Ni=1.10:1) and then calcined under a flowing O₂ atmosphere at 650° C. for 10 h. Both heating and cooling rates were set to 5° C.·min⁻¹. During the cooling process, the O₂ pressure was increased to ˜100 bar. Finally, the as-prepared LNO cathode powders were transferred into an argon glovebox and ground in a mortar. LAZO@LNO cathode powders were prepared by atomic layer deposition (ALD) in the argon glovebox. The LAZO protective layer was deposited on the surface of LNO cathode powders using lithium tert-butoxide (LiO^{t}Bu, 97%, Sigma-Aldrich), trimethylaluminum (TMA, 97%, Sigma-Aldrich), diethylzinc (DEZ, ≥52% Zn basis, Sigma-Aldrich), and deionized water (H₂O) as precursors in a Savannah 200 ALD system (Cambridge Nanotech, USA). The deposition temperature for LAZO was set to 200° C. LNO powder was placed into a tumbler, which was then set at 20 rpm. Argon was used as the carrier gas at a flow rate of 20 sccm. During one ALD cycle, TMA (0.02 s-10 s-30 s), H₂O (0.02 s-10 s-30 s), LiO^{t}Bu (2 s-30 s-30 s), H₂O (0.02 s-10 s-30 s), DEZ (0.02 s-10 s-30 s) and H₂O (0.02 s-10 s-30 s) were alternatively introduced into the reaction chamber with a pulse time, reaction time, and evacuation time. After 50, 100 and 150 ALD cycles, a LAZO coating with different thickness was deposited on the surface of LNO powders. The 100 cycles ALD LAZO coated LNO samples were selected as the coated samples for in-depth analysis because they exhibited the best cycling performance among the three coated samples based on electrochemical measurements (FIG. 22). The LPSC SE powder was prepared by ball milling a stoichiometric mixture of Li₂S (99.98%, Sigma-Aldrich), P₂S₅ (99%, Sigma-Aldrich), and LiCl (99.95%, Sigma-Aldrich) at 600 rpm for 10 h with ZrO₂ balls. After that, the ball-milled powder was heat-treated at 550° C. for 5 h in a flowing Ar atmosphere. The total conductivity of the synthesized LPSC SE, measured using stainless steel blocking electrodes, was 3.2×10⁻³ S·cm⁻¹.

### Example 2

### Materials Characterization

The XRD measurements were conducted in the 20 range from 10° to 80° using an X-ray diffractometer (Bruker D8 Advance) equipped with a Cu Kα radiation source (λ=1.5406 Å). Rietveld refinement was conducted using the MAUD software to obtain crystal structure information. The samples were sealed with Kapton film in the highly pure argon glovebox before being transferred to the sample stage of XRD. The SEM measurements were carried out using a field-emission SEM (FEI, Magellan 400L) equipped with an energy-dispersive spectrometer (EDX). The HAADF-STEM images and mappings were obtained by aberration probe-corrected STEM (ThermoFisher, Themis Z G3) with an accelerating voltage of 300 kV and a high brightness Schottky field emission electron source. HAADF-STEM samples were prepared by dual-beam focused-ion beam (FIB, FEI, Helios 5UC) using a 5 kV Ga ion beam. Prior to FIB preparation, epoxy soaking and carbon deposition were conducted to avoid damage to the ultrathin ALD LAZO protective layer by the Ga ion beam and preserve the sample morphology in subsequent lift-out and thinning processes. After lift-out, the prepared TEM samples were thinned to ˜100 nm. The cross-sectional images of composite cathode layers were measured using a plasma focused ion beam SEM (PFIB-SEM) (ThermoFisher, Helios G4-CXe). In operando Raman measurements were conducted using a LabRAM HR Evolution Raman microscope (HORIBA France SAS) with a 532 nm laser. The X-ray absorption spectra at the Ni—K edge (17C beamline), P—K edge (16A beamline), S—K edge (16A beamline), Ni-L_{2,3} edge (11A beamline), and O—K edge (11A beamline), were measured at the Taiwan Synchrotron Radiation Research Center. The XPS measurements were performed on a Thermo Scientific Nexsa spectrometer equipped with an Al Kα achromatic X-ray source. To avoid exposure to air and moisture, all samples were sealed using a specific sample holder in a highly pure argon glovebox before being transferred to the SEM, STEM, XAS and XPS chamber. Specially for the measurements of Ni-L_{2,3} edge of LNO and LAZO@LNO powders, the sample was first pressed into a pellet in the highly pure argon glovebox, and then the pellet was cut open using a crystal cleaver (WX-440, Kratos Analytical Ltd.) in the XAS chamber. The signal of Ni-L_{2,3} edge of LNO and LAZO@LNO powders was collected from the exposed fresh section of the pellet.

### Example 3

### XAS Simulations

To fit the Ni-L_{2,3} XAS, a conventional configuration-cluster-interaction calculations was used. In this approach, local solid-state effects of the crystal field, ligand field, spin-orbital coupling, and the atomic multiplet were involved. To consider the hole-disproportion into the calculations the double NiO₆ cluster was employed based on the configuration

$$\vert 3 {d}_{A}^{7 + i} {\underline{L}}_{A}^{i} 3 {d}_{B}^{7 + j} {\underline{L}}_{B}^{j} 2 {p}^{6} 〉$$

with i and j each ranging from 0 to 2, and

$${\underline{L}}_{A ( B )}^{i}$$

denotes the number of i(j) holes in the ligand orbital bonding to the Ni d shell.

All local solid-state effects were written in the form of second quantization with parameters used as following: 10 Dq=0.7 eV for the 3d local crystal field under Oh symmetry, ξ=0.091 eV for the 3d electrons spin-orbital coupling coefficient and ξ=11.506 eV for 2p core-hole. The Slater-Integral for atomic-multiplet effects was set as (F₂, F₄)=(9.293 eV, 5.806 eV) for 3d-3d Coulomb interactions and (F₂, G₁, G₃)=(5.844 eV, 4.430 eV, 2.521 eV) for 2p-3d Coulomb interactions. The values of those Slater-Integral were deduced from Hartree-Fock approximation using the R. D. Cowans coded RCN36K. The mono-part of Slater-Integral (F0) was defined as U_{dd}+(F₂+F₄)×2/63 for 3d-3d and U_{pd}+(1/15)×G₁+(3/70)×G₃ for 2p-3d Coulomb interactions, where U_{dd}=6.0 and U_{dp}=7.5 eV were used in the fitting.

The onsite energy is defined as 1/10×(5×Δ−56×U_{dd}−48×U_{pd}) for 3d orbital, 1/10×(−5×Δ+14×U_{dd}+12×U_{pd}) for L orbital, and 1/10×(5×Δ+14×U_{dd}−68×U_{pd}) for 2p core shell, where the charger transfer energy Δ controls the energy cost for one electron hopping from L to 3d orbital. The parameter for the intra-cluster hopping between d_{A}−L_{A} (d_{B}−L_{B}) was derived by pdσ×1/\sqrt{1−V₁²}, and the intra-cluster hopping d_{A}−L_{B} (d_{B}−L_{A}) was controlled by the parameter of pdσ×V_{I}. The V_{I}=0.225 got the best fitting. To take the effect of hole-disproportion, pdσ=−1.95 eV is set for the hopping in-between d_{A}−L_{A} and pdσ=−1.16 eV for the hopping in-between d_{B}−L_{B} to account for the ground state electronic configuration of

$$\vert {d}_{A}^{8} {\underline{L}}_{A}^{1.6} {d}_{B}^{8} {\underline{L}}_{B}^{0.4} 〉 .$$

The XAS for Ni^{3.6+} were calculated by employing the Green's function to propagate the ground state electronic configuration of

$$\vert {d}_{A}^{8} {\underline{L}}_{A}^{1.6} {d}_{B}^{8} {\underline{L}}_{B}^{04} 〉$$

to the L_{2,3}-edge XAS excitonic state of

$$\vert \underline{p} {d}_{A}^{9} {\underline{L}}_{A}^{1.6} 〉 \vert {d}_{B}^{8} {\underline{L}}_{B}^{0.4} 〉 ,$$

### and the XAS for Ni^{2.4+} to

$$\vert {d}_{A}^{8} {L}^{1.6} 〉 \vert \underline{p} {d}_{B}^{9} {\underline{L}}_{B}^{0.4} 〉 .$$

### Example 4

### Electrochemical Measurements

ASSLBs were tested using STC-SB polyaryletheretherketone (PEEK) mold cells with a 10 mm diameter (Hefei Kejing Mater. Tech. Co. Ltd., China) at 35° C. LPSC powder (˜80 mg) was first added into the cylinder and then submitted to uniaxial pressing at a pressure of 150 Mpa for 2 min. The composite cathode was prepared by hand mixing LNO (or LAZO@LNO), LPSC, and carbon nanofiber (>99%, Sigma-Aldrich) at a mass ratio of 65:30:5 or 75:22:3 in an agate mortar for 30 min, after which 10-11 mg (25-32 mg for the high-loading test) of this mixed powder was homogeneously distributed on one side of the preformed SE pellet, and then submitted to uniaxial pressing at a pressure of 370 Mpa for 2 min. After the second pressing step, a 0.1 mm thick indium foil with a 9 mm diameter and a 0.25 mm thick lithium foil with a 3 mm diameter were successively added to the other side of the SE pellet and pressed at a pressure of 150 Mpa for 2 minutes. For the high-loading test, the amount of LiIn anode should also be increased accordingly. The LiIn anode composition is close to Li_{0.5}In, which can provide a stable potential of ˜0.6 V vs. Li⁺/Li as the counter electrode. Moreover, it provides a Li reservoir to ensure that the discharge is limited only by the cathode. The amount of Li coming from the cathode is ˜10 at % of the amount of Li_{0.5}In. So in this case, the N/P ratio is ˜4.3. After that, a ˜150 or ˜2 Mpa constant pressure was applied to the cell using the screw of the stainless-steel framework; the pressure was kept constant during the electrochemical tests. The mass loading of LNO or LAZO@LNO cathode active material was 8.28-9.11 mg·cm⁻² (23.18-26.50 mg·cm⁻² for the high-loading test). Galvanostatic cycling tests of the cells were conducted using a Neware battery test system (CT-4008T, Shenzhen, China) in the voltage range from 2.0 to 3.7 V (vs. LiIn/In), which corresponds to approximately 2.6-4.3 V (vs. Li⁺/Li). The C-rate of 1 C corresponds to 180 mA·g⁻¹. The GITT tests were carried out at a constant current of 0.2 C for 10 min and a resting period of 1 h during the charge-discharge processes. EIS tests were performed over a frequency range of 1 MHz to 5 mHz with an applied amplitude of 10 mV by an electrochemical working station (Biologic VMP-300). CV tests were carried out at a scan rate of 0.02 mV s⁻¹ under 2.6-4.3 V (vs. Li⁺/Li) via an electrochemical working station (Biologic VMP-300).

### Example 5

### ALD Deposition

The atomic layer deposition (ALD) technique is a typical gas-phase thin film deposition process with self-limiting and saturated surface reactions. Therefore, continuous exposure to the gaseous precursors until the surface reactions become saturated is the key to obtaining complete and uniform coating on powder samples. This can be achieved by developing advanced ALD reactor and precursor supply systems. For example, rotary reactors have been developed to provide both mechanical agitation which prevents agglomeration, and static reactant exposure which provides a high residence time. Powder ALD technique has progressed over the last two decades, dealing successfully with the issues related to agglomeration of particles, thickness, conformity and composition of the coating films. Based on the typical SEM-EDX (FIG. 8) and STEM-EDX (FIG. 1E) mapping results from different scales, it can be concluded that the LAZO protective layer has been uniformly modified on the surface of the LNO particles. Additionally, the coated samples have been ground before SEM and STEM measurements. Based on the typical SEM-EDX (FIG. 8) and STEM-EDX (FIG. 1E) mapping results from different scales, it can be concluded that the LAZO coating layer is still perfect even after griding. One reason might be that the ALD coating process leads to a strong bonding connection between the cathode particle and the coating layer. The other reason might be that manual griding can't produce sufficient energy to destroy the oxide-type LAZO coating layer with high Young's modulus.

### Example 6

### Cost of Materials in Devices

Utilizing the physical data (Table 3), the estimated the cost was estimate for LAZO ALD coating on the LNO cathode material including the CapEx for production equipment, OpEx and labor, and find that the materials cost is 0.84 $/kg, 0.25 $/cell, and 0.82 $/kWh, respectively. Based on the designed scale of 6 GWh, developed processes and current precursor economics, it is estimated that the cost of LiNbO₃ and Li₂ZrO₃ of similar thickness on LNO would be around 1.41 and 1.85 $/kWh, respectively. The economics of the ALD coatings are dominated by the costs of the precursors (The sensitivity to precursor cost for the model is 0.4. The sensitivity is defined as change output/0 change input). In turn, generally, the cost of the precursor inversely scales with annual use for the application (this 6 GWh factory), as well as the global demand for the precursors. So more common precursors that are used in other applications spaces beyond batteries and ALD coatings are generally cheaper. Al- and Zn-based precursors are significantly less expensive and more prevalent in other markets, so the cost of LAZO coatings is much lower than that of the representative coatings (e.g., LiNbO₃, Li₂ZrO₃) widely used in ASSLBs.

TABLE 3
Final cost calculator

| | | | |
|---|---|---|---|
| Cost of precursor per | 1908068.91 | $/yr | Cost of precursors |
| year cathode | | | for annual battery |
| | | | production |
| Cost of precursor per | 1628264.24 | $/yr | |
| year SE | | | |
| Amortized equipment | 0.14 | $/kg | Amortized equipment |
| cost cathode | | | cost including |
| Amortized equipment | 0.30 | $/kg | depreciation (and |
| cost SE | | | margins) |
| ALD materials cost | 0.32 | $/kg | |
| cathode | | | |
| ALD materials cost SE | 0.60 | $/kg | |
| ALD OpEx cost cathode | 0.03 | $/kg | |
| ALD OpEx cost SE | 0.06 | $/kg | |
| Total cost of ALD for | 0.84 | $/kg | Toal cost with margins |
| cathode | | | per kg/cell/kWh |
| Total cost of ALD for SE | 1.51 | $/kg | |
| Total cost of ALD for | 0.25 | $/cell | |
| cathode | | | |
| Total cost of ALD for SE | 0.21 | $/cell | |
| Total cost of ALD for | 0.82 | $/kWh | |
| cathode | | | |
| Total cost of ALD for SE | 0.68 | $/kWh | |
| Cost of ALD insurance | 1.45 | % | Percentage cost of |
| | | | ALD on cathode & SE |
| | | | to cell production |

OpEx changes were not estimated in battery processing methods (good or bad, e.g., nor were any cost saving presumptions included for battery processing from reduced dry room or cleanroom facilities). (3) There were no margins directly added on the materials, but these were built into the equipment and licensing costs. If margins were removed entirely, the cost drops further. (4) No corrections were made for precursor use inefficiencies during processing.

In conclusion, the total increase of the cost to the kWh is less than 1% (˜86.5 $/kWh without ALD LAZO coating) after introducing an ALD LAZO coating layer, but the performance of ASSLBs is enhanced significantly. This added cost is negligible.

1. A material with a general formula LiₓAl_{y}Zn_{z}O_{δ} (LAZO), wherein:
x, y, z and δ, are each a whole number ranging between 1 and 10.

2. (canceled)

3. The material of claim 1 in the form of a layer wherein the thickness of said layer ranges between 1 and 500 nm.

4. A cathode comprising:
a first layer comprising lithium; and
a second layer comprising said LAZO material of claim 1.

5. The cathode of claim 4 wherein said first layer comprises LiNiO₂ (LNO).

6. The cathode of claim 4 wherein said first layer comprises any of the following selected from: Li₃MCl₆ and Li₂M_{2/3}Cl₄ wherein M is selected from: Y, Tb—Lu, Sc, and In; and LiMn₂O₄.

7. The cathode of claim 4 wherein said second layer further comprises an Al+Zn near-surface doping region disposed on the surface of the first layer.

8. The cathode of claim 4 wherein said first layer comprises a modulating structure.

9. The cathode of claim 8 wherein said modulating structure is selected from: spherical particles, cuboidal particles, wave-like structure and platonic solids or any combination thereof.

10. The cathode of claim 9 wherein said modulating structure is polycrystalline.

11. The cathode of claim 8 where the average size of said modulating structure ranges between 1 and 50 μm.

12. The cathode of claim 4 further comprising secondary particles disposed on said first layer.

13. The cathode of claim 12 wherein the size of said secondary particles ranges between 10 to 500 nm.

14. The cathode of claim 4 wherein the thickness of the second layer ranges between 1 and 50 nm.

15. (canceled)

16. (canceled)

17. (canceled)

18. The cathode of claim 4 further comprising a current collector wherein said first layer is disposed thereon.

19. The cathode of claim 18 wherein said current collector comprises any of the following selected from: aluminum (Al), copper (Cu), stainless steel, nickel (Ni), an alloy comprising Al, Cu or Ni, or any combination thereof.

20-40. (canceled)

41. A solid-state lithium battery comprising:
the cathode of claim 4;
a solid electrolyte; and
an anode;
wherein said solid electrolyte is disposed between said cathode and said anode.

42. The battery of claim 41 wherein said LAZO layer has a thickness ranging between 1 to 50 nm.

43. The battery of claim 41 wherein said solid electrolyte is selected from an inorganic solid electrolyte (ISE), a solid polymer electrolyte (SPE) and a composite polymer electrolyte (CPE) or any combination thereof.

44. The battery of claim 41 wherein the solid electrolyte comprises: argyrodite-like material, garnets, NASICON, lithium nitrides, lithium hydrides, lithium phosphidotrielates, phoshidotetrelates, perovskites, lithium halides, RbAg₄I₅, lithium phosphorus oxynitride, lithium thiophosphates, LPSC, LSPSSC, LSPS, LGPS, LSSSI, LISC, LHC, LSC, polyethylene oxide (PEO) based, polyvinylidene fluoride (PVDF) based, polyacrylonitrile (PAN) based, polyethylene oxide/polypropylene oxide (PEO/PPO) blends and polyphosphazene-based electrolytes or any combination thereof.

45. The battery of claim 44 wherein said argyrodite-like material is in the form Li_{7-θ}BCh_{6-θ}X_{θ} wherein:
θ is between 0 and 1;
B is selected from: phosphor or arsenic;
Ch is selected from: sulfur or selenium; and
X is selected from: chlorine, bromine or iodine.

46-58. (canceled)
